(19) United States
(12) Patent Application Publication
(10) Pub. No.: US 2022/0264878 A1
(43) Pub. Date: Aug. 25, 2022

(54) HERBICIDAL COMPOSITION CONTAINING R-TYPE PYRIDYLOXY CARBOXYLIC ACID DERIVATIVE AND USE THEREOF

(71) Applicant: Qingdao Kingagroot Chemical Compound Co., Ltd., Qingdao (CN)

(72) Inventors: Xuegang PENG, Qingdao (CN); De ZHAO, Qingdao (CN); Qi CUI, Qingdao (CN); Tao JIN, Qingdao (CN); Jingyuan ZHANG, Qingdao (CN); Na LIU, Qingdao (CN)

(21) Appl. No.: 17/627,221

(22) PCT Filed: Jul. 14, 2020
(86) PCT No.: PCT/CN2020/101901

§ 371 Date: Jan. 14, 2022

(30) Foreign Application Priority Data
Jul. 27, 2019 (CN) 201910685431.9
Aug. 27, 2019 (CN) 201910796285.7
Mar. 27, 2020 (CN) 202010228317.6
Mar. 27, 2020 (CN) 202010228765.6
May 14, 2020 (CN) 202010406451.0

(51) Int. Cl. A01N 43/40; A01N 43/90; A01N 43/54; A01N 47/36; A01N 43/50; A01N 37/38; A01N 37/18; A01N 43/60; A01N 43/70; A01N 43/88; A01N 37/34; A01N 37/22; A01N 43/56; A01N 43/06; A01N 35/06; A01N 43/80; A01N 43/36; A01N 43/653; A01N 33/18; A01N 43/84; A01N 43/82; A01N 57/20; A01P 13/00; A01N 25/32

(52) U.S. Cl. CPC A01N 43/40; A01N 25/32; A01N 43/54; A01N 47/36; A01N 43/50; A01N 37/38; A01N 37/18; A01N 43/60; A01N 43/70; A01N 43/88; A01N 37/34; A01N 37/22; A01N 43/56; A01N 43/06; A01N 35/06; A01N 43/80; A01N 43/36; A01N 43/653; A01N 33/18; A01N 43/84; A01N 43/82; A01N 57/20; A01P 13/00; A01N 43/90

(57) ABSTRACT

The present invention belongs to the technical field of pesticides, and particularly relates to an herbicidal composition comprising R-pyridyloxycarboxylic acid and derivative and an application thereof. The composition comprises an active ingredient A and an active ingredient B in an herbicidally effective amount, wherein, the active ingredient A is one or more compounds selected from an R-pyridyloxycarboxylic acid represented by formula I and salt, ester derivative thereof,

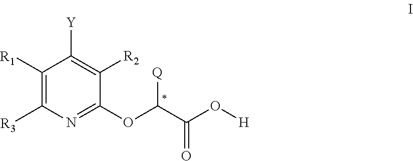

wherein, R₁, R₂ each independently represent halogen, C1-C6 alkyl, halo C1-C6 alkyl or C3-C6 cycloalkyl;
R₃ represents hydrogen, halogen, C1-C6 alkyl or halo C1-C6 alkyl;
Q represents C1-C6 alkyl, etc.;
Y represents amino, etc.;
the active ingredient B is selected from the following one or more compounds or acid or salt or ester derivatives thereof, ALS inhibitor, ACCase inhibitor, PSII inhibitor, HPPD inhibitor, PDS inhibitor, DOXP inhibitor, PPO inhibitor, Synthetic hormone, EPSPS inhibitor, GS inhibitor, PSI inhibitor. The composition is capable of effectively controlling various weeds, and has the following advantages: exhibiting a broad spectrum of weed control, being used in a reduced dose, and being capable of bringing about a synergistic effect and removing resistant weeds.

### TECHNICAL FIELD

The present invention belongs to the technical field of pesticides, and particularly relates to an herbicidal composition comprising R-pyridyloxycarboxylic acid and derivative and an application thereof.

### BACKGROUND ART

Chemical control of weed is a most economical and effective means for controlling weeds in farmlands, however, continuously use of a single chemical herbicide or chemical herbicides having a single functional mechanism at a high dosage for a long period of time is likely to cause problems associated with evolved drug resistance and tolerance of weeds. Well complexing or formulating of herbicidal compounds can achieve the following advantages: exhibiting a broad spectrum of weed control, improving weed control effect, and delaying occurrence and development of drug resistance and tolerance of weeds, and thus is one of the most effective means to solve the above problems. Accordingly, herbicidal compositions which have a high safety and a broad weed controlling spectrum, and are capable of bringing about a synergistic effect and removing resistant weeds are desiderated in production.

### The Contents of the Invention

In order to solve the above existing problems in the prior art, the present invention provides an herbicidal composition comprising R-pyridyloxycarboxylic acid and derivative and an application thereof. The composition is capable of effectively controlling weeds such as grassy weeds or broadleaf weeds etc., and has the following advantages: exhibiting a broad spectrum of weed control, being used in a reduced dose, and being capable of bringing about a synergistic effect and removing resistant weeds.

An herbicidal composition comprising R-pyridyloxycarboxylic acid and derivative which comprises an active ingredient A and an active ingredient B in an herbicidally effective amount, wherein,

the active ingredient A is one or more compounds selected from an R-pyridyloxycarboxylic acid represented by formula I and salt, ester derivative thereof,

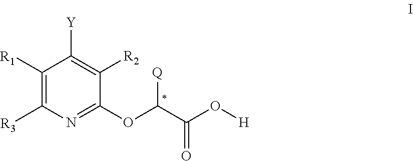

wherein, R₁, R₂ each independently represent halogen, C1-C6 alkyl, halo C1-C6 alkyl or C3-C6 cycloalkyl;

R₃ represents hydrogen, halogen, C1-C6 alkyl or halo C1-C6 alkyl;

Q represents C1-C6 alkyl, halo C1-C6 alkyl, C3-C6 cycloalkyl, C2-C6 alkenyl, C2-C6 alkynyl, halogen, cyano, amino, nitro, formyl, C1-C6 alkoxy, C1-C6 alkylthio, C1-C6 alkoxycarbonyl, hydroxy C1-C6 alkyl, C1-C6 alkoxy C1-C6 alkyl, cyano C1-C6 alkyl, C1-C6 alkylamino C1-C6 alkyl; or phenyl, benzyl, naphthyl, furyl, thienyl, thiazolyl, pyrazolyl, pyridyl or pyrimidinyl that is unsubstituted or substituted by at least one group selected from the group consisting of C1-C6 alkyl, cyano, halo C1-C6 alkyl, C1-C6 alkylamino, halogen, C1-C6 alkoxy;

Y represents amino, C1-C6 alkylamino, C1-C6 alkylcarbonylamino; or phenylcarbonylamino, benzylamino or furylmethyleneamino that is unsubstituted or substituted by at least one group selected from the group consisting of C1-C6 alkyl, halogen, cyano, C1-C6 alkylamino, C1-C6 alkoxy, halo C1-C6 alkyl;

the salt is metal salt, ammonium salt NH₄⁺, primary amine R″NH₂ salt, secondary amine (R″)₂NH salt, tertiary amine (R″)₃N salt, quaternary amine salt (R″)₄N⁺, salt of polyamine, morpholine salt, N-methyl morpholine salt, piperidine salt, pyridine salt, aminopropyl morpholine salt, Jeff amine D-230 salt, the salt of 2,4,6-tri(dimethylaminomethyl) phenol and sodium hydroxide, C1-C16 alkylsulfonium salt (preferably C1-C6 alkylsulfonium salt), C1-C16 alkylsulfoxonium salt (preferably C1-C6 alkylsulfoxonium salt), C1-C16 alkylphosphonium salt (preferably C1-C6 alkylphosphonium salt) or C1-C16 alkanolphosphonium salt (preferably C1-C6 alkanolphosphonium salt);

wherein, R″ each independently represents C1-C16 alkyl, C2-C12 alkenyl (preferably C2-C₆ alkenyl), C2-C12 alkynyl (preferably C2-C₆ alkynyl), C3-C12 cycloalkyl; or C1-C16 alkyl (preferably C1-C6 alkyl) substituted by one or more of the following groups: halogen, hydroxy, C1-C6 alkoxy, C1-C6 alkylthio, hydroxy C1-C6 alkoxy; or phenyl or benzyl that is unsubstituted or substituted by C1-C6 alkyl.

the ester is

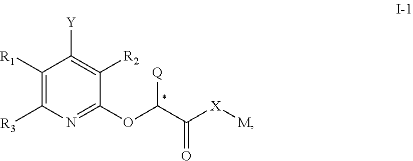

wherein, X represents O or S;

M represents C1-C18 alkyl, halo C1-C8 alkyl, C3-C6 cycloalkyl that is unsubstituted or substituted by C1-C6 alkyl, C2-C6 alkenyl, halo C2-C6 alkenyl, C2-C6 alkynyl, C1-C6 alkoxy, C1-C6 alkoxycarbonyl, C1-C6 alkylsulfonyl, cyano C1-C6 alkyl, nitro C1-C6 alkyl, C1-C6 alkoxy C1-C6 alkyl, —(C1-C6 alkyl)-Z,

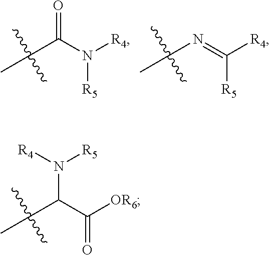

or phenyl,

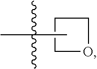

tetrahydrofuryl, pyridyl, naphthyl, furyl, thienyl, pyrrolyl, pyrazolyl or imidazolyl that is unsubstituted or substituted by at least one group selected from the group consisting of C1-C6 alkyl, halo C1-C6 alkyl, cyano, C1-C6 alkylamino, halogen, C1-C6 alkoxy;

Z represents

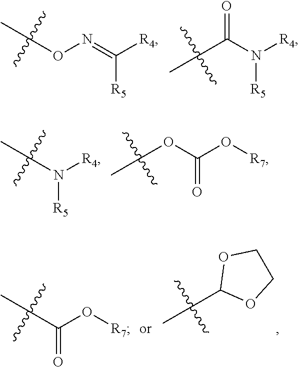

phenyl, tetrahydrofuryl, pyridyl, pyrazolyl, thienyl, furyl or naphthyl that is unsubstituted or substituted by at least one group selected from the group consisting of C1-C6 alkyl, C1-C6 alkoxy, C1-C6 alkylamino, halo C1-C6 alkyl, cyano, halogen;

R₄, R₅, R₆ each independently represent hydrogen, C1-C6 alkyl, C1-C6 alkoxycarbonyl; or phenyl that is unsubstituted or substituted by at least one group selected from the group consisting of C1-C6 alkyl, C1-C6 alkoxy, C1-C6 alkylamino, halo C1-C6 alkyl, cyano, halogen;

R₇ represents C1-C6 alkyl, C2-C6 alkenyl or

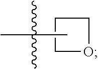

the active ingredient B is selected from the following one or more compounds or acid or salt or ester derivatives thereof,

(1) ALS inhibitor selected from: for example, penoxsulam (CAS NO.: 219714-96-2), bispyribac-sodium (CAS NO.: 125401-92-5), pyrazosulfuron-ethyl(CAS NO.: 93697-74-6), nicosulfuron (CAS NO.: 111991-09-4), florasulam (CAS NO.: 145701-23-1), rimsulfuron (CAS NO.: 122931-48-0), imazethapyr (CAS NO.: 81335-77-5), imazapic (CAS NO.: 104098-48-8), imazamox (CAS NO.: 114311-32-9), sulfometuron-methyl(CAS NO.: 74222-97-2), cloransulam-methyl (CAS NO.: 147150-35-4);

(2) ACCase inhibitor selected from: for example, cyhalofop-butyl(CAS NO.: 122008-85-9), clodinafop-propargyl(CAS NO.: 105512-06-9), pinoxaden (CAS NO.: 243973-20-8), clethodim (CAS NO.: 99129-21-2), sethoxydim (CAS NO.: 74051-80-2), quizalofop-P-methyl(CAS NO.: 100646-51-3), fluazifop-P-butyl(CAS NO.: 79241-46-6), haloxyfop-P-methyl(CAS NO.: 72619-32-0);

(3) PSII inhibitor selected from: for example, atrazine (CAS NO.: 1912-24-9), isoproturon (CAS NO.: 34123-59-6), chlorotoluron (CAS NO.: 15545-48-9), diuron (CAS NO.: 330-54-1), bentazone (CAS NO.: 25057-89-0), bromoxynil (CAS NO.: 1689-84-5), propanil (CAS NO.: 709-98-8);

(4) HPPD inhibitor selected from: for example, cypyrafluone (CAS NO.: 1855929-45-1), bipyrazone (CAS NO.: 1622908-18-2), fenpyrazone (CAS NO.: 1992017-55-6), tripyrasulfone (CAS NO.: 1911613-97-2), tefuryltrione (CAS NO.: 473278-76-1), mesotrione (CAS NO.: 104206-82-8), tembotrione (CAS NO.: 335104-84-2), topramezone (CAS NO.: 210631-68-8), isoxaflutole (CAS NO.: 141112-29-0), benzobicylon (CAS NO.: 156963-66-5);

(5) PDS inhibitor selected from: for example, diflufenican (CAS NO.: 83164-33-4), flurochloridone (CAS NO.: 61213-25-0);

(6) DOXP inhibitor: for example, clomazone (CAS NO.: 81777-89-1);

(7) PPO inhibitor selected from: for example, carfentrazone-ethyl(CAS NO.: 128621-72-7), fomesafen (CAS NO.: 72178-02-0), fluoroglycofen (CAS NO.: 77501-60-1), oxyfluorfen (CAS NO.: 42874-03-3), lactofen (CAS NO.: 77501-63-4), acifluorfen-sodium (CAS NO.: 50594-66-6), flumioxazin (CAS NO.: 103361-09-7), sulfentrazone (CAS NO.: 122836-35-5), saflufenacil (CAS NO.: 372137-35-4), oxadiazon (CAS NO.: 19666-30-9), oxadiargyl(CAS NO.: 39807-15-3);

(8) Synthetic hormone inhibitor selected from: for example, triclopyr (CAS NO.: 55335-06-3), MCPA (CAS NO.: 94-74-6), dicamba (CAS NO.: 1918-00-9), picloram (CAS NO.: 1918-02-1), aminopyralid (CAS NO.: 150114-71-9), fluroxypyr (CAS NO.: 69377-81-7), florpyrauxifen benzyl (CAS NO.: 1390661-72-9), halauxifen-methyl (CAS NO.: 943831-98-9), quinclorac (CAS NO.: 84087-01-4), clopyralid (CAS NO.: 1702-17-6);

(9) EPSPS inhibitor: for example, glyphosate (CAS NO.: 1071-83-6);

(10) GS inhibitor selected from, for example, glufosinate ammonium (CAS NO.: 77182-82-2);

(11) PSI inhibitor selected from, for example, diquat Dibromide monohydrate (CAS NO.: 6385-62-2), paraquat dichloride (CAS NO.: 1910-42-5).

Preferably, R₁, R₂ each independently represent fluoro, chloro, bromo, iodo, methyl, ethyl, propyl, isopropyl, trifluoromethyl or cyclopropyl;

R₃ represents hydrogen, fluoro, chloro, bromo, iodo, methyl or trifluoromethyl;

Q represents methyl, ethyl, propyl, isopropyl, cyclopropyl, vinyl, ethynyl, fluoro, chloro, bromo, cyano, amino, nitro, formyl, methoxy, methylthio, methoxycarbonyl, monochloromethyl, monofluoromethyl, difluoromethyl, trifluoromethyl, 2-chloroethyl, 2,2,2-trifluoroethyl, hydroxymethyl,

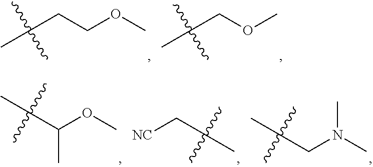

benzyl, naphthyl

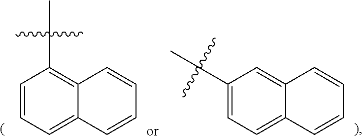 [SMILES: *c1cccc2ccccc12 ; *c1ccc2ccccc2c1]

furyl

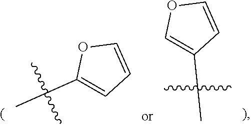 [SMILES: *c1ccco1 ; *c1ccoc1]

pyridyl

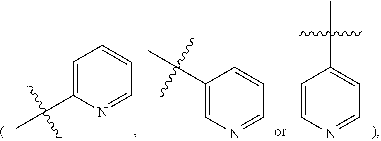

pyrimidinyl

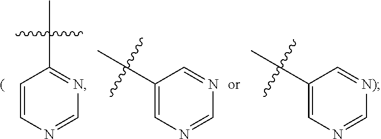

thiazolyl

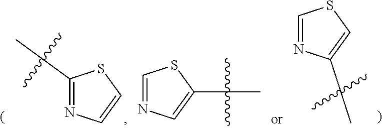

that is unsubstituted or substituted by chloro; thienyl

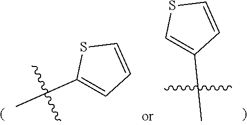 [SMILES: *c1cccs1 ; *c1ccsc1]

that is unsubstituted or substituted by fluoro;

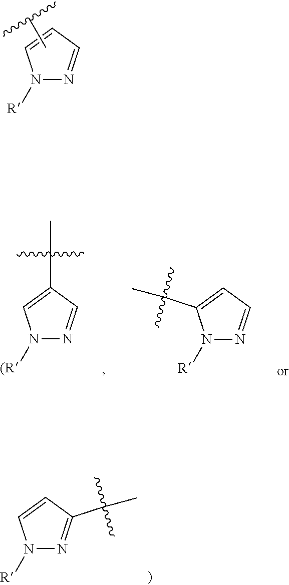

that is unsubstituted or substituted by methyl or fluoro; or phenyl that is unsubstituted or substituted by at least one group selected from the group consisting of methyl, trifluoromethyl, chloro, methoxy;

Y represents NH₂,

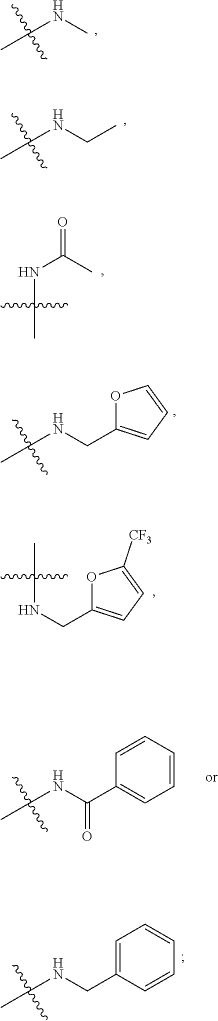

the salt is alkali metal (such as sodium, lithium, potassium, cesium or rubidium) salt, alkaline earth metal (such as calcium, magnesium, barium or strontium) salt, and salts of metals such as antimony, bismuth, cadmium, cerium, chromium, cobalt, scandium, titanium, manganese, copper, iron, silver, gold, zinc, aluminum, etc., amine salt such as ammonium salt, tetramethylammonium salt, tetraethylammonium salt, tetrapropylammonium salt, tetrabutylammonium salt, N-hexadecyltrimethylamine salt, N-benzyltrimethylammonium salt, benzyltriethylammonium salt, choline amine salt, monomethylamine salt, dimethylamine salt, trimethylamine salt, monoethylamine salt, diethylamine salt, triethylamine salt, n-propylamine salt, dipropylamine salt, tripropylamine salt, monoisopropylamine salt, diisopropylamine salt, triisopropylamine salt, n-butylamine salt, dibutylamine salt, tributylamine salt, isobutylamine salt, tert-butylamine salt, pentylamine salt, hexylamine salt, heptylamine salt, octylamine salt, dodecylamine salt, tetradecylamine salt, diallylamine salt, cyclohexylamine salt, cyclododecylamine salt, aniline salt, o-toluidine salt, m-toluidine salt, p-toluidine salt, dianiline salt, benzylamine salt, monoethanolamine salt, N-methyl monoethanolamine salt, N,N-dimethylethanolamine salt, N-ethyl monoethanolamine salt, N,N-diethylethanolamine salt, N-propyl monoethanolamine salt, N,N-di-n-propylethanolamine salt, N-butyl monoethanolamine salt, diethanolamine salt, N-methyldiethanolamine salt, N-ethyldiethanolamine salt, N-propyldiethanolamine salt, N-butyldiethanolamine salt, N, N-dibutylethanolamine salt, triethanolamine salt, tripropanolamine salt, triisopropanolamine salt, tri(2-hydroxypropyl)amine salt, diglycolamine salt, salt of polyamine (for example, hexamethylenetetramine salt, ethylenediamine salt, diethylenetriamine salt, dimethylaminopropylamine salt, 1,2-propyldiamine salt, triethylenediamine salt, triethylenetetramine salt, benzidine salt, N,N-bis[aminopropyl]methylamine salt), 2-methylthiopropylamine salt, 2-butoxyethylamine salt, AEPD

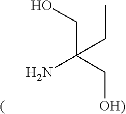

salt, tri(methylol) aminomethane

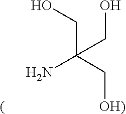

salt, morpholine salt, N-methyl morpholine salt, piperidine salt, pyridine salt, aminopropyl morpholine

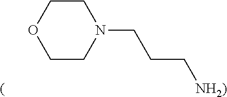

salt, Jeff amine D-230

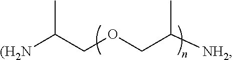

n is 2 or 3) salt, the salt of 2,4,6-tri(dimethylaminomethyl) phenol and sodium hydroxide, sulfonium salt such as alkylsulfonium salt (such as trimethylsulfonium salt, triethylsulfonium salt), alkylsulfoxonium salt, phosphonium salt such as alkylphosphonium salt or alkanolphosphonium salt;

in formula I-1, X represents O or S;

M represents methyl, ethyl, propyl, isopropyl, n-butyl, sec-butyl, isobutyl, tert-butyl, pentyl, hexyl, heptyl, octyl, nonyl, decyl, undecyl, dodecyl, octadecyl, trifluoromethyl, pentafluoroethyl, 3-chlorobutyl, 2-fluoroethyl, 2-chloroethyl, 2-bromoethyl, 2,2-difluoroethyl, 2,2,2-trifluoroethyl, 4,4,4-trifluorobutyl, 2,2,3,3,3-pentafluoropropyl, cyclopropyl, cyclobutyl, cyclopentyl, cyclohexyl, allyl, 2-propynyl, methoxy, ethoxycarbonyl, methylsulfonyl

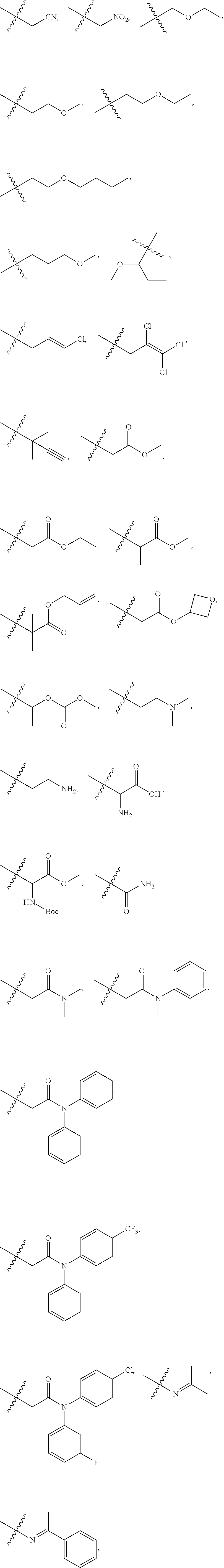

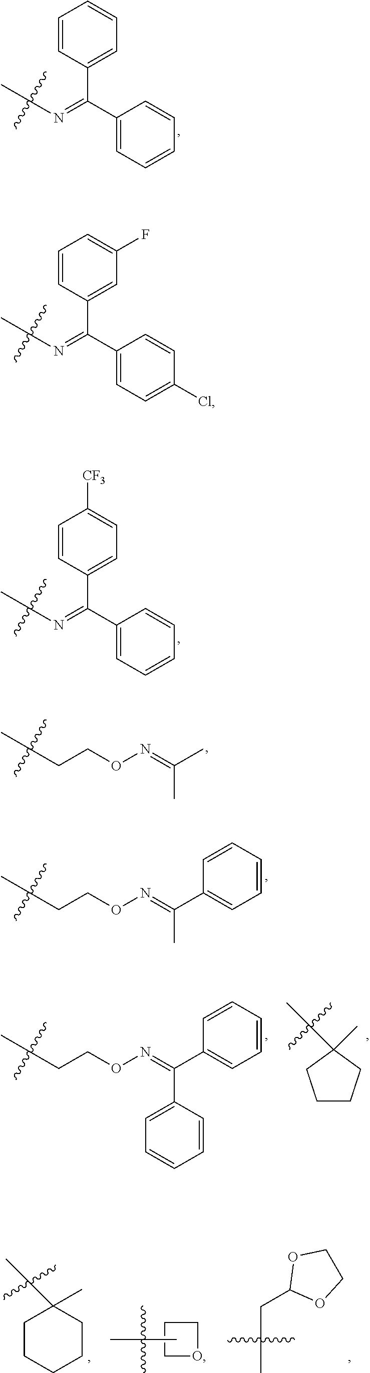

tetrahydrofuryl

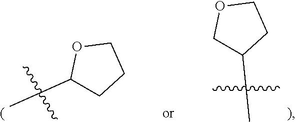 [SMILES: *C1CCCO1 ; *C1CCOC1]

tetrahydrofurylmethylene

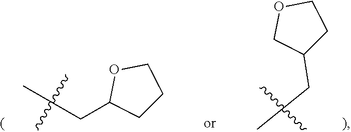 [SMILES: *CC1CCCO1 ; *CC1CCOC1]

pyridyl

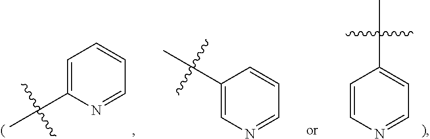 [SMILES: *c1ccccn1 ; *c1cccnc1 ; *c1ccncc1]

pyridylmethylene

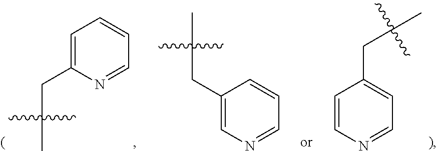 [SMILES: *Cc1ccccn1 ; *Cc1cccnc1 ; *Cc1ccncc1]

naphthyl

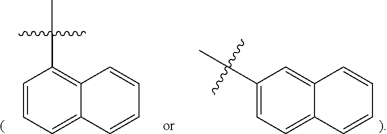 [SMILES: *c1cccc2ccccc12 ; *c1ccc2ccccc2c1]

naphthylmethylene

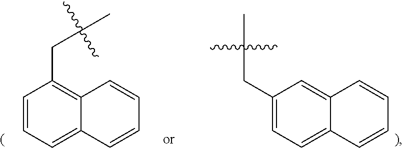 [SMILES: *Cc1cccc2ccccc12 ; *Cc1ccc2ccccc2c1]

furyl

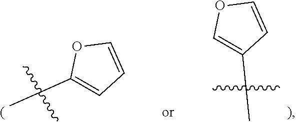 [SMILES: *c1ccco1 ; *c1ccoc1]

furylmethylene

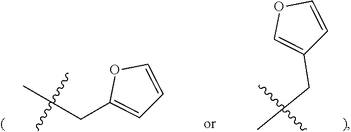 [SMILES: *Cc1ccco1 ; *Cc1ccoc1]

thienyl

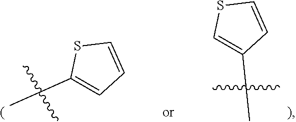 [SMILES: *c1cccs1 ; *c1ccsc1]

thienylmethylene

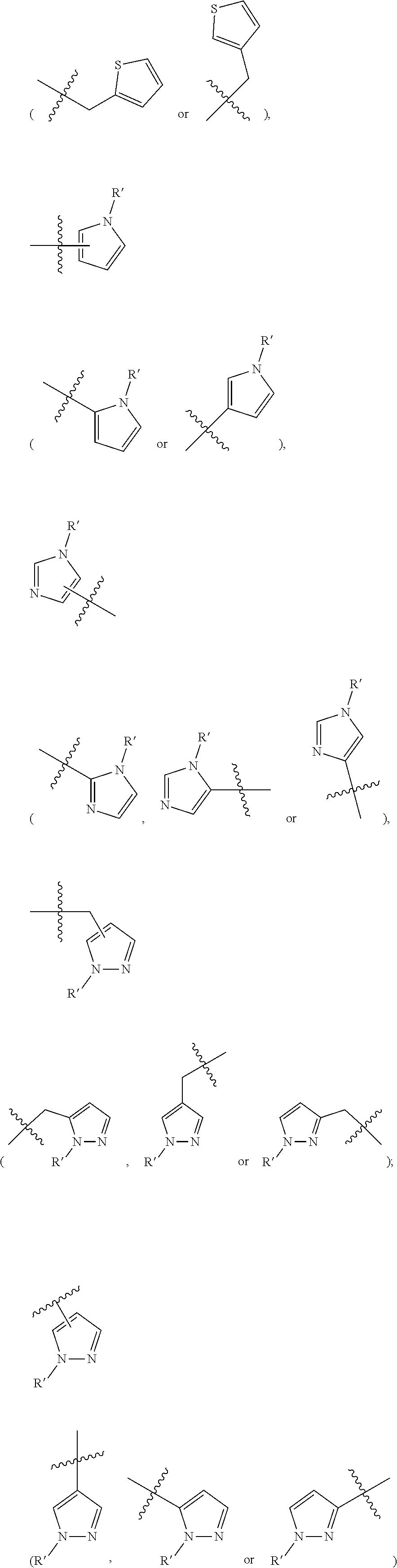

that is unsubstituted or substituted by methyl; phenyl that is unsubstituted or substituted by methyl, dimethylamino, chloro, methoxy, trifluoromethyl or isopropyl; or benzyl that is unsubstituted or substituted by trifluoromethyl, bromo, chloro, fluoro, methoxy, cyano or methyl;

R′ represents hydrogen, methyl, ethyl or difluoromethyl.

More preferably, the active ingredient A is one or more compounds selected from,

| No. of | | |
|---|---|---|
| com- | | |
| ponent | | |
| A | Structure | ¹HNMR |
| A1 | 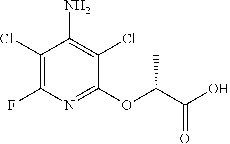 [SMILES: C[C@@H](Oc1nc(F)c(Cl)c(N)c1Cl)C(=O)O] | ¹H NMR (500 MHz, DMSO-d₆) δ 12.96 (s, 1H), 6.99 (s, 2H), 5.06 (q, J = 7.0 Hz, 1H), 1.50 (d, J = 7.0 Hz, 3H) |
| A2 | 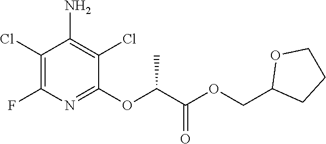 [SMILES: C[C@@H](Oc1nc(F)c(Cl)c(N)c1Cl)C(=O)OCC1CCCO1] | ¹H NMR (500 MHz, Chloroform-d) δ 5.28 (q, J = 7.0 Hz, 1H), 5.15 (s, 2H), 4.27- 4.07 (m, 3H), 3.91-3.73 (m, 2H), 2.04- 1.82 (m, 3H), 1.66 (d, J = 7.0 Hz, 3H), 1.59-1.54 (m, 1H). |
| A3 | A1 sodium salt | |
| A4 | A1 potassium salt | |
| A5 | A1 calcium salt | |
| A6 | A1 lithium salt | |
| A7 | A1 aluminum salt | |
| A8 | A1 barium salt | |
| A9 | A1 magnesium salt | |
| A10 | A1 copper salt | |
| A11 | A1 iron salt | |
| A12 | A1 ammonium salt | |
| A13 | A1 monomethylamine salt | |
| A14 | A1 dimethylamine salt | |
| A15 | A1 trimethylamine salt | |
| A16 | A1 monoethylamine salt | |
| A17 | A1 diethylamine salt | |
| A18 | A1 triethylamine salt | |
| A19 | A1 ethylenediamine salt | |
| A20 | A1 triethylene diamine salt | |
| A21 | A1 monoethanolamine salt | |
| A22 | A1 diethanolamine salt | |
| A23 | A1 triethanolamine salt | |
| A24 | A1 N-methyl monoethanolamine salt | |
| A25 | A1 N-methyldiethanolamine salt | |
| A26 | A1 N-ethyl monoethanolamine salt | |
| A27 | A1 N-ethyldiethanolamine salt | |
| A28 | A1 N,N-diethylethanolamine salt | |
| A29 | A1 N-propyl monoethanolamine salt | |
| A30 | A1 N-propyl diethanolamine salt | |
| A31 | A1 N,N-di-n-propylethanolamine salt | |
| A32 | A1 N-butyl monoethanolamine salt | |
| A33 | A1 N-butyl diethanolamine salt | |
| A34 | A1 N,N-dibutylethanolamine salt | |
| A35 | A1 n-propylamine salt | |
| A36 | A1 dipropylamine salt | |
| A37 | A1 tripropylamine salt | |
| A38 | A1 n-butylamine salt | |
| A39 | A1 dibutylamine salt | |
| A40 | A1 tributylamine salt | |
| A41 | A1 isobutylamine salt | |
| A42 | A1 tert-butylamine salt | |
| A43 | A1 hexylamine salt | |
| A44 | A1 octylamine salt | |
| A45 | A1 aniline salt | |
| A46 | A1 diphenylamine salt | |
| A47 | A1 benzidine salt | |
| A48 | A1 benzylamine salt | |
| A49 | A1 cyclohexylamine salt | |
| A50 | A1 monoisopropylamine salt | |
| A51 | A1 thisopropylamine salt | |
| A52 | A1 diglycolamine salt | |
| A53 | A1 hexamethylenetetramine salt | |
| A54 | A1 tetramethylammonium salt | |
| A55 | A1 tetraethylammonium salt | |
| A56 | A1 tetrapropylammonium salt | |
| A57 | A1 tetrabutylammonium salt | |
| A58 | A1 choline amine salt | |
| A59 | A1 N-benzyltrimethylammonium salt | |
| A60 | A1 N-hexadecyltrimethylammonium salt | |
| A61 | A1 pyridine salt | |
| A62 | A1 N-methylmorpholine salt | |
| A63 | A1 o-toluidine salt | |
| A64 | A1 m-toluidine salt | |
| A65 | A1 p-toluidine salt | |
| A66 | A1 piperidine salt | |
| A67 | 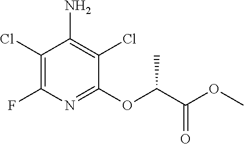 [SMILES: COC(=O)[C@@H](C)Oc1nc(F)c(Cl)c(N)c1Cl] | ¹H NMR (500 MHz, DMSO-d₆) δ 7.04 (s, 2H), 5.15 (q, J = 7.0 Hz, 1H), 3.65 (s, 3H), 1.50 (d, J = 7.0 Hz, 3H). |
| A68 | 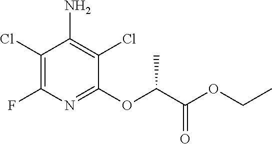 [SMILES: CCOC(=O)[C@@H](C)Oc1nc(F)c(Cl)c(N)c1Cl] | |
| A69 | 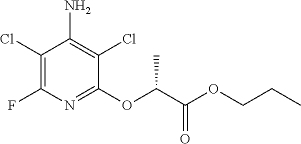 [SMILES: CCCOC(=O)[C@@H](C)Oc1nc(F)c(Cl)c(N)c1Cl] | |
| A70 | 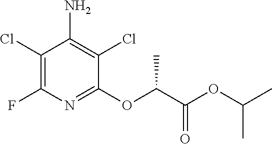 [SMILES: CC(C)OC(=O)[C@@H](C)Oc1nc(F)c(Cl)c(N)c1Cl] | |
| A71 | 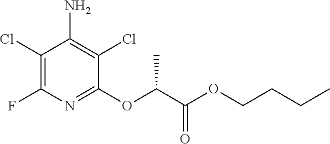 [SMILES: CCCCOC(=O)[C@@H](C)Oc1nc(F)c(Cl)c(N)c1Cl] | |
| A72 | 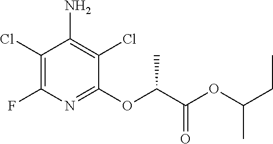 [SMILES: CCC(C)OC(=O)[C@@H](C)Oc1nc(F)c(Cl)c(N)c1Cl] | |
| A73 | 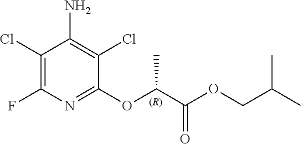 | |
| A74 | 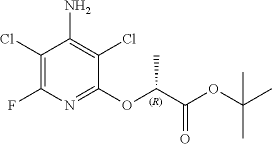 | |
| A75 | 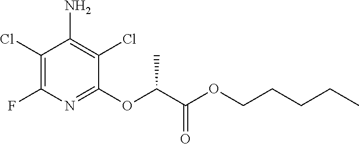 [SMILES: CCCCCOC(=O)[C@@H](C)Oc1nc(F)c(Cl)c(N)c1Cl] | |
| A76 | 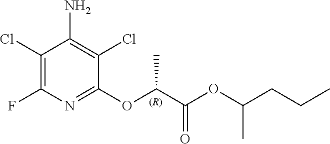 | |
| A77 | 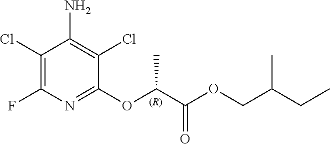 | |
| A78 | 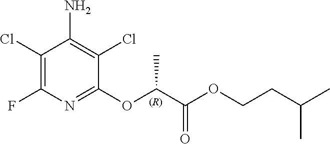 | |
| A79 | 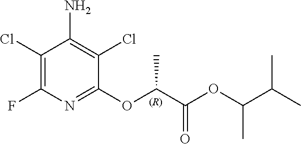 | |
| A80 | 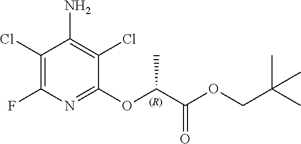 | |
| A81 | 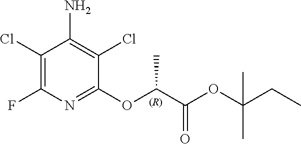 | |
| A82 | 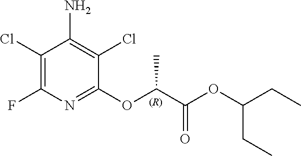 | |
| A83 | 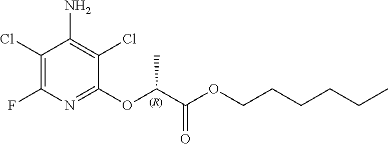 | |
| A84 | 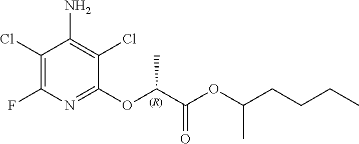 | |
| A85 | 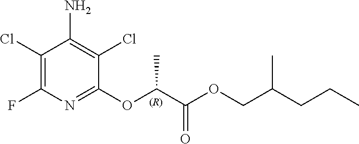 | |
| A86 | 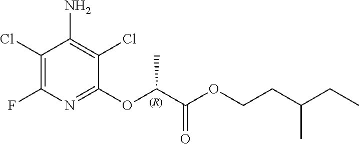 | |
| A87 | 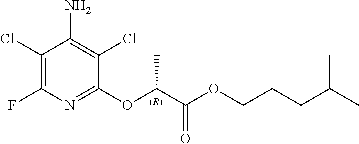 | |
| A88 | 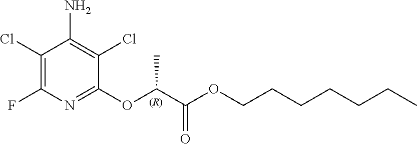 | |
| A89 | 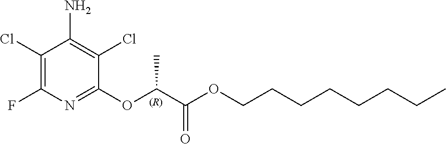 | |
| A90 | 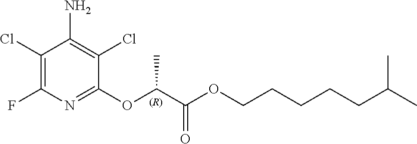 | |
| A91 | 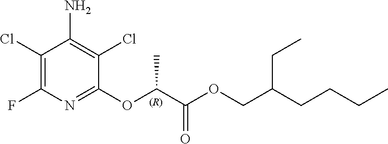 | |
| A92 | 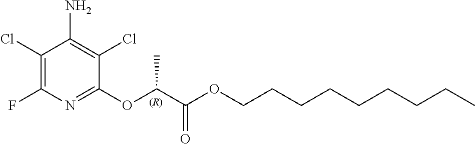 | |
| A93 | 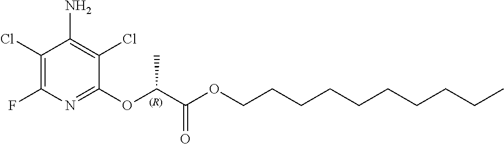 | |
| A94 | 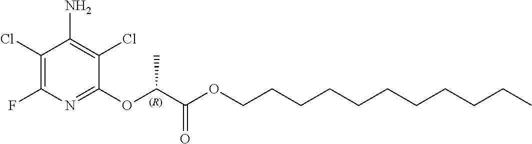 | ¹H NMR (500 MHz, DMSO-d₆) δ 6.81 (s, 2H), 4.67 (q, J = 7.0 Hz, 1H), 3.91-4.01 (m, 2H), 1.52 (d, J = 7.0 Hz, 3H), 1.21- 1.31 (m, 2H), 1.12-1.24 (m, 16H), 0.83- 0.91 (m, 3H) |
| A95 | 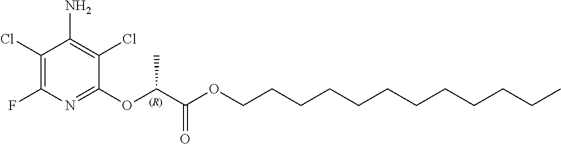 | |
| A96 | 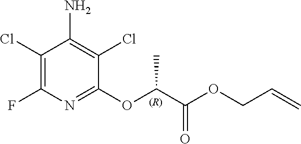 | |
| A97 | 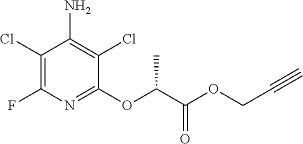 [SMILES: C#CCOC(=O)[C@@H](C)Oc1nc(F)c(Cl)c(N)c1Cl] | |
| A98 | 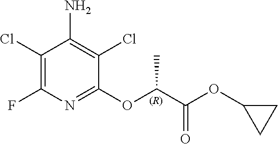 | |
| A99 | 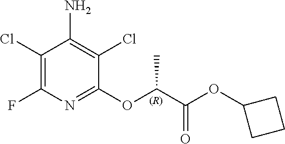 | |
| A100 | 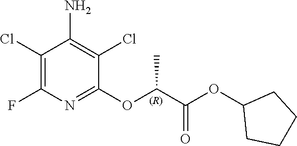 | |
| A101 | 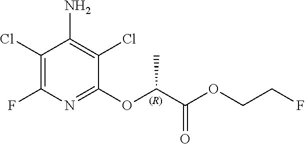 | |
| A102 | 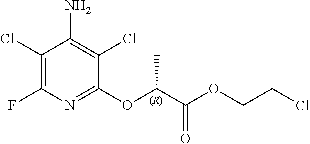 | |
| A103 | 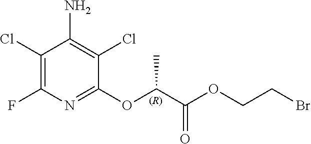 | |
| A104 | 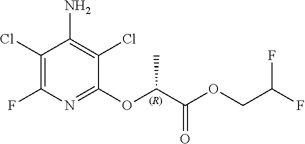 | |
| A105 | 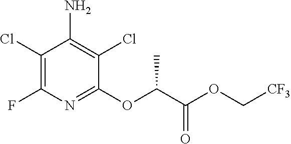 [SMILES: C[C@@H](Oc1nc(F)c(Cl)c(N)c1Cl)C(=O)OCC(F)(F)F] | |
| A106 | 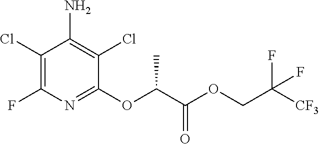 [SMILES: C[C@@H](Oc1nc(F)c(Cl)c(N)c1Cl)C(=O)OCC(F)(F)C(F)(F)F] | |
| A107 | 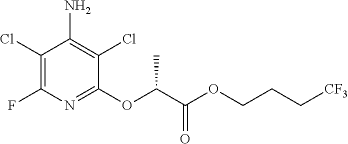 [SMILES: C[C@@H](Oc1nc(F)c(Cl)c(N)c1Cl)C(=O)OCCCC(F)(F)F] | |
| A108 | 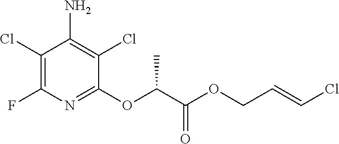 [SMILES: C[C@@H](Oc1nc(F)c(Cl)c(N)c1Cl)C(=O)OC/C=C/Cl] | |
| A109 | 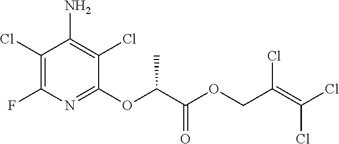 [SMILES: C[C@@H](Oc1nc(F)c(Cl)c(N)c1Cl)C(=O)OCC(Cl)=C(Cl)Cl] | |
| A110 | 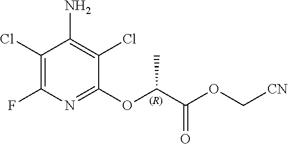 | |
| A111 | 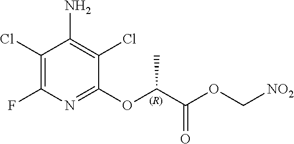 | |
| A112 | 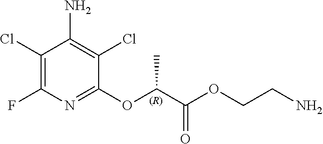 | |
| A113 | 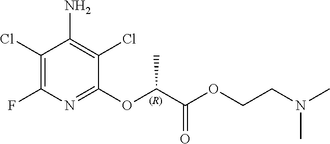 | |
| A114 | 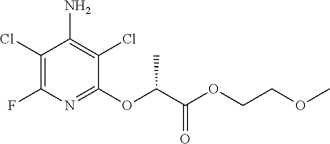 [SMILES: COCCOC(=O)[C@@H](C)Oc1nc(F)c(Cl)c(N)c1Cl] | |
| A115 | 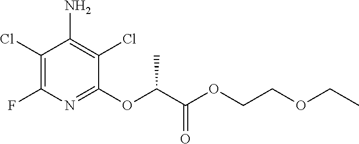 [SMILES: CCOCCOC(=O)[C@@H](C)Oc1nc(F)c(Cl)c(N)c1Cl] | |
| A116 | 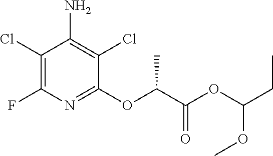 [SMILES: CCC(OC)OC(=O)[C@@H](C)Oc1nc(F)c(Cl)c(N)c1Cl] | |
| A117 | 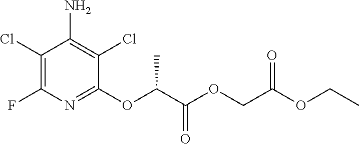 [SMILES: CCOC(=O)COC(=O)[C@@H](C)Oc1nc(F)c(Cl)c(N)c1Cl] | |
| A118 | 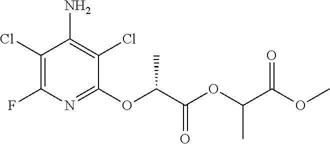 [SMILES: COC(=O)C(C)OC(=O)[C@@H](C)Oc1nc(F)c(Cl)c(N)c1Cl] | |
| A119 | 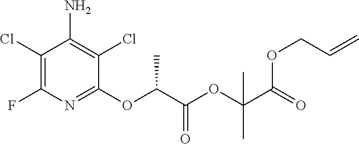 [SMILES: C=CCOC(=O)C(C)(C)OC(=O)[C@@H](C)Oc1nc(F)c(Cl)c(N)c1Cl] | |
| A120 | 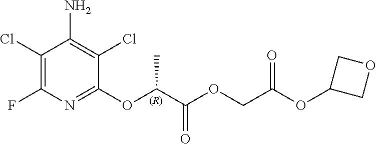 | |
| A121 | 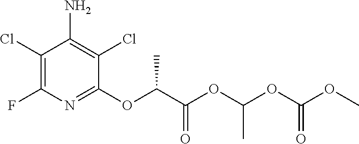 [SMILES: COC(=O)OC(C)OC(=O)[C@@H](C)Oc1nc(F)c(Cl)c(N)c1Cl] | |
| A122 | 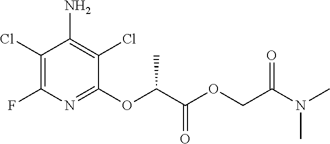 [SMILES: C[C@@H](Oc1nc(F)c(Cl)c(N)c1Cl)C(=O)OCC(=O)N(C)C] | |
| A123 | 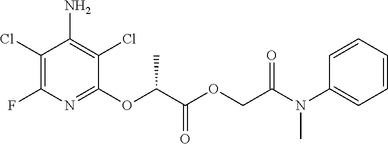 [SMILES: C[C@@H](Oc1nc(F)c(Cl)c(N)c1Cl)C(=O)OCC(=O)N(C)c1ccccc1] | |
| A124 | 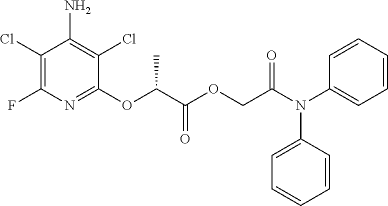 [SMILES: C[C@@H](Oc1nc(F)c(Cl)c(N)c1Cl)C(=O)OCC(=O)N(c1ccccc1)c1ccccc1] | |
| A125 | 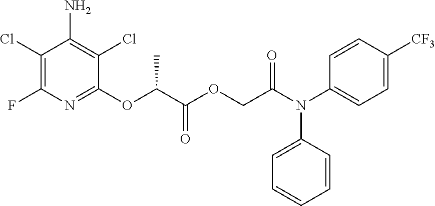 [SMILES: C[C@@H](Oc1nc(F)c(Cl)c(N)c1Cl)C(=O)OCC(=O)N(c1ccccc1)c1ccc(C(F)(F)F)cc1] | |
| A126 | 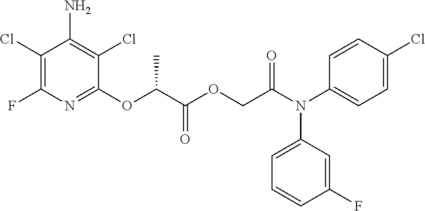 [SMILES: C[C@@H](Oc1nc(F)c(Cl)c(N)c1Cl)C(=O)OCC(=O)N(c1ccc(Cl)cc1)c1cccc(F)c1] | |
| A127 | 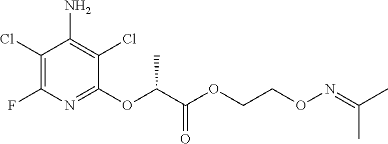 [SMILES: CC(C)=NOCCOC(=O)[C@@H](C)Oc1nc(F)c(Cl)c(N)c1Cl] | |
| A128 | 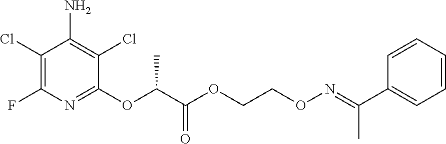 [SMILES: C/C(=N\OCCOC(=O)[C@@H](C)Oc1nc(F)c(Cl)c(N)c1Cl)c1ccccc1] | |
| A129 | 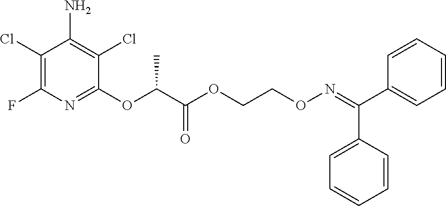 [SMILES: C[C@@H](Oc1nc(F)c(Cl)c(N)c1Cl)C(=O)OCCON=C(c1ccccc1)c1ccccc1] | |
| A130 | 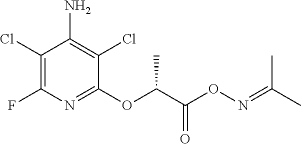 [SMILES: CC(C)=NOC(=O)[C@@H](C)Oc1nc(F)c(Cl)c(N)c1Cl] | ¹H NMR (500 MHz, d₆) δ 6.79 (s, 2H), 4.73 (q, J = 7.0 Hz, 1H), 2.47 (s, 3H), 2.41 (s, 3H), 1.50 (d, J = 7.0 Hz, 3H). |
| A131 | 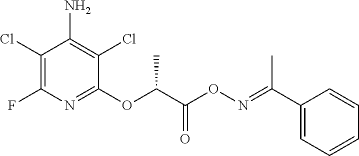 [SMILES: C/C(=N\OC(=O)[C@@H](C)Oc1nc(F)c(Cl)c(N)c1Cl)c1ccccc1] | |
| A132 | 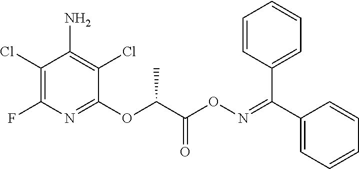 [SMILES: C[C@@H](Oc1nc(F)c(Cl)c(N)c1Cl)C(=O)ON=C(c1ccccc1)c1ccccc1] | |
| A133 | 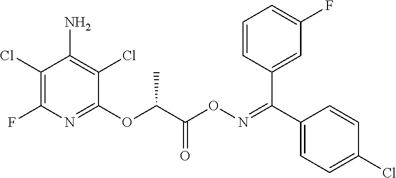 [SMILES: C[C@@H](Oc1nc(F)c(Cl)c(N)c1Cl)C(=O)O/N=C(/c1ccc(Cl)cc1)c1cccc(F)c1] | |
| A134 | 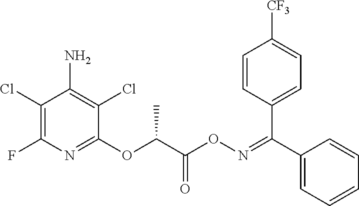 [SMILES: C[C@@H](Oc1nc(F)c(Cl)c(N)c1Cl)C(=O)O/N=C(/c1ccccc1)c1ccc(C(F)(F)F)cc1] | |
| A135 | 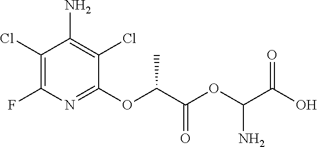 [SMILES: C[C@@H](Oc1nc(F)c(Cl)c(N)c1Cl)C(=O)OC(N)C(=O)O] | |
| A136 | 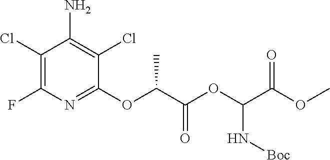 [SMILES: COC(=O)C(NC(=O)OC(C)(C)C)OC(=O)[C@@H](C)Oc1nc(F)c(Cl)c(N)c1Cl] | |
| A137 | 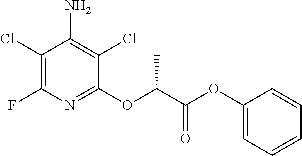 [SMILES: C[C@@H](Oc1nc(F)c(Cl)c(N)c1Cl)C(=O)Oc1ccccc1] | |
| A138 | 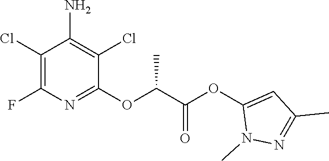 [SMILES: Cc1cc(OC(=O)[C@@H](C)Oc2nc(F)c(Cl)c(N)c2Cl)n(C)n1] | |
| A139 | 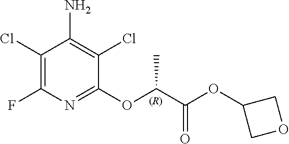 | |
| A140 | 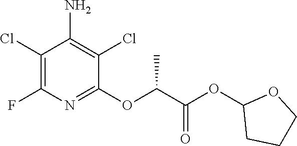 [SMILES: C[C@@H](Oc1nc(F)c(Cl)c(N)c1Cl)C(=O)OC1CCCO1] | |
| A141 | 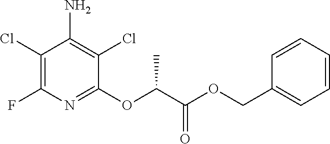 [SMILES: C[C@@H](Oc1nc(F)c(Cl)c(N)c1Cl)C(=O)OCc1ccccc1] | ¹H NMR (500 MHz, DMSO-d₆) δ 7.34-7.27 (m, 5H), 7.05 (s, 2H), 5.20-5.17 (m, 3H), 1.53 (d, J = 7.0 Hz, 3H). |
| A142 | 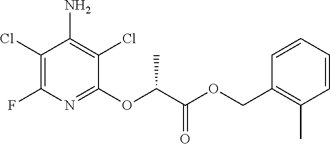 [SMILES: Cc1ccccc1COC(=O)[C@@H](C)Oc1nc(F)c(Cl)c(N)c1Cl] | |
| A143 | 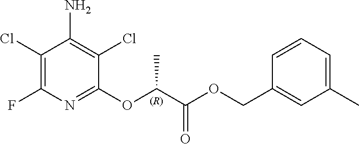 | |
| A144 | 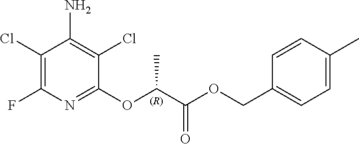 | |
| A145 | 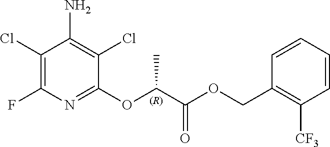 | |
| A146 | 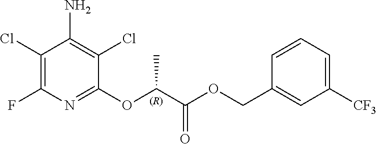 | |
| A147 | 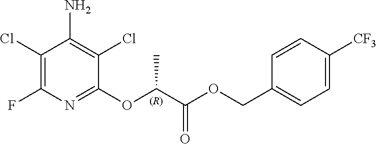 | |
| A148 | 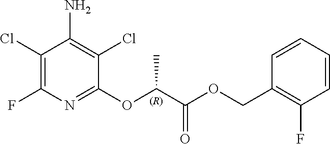 | |
| A149 | 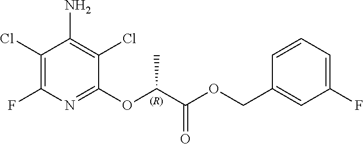 | |
| A150 | 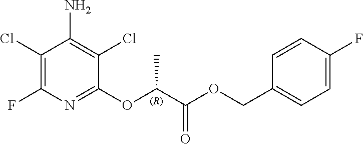 | |
| A151 | 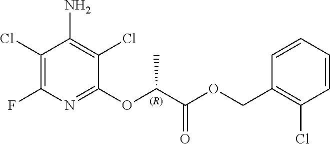 | |
| A152 | 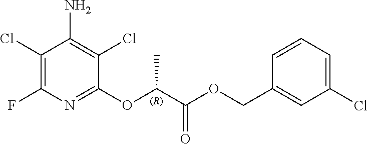 | |
| A153 | 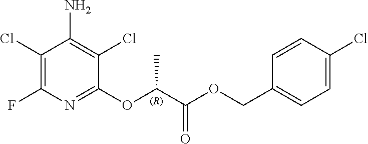 | |
| A154 | 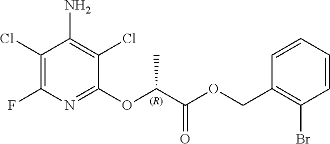 | |
| A155 | 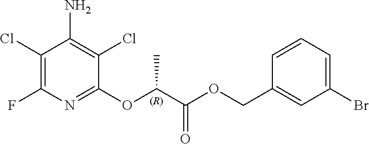 | |
| A156 | 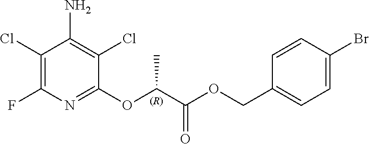 | |
| A157 | 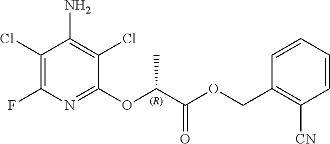 | |
| A158 | 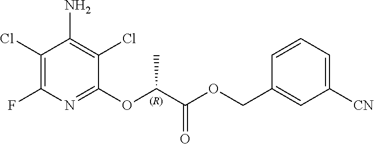 | |
| A159 | 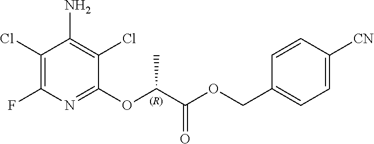 | |
| A160 | 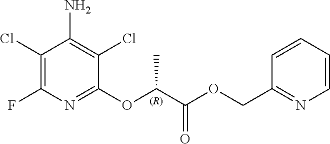 | |
| A161 | 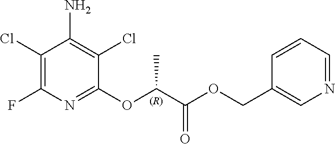 | |
| A162 | 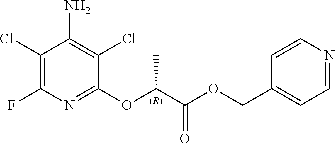 | |
| A163 | 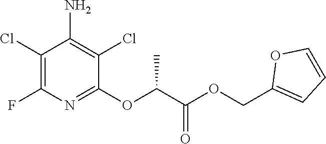 [SMILES: C[C@@H](Oc1nc(F)c(Cl)c(N)c1Cl)C(=O)OCc1ccco1] | ¹H NMR (500 MHz, Chloroform-d) δ 7.41 (d, J = 2.0 Hz, 1H), 6.41 (d, J = 3.5 Hz, 1H), 6.36 (dd, J = 3.5, 2.0 Hz, 1H), 5.25 (q, J = 7.0 Hz, 1H), 5.20-5.08 (m, 4H), 1.63 (d, J = 7.0 Hz, 3H). |
| A164 | 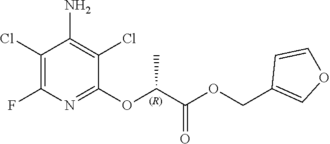 | |
| A165 | 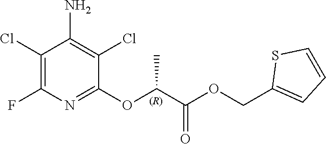 | |
| A166 | 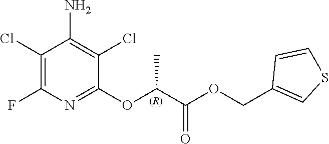 | |
| A167 | 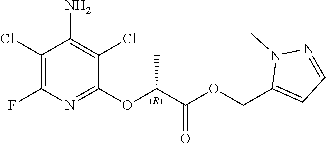 | |
| A168 | 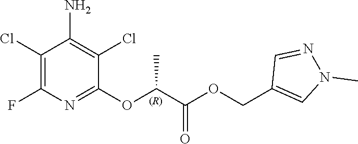 | |
| A169 | 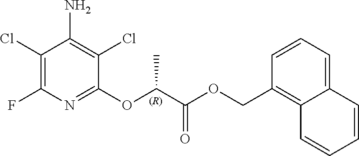 | |
| A170 | 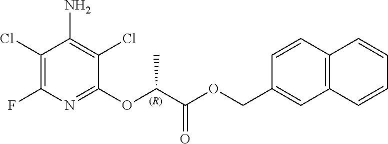 | |
| A171 | 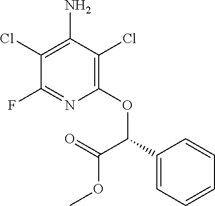 [SMILES: COC(=O)[C@H](Oc1nc(F)c(Cl)c(N)c1Cl)c1ccccc1] | ¹H NMR (500 MHz, Chloroform-d) δ 7.61- 7.63 (m, 2H), 7.38-7.45 (m, 3H), 6.13 (s, 1H), 5.18 (s, 2H), 3.73 (s, 3H). |
| A172 | 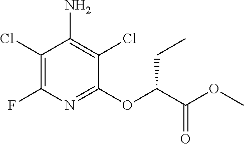 [SMILES: CC[C@@H](Oc1nc(F)c(Cl)c(N)c1Cl)C(=O)OC] | ¹H NMR (500 MHz, DMSO-d₆) δ 7.04 (s, 2H), 5.00-5.03 (m, 1H), 3.66 (s, 3H), 1.84-1.94 (m, 2H), 0.96-1.0 (m, 3H). |
| A173 | 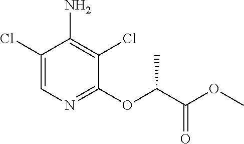 [SMILES: COC(=O)[C@@H](C)Oc1ncc(Cl)c(N)c1Cl] | ¹H NMR (500 MHz, DMSO-d₆) δ 7.61 (s, 1H), 6.80 (s, 2H), 4.63 (q, J = 7.0 Hz, 1H), 3.72 (s, 3H), 1.51 (d, J = 7.0 Hz, 3H). |
| A174 | 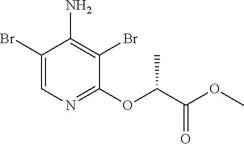 [SMILES: COC(=O)[C@@H](C)Oc1ncc(Br)c(N)c1Br] | |
| A175 | 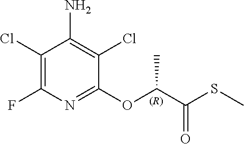 | |
| A176 | 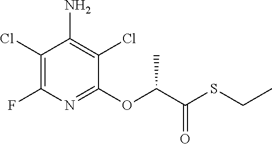 [SMILES: CCSC(=O)[C@@H](C)Oc1nc(F)c(Cl)c(N)c1Cl] | |
| A177 | 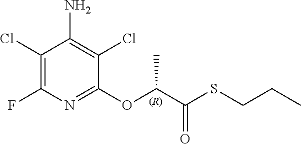 | |
| A178 | 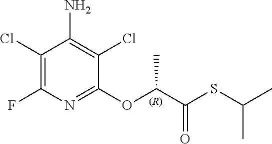 | |
| A179 | 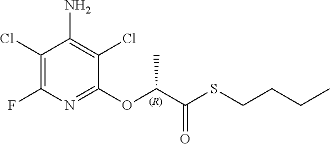 | |
| A180 | 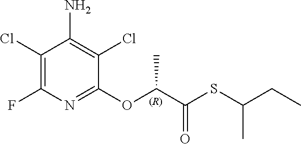 | |
| A181 | 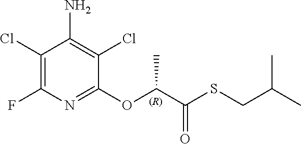 | |
| A182 | 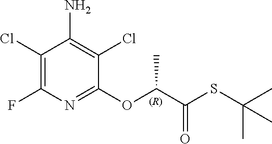 | |
| A183 | 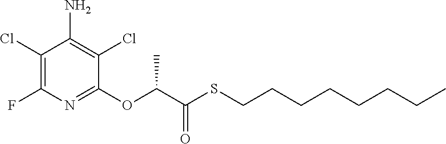 [SMILES: CCCCCCCCSC(=O)[C@@H](C)Oc1nc(F)c(Cl)c(N)c1Cl] | |
| A184 | 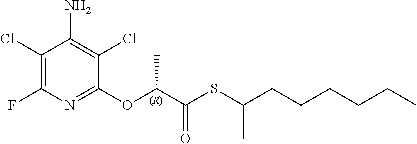 | |
| A185 | 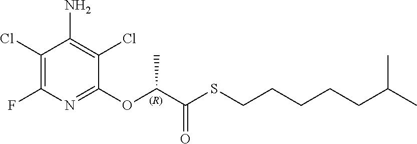 | |
| A186 | 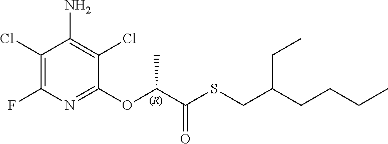 | |
| A187 | 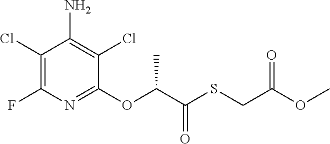 [SMILES: COC(=O)CSC(=O)[C@@H](C)Oc1nc(F)c(Cl)c(N)c1Cl] | |
| A188 | 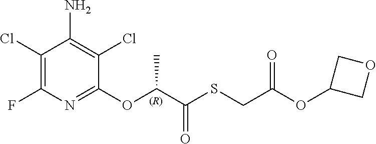 | |
| A189 | 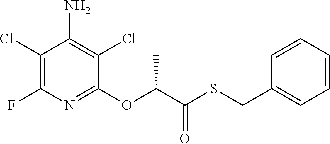 [SMILES: C[C@@H](Oc1nc(F)c(Cl)c(N)c1Cl)C(=O)SCc1ccccc1] | |
| A190 | 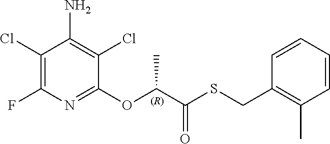 | |
| A191 | 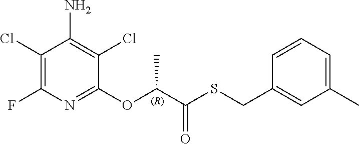 | |
| A192 | 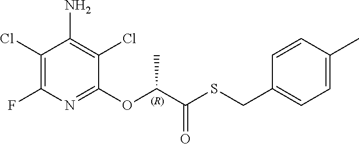 | |
| A193 | 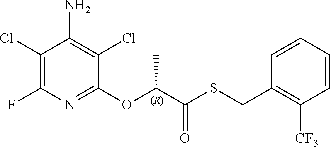 | |
| A194 | 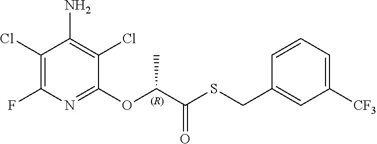 | |
| A195 | 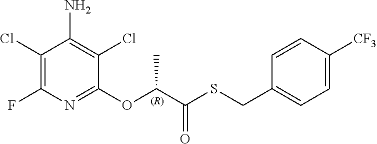 | |
| A196 | 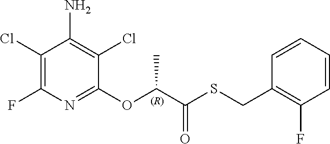 | |
| A197 | 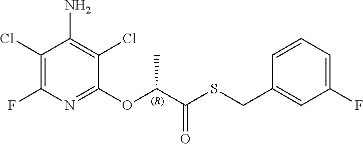 | |
| A198 | 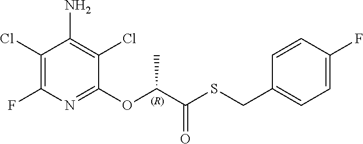 | |
| A199 | 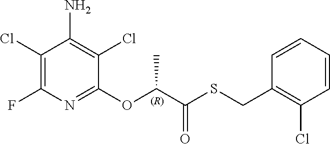 | |
| A200 | 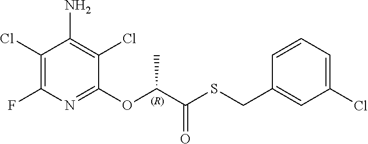 | |
| A201 | 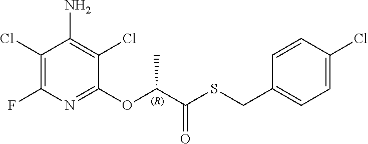 | |
| A202 | 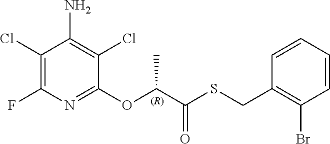 | |
| A203 | 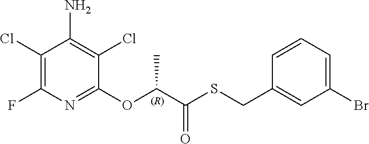 | |
| A204 | 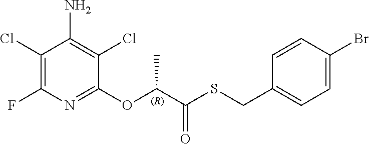 | |
| A205 | 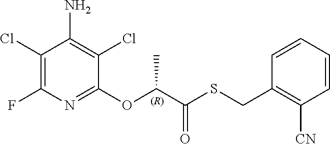 | |
| A206 | 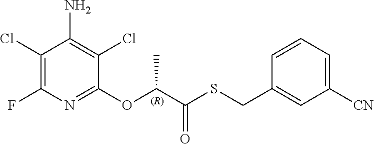 | |
| A207 | 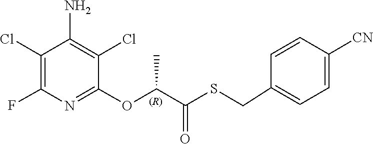 | |
| A208 | 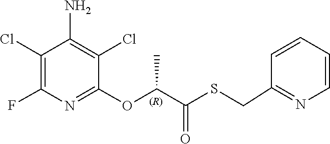 | |
| A209 | 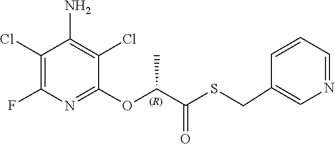 | |
| A210 | 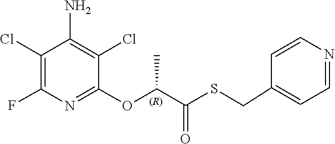 | |
| A211 | 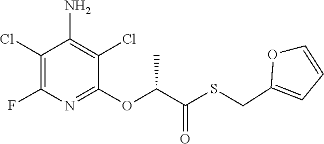 [SMILES: C[C@@H](Oc1nc(F)c(Cl)c(N)c1Cl)C(=O)SCc1ccco1] | ¹H NMR (500 MHz, Chloroform-d) δ 7.34 (d, J = 2.5, 1H), 6.32-6.30 (m, 1H), 6.13- 6.07 (m, 1H), 5.01 (q, J = 6.5 Hz, 1H), 4.74 (s, 2H), 4.46 (s, 2H), 1.72 (d, J = 6.5 Hz, 3H). |
| A212 | 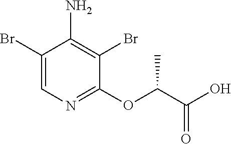 | ¹H NMR (500 MHz, Chloroform-d) δ 10.25 (s, 1H), 7.74 (s, 1H), 4.54 (q, J = 7.0 Hz, 1H), 3.50 (s, 2H), 1.72 (d, J = 7.0 Hz, 3H). |
| A213 | 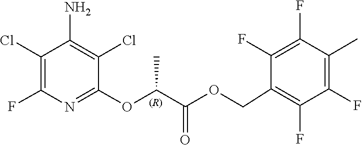 | ¹H NMR (500 MHz, Chloroform-d) δ 5.42 (s, 2H), 4.63 (q, J = 7.0 Hz, 1H), 4.43 (s, 2H), 2.33 (s, 3H), 1.65 (d, J = 7.0 Hz, 3H). |
| A214 | 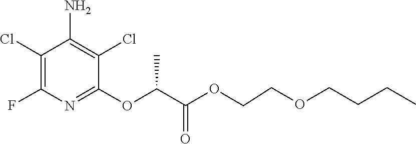 [SMILES: CCCCOCCOC(=O)[C@@H](C)Oc1nc(F)c(Cl)c(N)c1Cl] | ¹H NMR (500 MHz, Chloroform-d) δ 4.67 (q, J = 6.5 Hz, 1H), 4.45 (s, 2H), 4.20-4.09 (m, 2H), 3.38-3.12 (m, 3H), 3.04-2.95 (m, 1H), 1.61 (d, J = 6.5 Hz, 3H), 1.59- 1.15 (m, 4H), 1.03 (t, J = 7.5 Hz, 3H). |
| A215 | 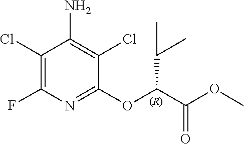 | |
| A216 | 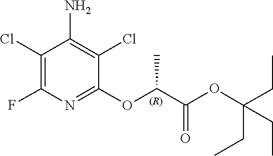 | |
| A217 | 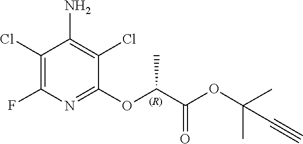 | |
| A218 | 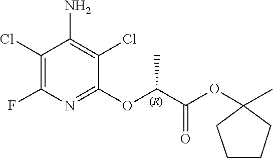 | |
| A219 | 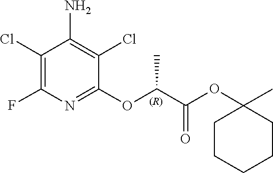 | |
| A220 | 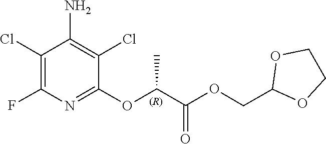 | |
| A221 | 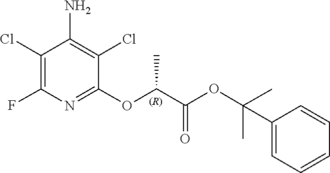 | |
| A222 | 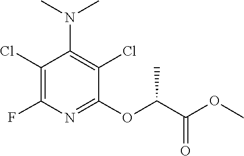 [SMILES: COC(=O)[C@@H](C)Oc1nc(F)c(Cl)c(N(C)C)c1Cl] | |
| A223 | 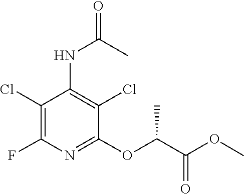 [SMILES: COC(=O)[C@@H](C)Oc1nc(F)c(Cl)c(NC(C)=O)c1Cl] | |

The preparation method of the active ingredient A comprises the following steps.

A compound of formula III is reacted with a compound of formula II to obtain a compound of formula I-1-1; the reaction scheme is as follows:

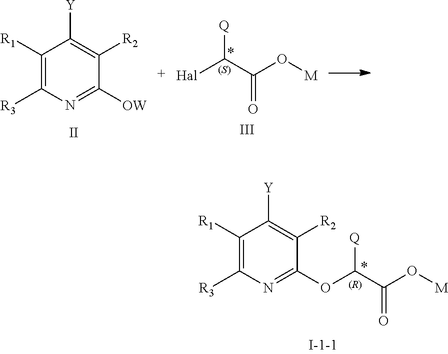

wherein, W represents hydrogen or an alkali metal, preferably K, Na; Hal represents halogen, preferably Br, Cl; the reaction is carried out in the presence of a catalyst and a solvent. Preferably, the catalyst is TBAB, and the solvent is one or more selected from the group consisting of DCM, DCE, ACN, THF, DMF.

The compound of formula I-1-1 is reacted in the presence of a lithium hydroxide aqueous solution and a solvent to obtain a compound of formula I; the reaction scheme is as follows:

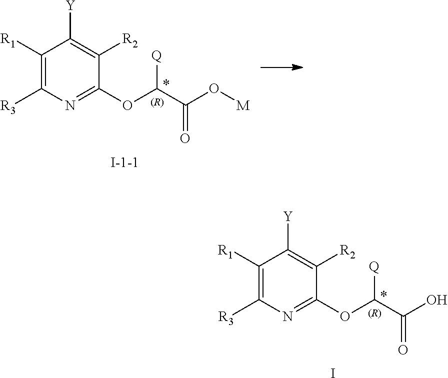

preferably, the solvent is one or more selected from the group consisting of methanol, ethanol, and isopropanol.

The compound of formula I is reacted with M-SH to obtain a compound of formula I-1-2; the reaction scheme is as follows:

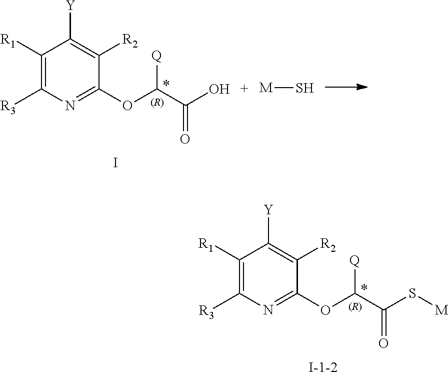

wherein, the reaction is carried out in the presence of a dehydrant and a solvent, preferably the dehydrant is DCC, and the solvent is one or more selected from the group consisting of dichloromethane, dichloroethane, acetonitrile, N,N-dimethylformamide, N,N-dimethylacetamide, dimethyl sulfoxide, tetrahydrofuran, toluene, xylene;

or, when Y represents NR₁R₂ (R₁, R₂ are not hydrogen at the same time), it is obtained by reacting a compound of formula I-2

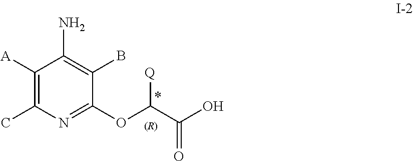

or a compound of formula I-1-3

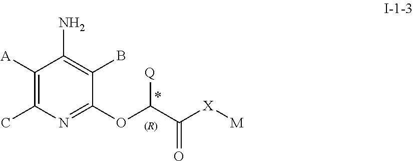

with a corresponding halide;

wherein, the halide is preferably chloride or bromide; the reaction is carried out in the presence of a base and a solvent, wherein the base is one or more selected from the group consisting of sodium hydroxide, potassium hydroxide, sodium carbonate, potassium carbonate, sodium bicarbonate and cesium carbonate; the solvent is one or more selected from the group consisting of THF, 1,4-dioxane, toluene, 1,2-dichloroethane, ethyl acetate, acetonitrile, DMF, acetone, dichloromethane and chloroform; a catalyst, preferably DMAP, is optionally added during the reaction.

The salt is an agrochemically acceptable salt, which is preferably prepared by reacting the R-pyridyloxycarboxylic acid compound of the present invention with a chemically acceptable basic compound. The aforesaid agrochemically acceptable salt can be easily separated and can be purified by conventional separation methods such as solvent extraction, dilution, recrystallization, column chromatography, and preparative thin layer chromatography.

In some embodiments, the active ingredient A to the active ingredient B is in a weight ratio of 1:100˜100:1 or 1:50˜50:1, preferably 1:30˜30:1 or 1:20˜20:1, more preferably 1:10˜10:1 or 1:8˜8:1, further preferably 1:5˜5:1 or 1:1˜2:1 or 1:1˜1:2.

In some embodiments, the active ingredients A and B together account for 1-95%, preferably 10-80%, of the total weight of the herbicidal composition.

The herbicidal composition may comprise a conventional adjuvant, the conventional adjuvant comprises, for example, a carrier and/or a surfactant.

The term “carrier” herein refers to an organic or inorganic, natural or synthetic substance, which facilitates the application of the active ingredients. In general, the carrier is inert and must be agriculturally acceptable, especially is acceptable to a plant to be treated. The carrier may be a solid, such as clay, a natural or synthetic silicate, silica, a resin, a wax, a solid fertilizer and so on; or a liquid such as water, an alcohol, a ketone, a petroleum fraction, an aromatic or paraffinic hydrocarbon, a chlorohydrocarbon, liquefied gas and so on.

The surfactant, which may be ionic or non-ionic, can include an emulsifier, a dispersant or a wetting agent. Examples which may be mentioned are a salt of polyacrylic acid, a salt of lignosulfonic acid, a salt of phenolsulfonic acid or of naphthalenesulfonic acid, a polymer of ethylene oxide with an aliphatic alcohol or with an aliphatic acid or with an aliphatic amine or with a substituted phenol (in particular, an alkylphenol or an arylphenol), a sulfosuccinate, a taurine derivative (especially an alkyl taurate) and a phosphoric ester of an alcohol or of a polyhydroxyethylated phenol, an alkyl sulfonate, an alkylaryl sulfonate, an alkyl sulfate, a laurylether sulfate, a fatty alcohol sulfate, a sulfated hexadecanol, heptadecanol and octadecanol and a sulfated fatty alcohol polyglycol ether, and further include a condensate of naphthalene or naphthalenesulfonic acid with phenol and formaldehyde, polyoxyethylene octylphenyl ether, ethoxylated isooctylphenol, octylphenol or nonylphenol, a polyethylene glycol alkylphenyl ether, a polyethylene glycol tributylphenyl ether, a polyethylene glycol tristearylphenyl ether, a alkylaryl polyether alcohol, an alcohol and fatty alcohol/ethylene oxide condensate, ethoxylated castor oil, a polyoxyethylene alkyl ether, an ethoxylated polyoxypropylene, a lauryl alcohol polyglycol ether acetal, a sorbitol ester, a lignin sulfite waste liquid, a protein, a denatured protein, a polysaccharide (e.g., methylcellulose), a hydrophobic modified starch, a polyvinyl alcohol, a polycarboxylate, a polyalkoxylate, a polyvinylamine, a polyvinylpyrrolidone, and a copolymer thereof. At least one surfactant may be required to facilitate dispersion of the active ingredient in water and proper application thereof to a plant.

The composition can also comprise various other components, such as a protective colloid, an adhesive, a thickener, a thixotropic agent, a penetrant, a stabilizer, a chelating agent, a dye, a colorant or a polymer.

In addition, the composition which can be combined with the active compounds are, for example, known active compounds as described in for example World Herbicide New Product Technology Handbook, China Agricultural Science and Farming Techniques Press, 2010.9 and in the literature cited therein. For example the following active compounds may be mentioned as herbicides (note: the compounds are either named by the “common name” in accordance with the International Organization for Standardization (ISO) or by the chemical names, if appropriate together with a customary code number): acetochlor, butachlor, alachlor, propisochlor, metolachlor, s-metolachlor, pretilachlor, propachlor, ethachlor, napropamide, R-left handed napropamide, propanil, mefenacet, diphenamid, diflufenican, ethaprochlor, beflubutamid, bromobutide, dimethenamid, dimethenamid-P, etobenzanid, flufenacet, thenylchlor, metazachlor, isoxaben, flamprop-M-methyl, flamprop-M-propyl, allidochlor, pethoxamid, chloranocryl, cyprazine, mefluidide, monalide, delachlor, prynachlor, terbuchlor, xylachlor, dimethachlor, cisanilide, trimexachlor, clomeprop, propyzamide, pentanochlor, carbetamide, benzoylprop-ethyl, cyprazole, butenachlor, tebutam, benzipram, mogrton, dichlofluanid, naproanilide, diethatyl-ethyl, naptalam, flufenacet, benzadox, chlorthiamid, chlorophthalimide, isocarbamide, picolinafen, atrazine, simazine, prometryn, cyanatryn, simetryn, ametryn, propazine, dipropetryn, SSH-108, terbutryn, terbuthylazine, triaziflam, cyprazine, proglinazine, trietazine, prometon, simetone, aziprotryne, desmetryn, dimethametryn, procyazine, mesoprazine, sebuthylazine, secbumeton, terbumeton, methoprotryne, cyanatryn, ipazine, chlorazine, atraton, pendimethalin, eglinazine, cyanuric acid, indaziflam, chlorsulfuron, metsulfuron-methyl, bensulfuron methyl, chlorimuron-ethyl, tribenuron-methyl, thifensulfuron-methyl, pyrazosulfuron-ethyl, mesosulfuron, iodosulfuron-methyl sodium, foramsulfuron, cinosulfuron, triasulfuron, sulfometuron methyl, nicosulfuron, ethametsulfuron-methyl, amidosulfuron, ethoxysulfuron, cyclosulfamuron, rimsulfuron, azimsulfuron, flazasulfuron, monosulfuron, monosulfuron-ester, flucarbazone-sodium, flupyrsulfuron-methyl, halosulfuron-methyl, oxasulfuron, imazosulfuron, primisulfuron, propoxycarbazone, prosulfuron, sulfosulfuron, trifloxysulfuron, triflusulfuron-methyl, tritosulfuron, sodium metsulfuron methyl, flucetosulfuron, HNPC-C, orthosulfamuron, propyrisulfuron, metazosulfuron, acifluorfen, fomesafen, lactofen, fluoroglycofen, oxyfluorfen, chlornitrofen, aclonifen, ethoxyfen-ethyl, bifenox, nitrofluorfen, chlomethoxyfen, fluorodifen, fluoronitrofen, furyloxyfen, nitrofen, TOPE, DMNP, PPG1013, AKH-7088, halosafen, chlortoluron, isoproturon, linuron, diuron, dymron, fluometuron, benzthiazuron, methabenzthiazuron, cumyluron, ethidimuron, isouron, tebuthiuron, buturon, chlorbromuron, methyldymron, phenobenzuron, SK-85, metobromuron, metoxuron, afesin, monuron, siduron, fenuron, fluothiuron, neburon, chloroxuron, noruron, isonoruron, 3-cyclooctyl-1, thiazfluron, tebuthiuron, difenoxuron, parafluron, methylamine tribunil, karbutilate, trimeturon, dimefuron, monisouron, anisuron, methiuron, chloreturon, tetrafluron, phenmedipham, phenmedipham-ethyl, desmedipham, asulam, terbucarb, barban, propham, chlorpropham, rowmate, swep, chlorbufam, carboxazole, chlorprocarb, fenasulam, BCPC, CPPC, carbasulam, butylate, benthiocarb, vernolate, molinate, triallate, dimepiperate, esprocarb, pyributicarb, cycloate, avadex, EPTC, ethiolate, orbencarb, pebulate, prosulfocarb, tiocarbazil, CDEC, dimexano, isopolinate, methiobencarb, 2,4-D butyl ester, MCPA-Na, 2,4-D isooctyl ester, MCPA isooctyl ester, 2,4-D sodium salt, 2,4-D dimethylamine salt, MCPA-thioethyl, MCPA, 2,4-D propionic acid, high 2,4-D propionic acid salt, 2,4-D butyric acid, MCPA propionic acid, MCPA propionic acid salt, MCPA butyric acid, 2,4,5-D, 2,4,5-D propionic acid, 2,4,5-D butyric acid, MCPA amine salt, dicamba, erbon, chlorfenac, saison, TBA, chloramben, methoxy-TBA, diclofop-methyl, fluazifop-butyl, fluazifop-p-butyl, haloxyfop-methyl, haloxyfop-P, quizalofop-ethyl, quizalofop-p-ethyl, fenoxaprop-ethy, fenoxaprop-p-ethyl, propaquizafop, cyhalofop-butyl, metamifop, clodinafop-propargyl, fenthiaprop-ethyl, chloroazifop-propynyl, poppenate-methyl, trifopsime, isoxapyrifop, paraquat, diquat, oryzalin, ethalfluralin, isopropalin, nitralin, profluralin, prodinamine, benfluralin, fluchloraline, dinitramina, dipropalin, chlornidine, methalpropalin, dinoprop, glyphosate, anilofos, glufosinate ammonium, amiprophos-methyl, sulphosate, piperophos, bialaphos-sodium, bensulide, butamifos, phocarb, 2,4-DEP, H-9201, zytron, imazapyr, imazethapyr, imazaquin, imazamox, imazamox ammonium salt, imazapic, imazamethabenz-methyl, fluroxypyr, fluroxypyr isooctyl ester, clopyralid, picloram, trichlopyr, dithiopyr, haloxydine, 3,5,6-trichloro-2-pyridinol, thiazopyr, fluridone, aminopyralid, diflufenzopyr, triclopyr-butotyl, Cliodinate, sethoxydim, clethodim, cycloxydim, alloxydim, clefoxydim, butroxydim, tralkoxydim, tepraloxydim, buthidazole, metribuzin, hexazinone, metamitron, ethiozin, ametridione, amibuzin, bromoxynil, bromoxynil octanoate, ioxynil octanoate, ioxynil, dichlobenil, diphenatrile, pyraclonil, chloroxynil, iodobonil, flumetsulam, florasulam, penoxsulam, metosulam, cloransulam-methyl, diclosulam, pyroxsulam, benfuresate, bispyribac-sodium, pyribenzoxim, pyriftalid, pyriminobac-methyl, pyrithiobac-sodium, benzobicylon, mesotrione, sulcotrione, tembotrione, tefuryltrione, bicyclopyrone, ketodpiradox, isoxaflutole, clomazone, fenoxasulfone, methiozolin, fluazolate, pyraflufen-ethyl, pyrazolynate, difenzoquat, pyrazoxyfen, benzofenap, nipyraclofen, pyrasulfotole, topramezone, pyroxasulfone, cafenstrole, flupoxam, aminotriazole, amicarbazone, azafenidin, carfentrazone-ethyl, sulfentrazone, bencarbazone, benzfendizone, butafenacil, bromacil, isocil, lenacil, terbacil, flupropacil, cinidon-ethyl, flumiclorac-pentyl, flumioxazin, propyzamide, MK-129, flumezin, pentachlorophenol, dinoseb, dinoterb, dinoterb acetate, dinosam, DNOC, chloronitrophene, medinoterb acetate, dinofenate, oxadiargyl, oxadiazon, pentoxazone, Flufenacet, fluthiacet-methyl, fentrazamide, flufenpyr-ethyl, pyrazon, brompyrazon, metflurazon, kusakira, dimidazon, oxapyrazon, norflurazon, pyridafol, quinclorac, quinmerac, bentazone, pyridate, oxaziclomefone, benazolin, clomazone, cinmethylin, ZJ0702, pyribambenz-propyl, indanofan, sodium chlorate, dalapon, trichloroacetic acid, monochloroacetic acid, hexachloroacetone, flupropanate, cyperquat, bromofenoxim, epronaz, methazole, flurtamone, benfuresate, ethofumesate, tioclorim, chlorthal, fluorochloridone, tavron, acrolein, bentranil, tridiphane, chlorfenpropmethyl, thidiarizonaimin, phenisopham, busoxinone, methoxyphenone, saflufenacil, clacyfos, chloropon, alorac, diethamquat, etnipromid, iprymidam, ipfencarbazone, thiencarbazone-methyl, pyrimisulfan, chlorflurazole, tripropindan, sulglycapin, prosulfalin, cambendichlor, aminocyclopyrachlor, rodethanil, benoxacor, fenclorim, flurazole, fenchlorazole-ethyl, cloquintocet-mexyl, oxabetrinil, MG/91, cyometrinil, DKA-24, mefenpyr-diethyl, furilazole, fluxofenim, isoxadifen-ethyl, dichlormid, halauxifen-methyl, DOW florpyrauxifen, UBH-509, D489, LS 82-556, KPP-300, NC-324, NC-330, KH-218, DPX-N8189, SC-0744, DOWCO535, DK-8910, V-53482, PP-600, MBH-001, KIH-9201, ET-751, KIH-6127 and KIH-2023.

The herbicidal composition may further comprise one or more safeners, which is one or more compounds selected from,

a) Compounds of the dichlorophenylpyrazoline-3-carboxylic acid (S1) type, preferably compounds such as ethyl 1-(2,4-dichlorophenyl)-5-(ethoxycarbonyl)-5-methyl-2-pyrazoline-3-carboxylate (S1-1, mefenpyr-diethyl, PM, pp. 594-595), and related compounds as they are described for example in WO 91/07874 and PM (pp. 594-595).

b) Dichlorophenylpyrazolecarboxylic acid derivatives, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethyl-ethyl) pyrazole-3-carboxylate (S1-4), ethyl-1-(2,4-dichlorophenyl)-5-phenylpyrazole-3-carboxylate (S1-5) and related compounds as are described in EP-A-333 131 and EP-A-269 806.

c) Compounds of the triazolecarboxylic acid (S1) type, preferably compounds such as fenchlorazole, i.e. ethyl 1-(2,4-dichlorophenyl)-5-trichloromethyl-(1H)-1,2,4-triazole-3-carboxylate (S1-6) and related compounds (see EP-A-174 562 and EP-A-346 620).

d) Compounds of the 5-benzyl- or 5-phenyl-2-isoxazoline-3-carboxylic acid type or of the 5,5-diphenyl-2-isoxazoline-3-carboxylic acid type, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds as are described in WO 91/08202, or of ethyl 5,5-diphenyl-2-isoxazoline-3-carboxylate (S1-9, isoxadifen-ethyl) or n-propyl 5,5-diphenyl-2-isoxazoline-3-carboxylate (S1-10) or ethyl 5-(4-fluorophenyl)-5-phenyl-2-isoxazoline-3-carboxylate (S1-11), as are described in patent application (WO-A-95/07897).

e) Compounds of the 8-quinoline oxyacetic acid (S2) type, preferably 1-methylhex-1-yl (5-chloro-8-quinolinoxy)acetate (S2-1, cloquintocet-mexyl, e.g. PM (pp. 195-196), (1,3-dimethylbut-1-yl) (5-chloro-8-quinolinoxy)acetate (S2-2), 4-allyloxybutyl (5-chloro-8-quinolinoxy) acetate (S2-3), 1-allyloxyprop-2-yl(5-chloro-8-quinolinoxy)acetate (S2-4), ethyl (5-chloro-8-quinolinoxy) acetate (S2-5), methyl (5-chloro-8-quinolinoxy)acetate (S2-6), allyl (5-chloro-8-quinolinoxy)acetate (S2-7), 2-(2-propylideneiminooxy)-1-ethyl (5-chloro-8-quinolinoxy)acetate (S2-8), 2-oxoprop-1-yl (5-chloro-8-quinolinoxy)acetate (S2-9) and related compounds as are described in EP-A-86750, EP-A-94349 and EP-A-191736 or EP-A-0492366.

f) Compounds of the (5-chloro-8-quinolinoxy)malonic acid type, preferably compounds such as diethyl (5-chloro-8-quinolinoxy)malonate, diallyl (5-chloro-8-quinolinoxy)malonate, methyl ethyl (5-chloro-8-quinolinoxy)-malonate and related compounds as are described in EP-A-0582 198.

g) Active compounds of the phenoxyacetic acids, phenoxypropionic acids or aromatic carboxylic acids type, such as, for example, 2,4-dichlorophenoxyacetic acid (and esters) (2,4-D), 4-chloro-2-methylphenoxypropionic esters (mecoprop), MCPA or 3,6-dichloro-2-methoxybenzoic acid (and esters) (dicamba).

h) active compounds of the pyrimidine type, such as, for example, “fenclorim” (PM, pp. 386-387) (=4,6-dichloro-2-phenylpyrimidine).

i) active compounds of the dichloroacetamide type, which are frequently used as pre-emergence safeners (soil-acting safeners) such as, for example, “dichloromid” (PM, pp. 270-271) (=N,N-diallyl-2,2-dichloroacetamide), “AR-29148” (=3-dichloroacetyl-2,2,5-trimethyl-1,3-oxazolido ne by Stauffer), “benoxacor” (PM, pp. 74-75) (=4-dichloroacetyl-3,4-dihydro-3-methyl-2H-1,4-benzoxazine), “APPG-1292” (=N-allyl-N[(1,3-dioxolan-2-yl)-methyl]dichloroacetamide by PPG Industries), “ADK-24” (=N-allyl-N-[(allylaminocarbonyl)-methyl]-dichloroacetamide by Sagro-Chem), “AAD-67” or “AMON 4660” (=3-dichloroaceryl-1-oxa-3-aza-spiro[4,5]decane by Nirrokemia or Monsanto), “diclonon” or “ABAS145138” or “ALAB145138” (=(=3-dichloroacetyl-2,5,5-trimethyl-1,3-diazabicyclo[4.3.0]nonane by BASF) and“furilazol” or “AMON 13900” (see PM, 482-483) (=(RS)-3-dichloroacetyl-5-(2-furyl)-2,2-dimethyloxazoli done).

j) active compounds of the dichloroacetone derivatives type, such as, for example, “AMG 191” (CAS Reg. No. 96420-72-3) (=2-dichloromethyl-2-methyl-1,3-dioxolane by Nitrokemia).

k) active compounds of the oxyimino compounds type which are known as seed-dressing materials such as, for example, “oxabetrinil” (PM, p. 689) HZ)-1,3-dioxolan-2-ylmethoxyimino (phenyl)acetonitrile), which is known as safener in seed dressing to prevent metolachlor damage, “fluxofenim” (PM, pp. 467-468) (=1-(4-chlorophenyl)-2,2,2-trifluoro-1-ethanone O-(1,3-dioxolan-2-ylmethyl)-oxime, which is known as safener in seed dressing to prevent metolachlor damage, and “cyometrinil” or “A-CGA-43089” (PM, p. 983) (=(Z)-cyanomethoxyimino(phenyl)acetonitrile), which is known as safener in seed dressing to prevent metolachlor damage.

l) active compounds of the thiazolecarboxylic esters type, which are known as seed-dressing materials, such as, for example, “flurazol” (PM, pp. 450-451) (=benzyl 2-chloro-4-trifluoromethyl-1,3-thiazole-5-carboxylate), which is known as safener in seed dressing to prevent alachlor and metolachlor damage.

m) active compounds of the naphthalenedicarboxylic acid derivatives type which are known as seed-dressing agents, such as, for example, “naphthalic anhydride” (PM, pp. 1009-1010) (=1,8-naphthalenedicarboxylic anhydride), which is known as safener for maize in seed dressing to prevent thiocarbamate herbicide damage.

n) active compounds of the chromaneacetic acid derivatives type, such as, for example, “ACL 304415” (CAS Reg. No. 31541-57-8) (=2-84-carboxychroman-4-yl)acetic acid by American Cyanamid).

o) active compounds which, in addition to a herbicidal action against harmful plants, also have a safener action on crop plants, such as, for example, “dimepiperate” or “AMY-93” (PM, pp. 302-303) (=S-1-methyl-1-phenylethyl piperidine-1-carbothioate), “daimuron” or “ASK 23” (PM, p. 247)(=1-(1-methyl-1-phenylethyl)-3-p-tolylurea), “cumyluron”=“AJC-940” (=3-(2-chlorophenyl methyl)-1-(1-methyl-1-phenyl-ethyl)urea, see JP-A-60087254), “methoxyphenon” or “ANK 049” (=3,3′-dimethyl-4-methoxy-benzophenone), “CSB” (=l-bromo-4-(chloromethylsulfonyl) benzene) (CAS Reg. No. 54091-06-4 by Kumiai).

In a preferred embodiment, the safener is one or more compounds selected from, for example, isoxadifen-ethyl (CAS NO.: 163520-33-0), cyprosulfamide (CAS NO.: 221667-31-8), mefenpyr-diethyl (CAS NO.: 135590-91-9), cloquintocet-mexyl (CAS NO.: 99607-70-2), gibberellic acid (CAS NO.: 77-06-5), furilazole (CAS NO.: 121776-33-8), metcamifen (CAS NO.: 129531-12-0).

In the context of the present specification, if an abbreviation of a generic name of an active compound is used, it includes in each case all customary derivatives, such as esters and salts, as well as isomers, in particular optical isomers, especially one or more commercially available forms. If the generic name denotes an ester or a salt, it also includes in each case all other conventional derivatives, such as other esters and salts, free acids and neutral compounds, as well as isomers, in particular optical isomers, especially one or more commercially available forms. The chemical name given to a compound means at least one compound encompassed by the generic name, and generally the preferred compound. In the case of sulfonamides such as sulfonylurea, salts also include salts formed by the exchange of cations with hydrogen atoms in the sulfonamide group. For example, 2-methyl-4-chloro derivatives include but are not limited to: 2-methyl-4-chloro sodium salt, -potassium salt, -dimethylammonium salt, -isopropylamine salt, etc., as well as 2-methyl-4-chloro methyl ester, -ethyl ester, -isooctyl ester, -thioethyl, etc.; 2,4-D derivatives include but are not limited to: 2,4-D salt such as sodium salt, potassium salt, dimethylammonium salt, triethanolammonium salt, isopropylamine salt, choline, etc., and 2,4-D esters such as methyl ester, ethyl ester, butyl ester, isooctyl ester, etc.

In the context of the present invention, the salts of the compounds are preferably in the form of respective alkali metal salts, alkaline earth metal salts or ammonium salts, preferably in the form of respective alkali metal salts, more preferably in the form of respective sodium or potassium salts, most preferably in the form of the respective sodium salt.

The composition of the present invention may be diluted prior to use or used directly by users. The composition can be prepared through a conventional processing method, that is, the active ingredient(s) is mixed with a liquid solvent or a solid carrier, and then one or more of the surfactants such as a dispersant, a stabilizer, a wetting agent, an adhesive, or a defoaming agent, etc. are added.

The herbicidal composition may be in a form of a formulation which is selected from: a dispersible oil suspension, a water suspension, a suspoemulsion, a wettable powder, an emulsifiable concentrate, a water-dispersible granule (a dry suspension), an aqueous emulsion and a microemulsion.

In short, the composition of the present invention can be mixed with solid and liquid additives conventionally used in formulations of the prior art. As the external conditions change, the amount of active ingredients used is also different. The external conditions are, for example, temperature, humidity, the nature of the herbicide used, etc. It can have a large variation range, for example between 0.001 and 1.0 kg/ha, or more active substances, but preferably between 0.005 and 750 g/ha, especially between 0.005 and 500 g/ha.

In addition, the composition according to the invention can be sprayed to a leaf of a plant to be treated, i.e., the composition of the invention can be applied to a weed, especially to the weed, and particularly to a surface of the weed from where the weed invades or is likely to invade crops.

Further, the present invention also provides use of the herbicidal composition for controlling weeds; and provides a method for controlling unwanted plant growth, which comprises applying the herbicidal composition to plants, plant parts, plants seed or plant growing area; preferably, the herbicidal composition being used to selectively control a weed in a useful crop; more preferably, the useful crop is genetically modified crop or a crop treated by gene editing technology.

Compounds of the invention are useful in treating all plants and plant parts. Plant varieties and cultivars can be obtained by conventional propagation and breeding methods or by genetic engineering methods. Genetically modified plants (transgenic plants) are those in which a heterologous gene (transgene) has been stably integrated into the plant's genome. A transgene that is defined by its particular location in the plant genome is called a transformation or transgenic event.

Genetically modified plant cultivars which can be treated according to the invention include those that are resistant against one or more biotic stresses (pests such as nematodes, insects, mites, fungi, etc.) or abiotic stresses (drought, cold temperature, soil salinity, etc.), or that contain other desirable characteristics. Plants can be genetically modified to exhibittraits of, for example, herbicide tolerance, insect-resistance, modified oil profiles or drought tolerance. Useful genetically modified plants containing single gene transformation events or combinations of transformation events are listed in Table 1. Additional information for the genetic modifications listed in Table 1 can be obtained from publicly available databases maintained, for example, by the U.S. Department of Agriculture.

The following abbreviations, T1 through T37, are used in Table 1 or traits. A “-” means the entry is not available.

| Trait | Description |
|---|---|
| T1 | Glyphosate tolerance |
| T2 | High lauric acid oil |
| T3 | Glufosinate tolerance |
| T4 | Phytate breakdown |
| T5 | Oxynil tolerance |
| T6 | Disease resistance |
| T7 | Insect resistance |
| T9 | Modified flower color |
| Ti1 | ALS Herbicide Tol. |
| T12 | Dicamba Tolerance |
| T13 | Anti-allergy |
| T14 | Salt tolerance |
| T15 | Cold tolerance |
| T16 | Imidazolinone herb tol. |
| T17 | Modified alpha-amylase |
| T18 | Pollination control |
| T19 | 2,4-D tolerance |
| T20 | Increased lysine |
| T21 | Drought tolerance |
| T22 | Delayed ripening/senescence |
| T23 | Modified product quality |
| T24 | High cellulose |
| T25 | Modified starch/carbohydrate |
| T26 | Insect & disease resist. |
| T27 | High trytophan |
| T28 | Erect leaves semidwarf |
| T29 | Semidwarf |
| T30 | Low iron tolerance |
| T31 | Modified oil/fatty acid |
| T32 | HPPD tolerance |
| T33 | High oil |
| T34 | Aryloxyalkanoate tol. |
| T35 | Mesotrione tolerance |
| T36 | Reduced nicotine |
| T37 | Modified product |

Genetically modified plants are shown in Table 1.

| Crop | Event Name | Event Code | Trait(s) | Gene(s) |
|---|---|---|---|---|
| Alfalfa | J101 | MON-0101-8 | T1 | cp4-epsps (aroA:CP4) |
| Alfalfa | J163 | MON-ØØ163-7 | T1 | cp4-epsps (aroA:CP4) |
| Canola* | 23-18-17 (Event 18) | CGN-89465-2 | T2 | te |
| Canola* | 23-198 (Event 23) | CGN-89465-2 | T2 | te |
| Canola* | 61061 | DP-Ø61Ø61-7 | T1 | ga [symbol] 4621 |
| Canola* | 73496 | DP-Ø73496-4 | T1 | ga [symbol] 4621 |
| Canola* | GT200 (RT200) | MON-89249-2 | T1 | cp4-epsps (aroA:CP4); goxv247 |
| Canola* | GT43 (RT73) | MON-ØØØ73-7 | T1 | cp4-epsps (aroA:CP4); goxv247 |
| Canola* | HCN10 (Topas 19/2) | — | T3 | bar |
| Canola* | HCN28 (T45) | ACS-BNØØ8-2 | T3 | pat (syn) |
| Canola* | HCN92 (Topas 19/2) | ACS-BNØØ7-1 | T3 | bar |
| Canola* | MON88302 | MON-883Ø2-9 | T1 | cp4-epsps (aroA:CP4) |
| Canola* | MPS961 | — | T4 | phyA |
| Canola* | MPS962 | — | T4 | phyA |
| Canola* | MPS963 | — | T4 | phyA |
| Canola* | MPS964 | — | T4 | phyA |
| Canola* | MPS965 | — | T4 | phyA |
| Canola* | MS1 (B91-4) | ACS-BNØØ4-7 | T [symbol] | bar |
| Canola* | MS8 | ACS-BNØØ5-8 | T3 | bar |
| Canola* | OXT-235 | ACS-BNØ11-5 | T5 | bxn |
| Canola* | PHY14 | — | T3 | bar |
| Canola* | PHY23 | — | T3 | bar |
| Canola* | PHY35 | — | T3 | bar |
| Canola* | PHY36 | — | T3 | bar |
| Canola* | RF1 (B93-101) | ACS-BNØØ1-4 | T3 | bar |
| Canola* | RF2 (B94-2) | ACS-BNØØ2-5 | T3 | bar |
| Canola* | RF3 | ACS-BNØØ3-6 | T3 | bar |
| Bean | EMBRAPA- 5.1 | EMB-PV051-1 | T6 | acl (sense and antisense) |
| Brinjal # | EE-1 | — | T7 | cry 1Ac |
| Cotton | 19-51a | DD-Ø1951A-7 | T11 | S4-HrA |
| Cotton | 281-24-236 | DAS-24236-5 | T3, T7 | pat (syn); cry1F |
| Cotton | 3006-210-23 | DAS-21Ø23-5 | T3, T7 | pat (syn); cry lAc |
| Cotton | 31707 | — | T5, T7 | bxn; cry1Ac |
| Cotton | 31803 | — | T5, T7 | bxn; cry1Ac |
| Cotton | 31807 | — | T5, T7 | bxn; cry1Ac |
| Cotton | 31808 | — | T5, T7 | bxn; cry1Ac |
| Cotton | 42317 | — | T5, T7 | bxn; cry1Ac |
| Cotton | BNLA-601 | — | T7 | cry1Ac |
| Cotton | BXN10211 | BXN10211-9 | T5 | bxn; cry1Ac |
| Cotton | BXN10215 | BXN10215-4 | T5 | bxn; cry1Ac |
| Cotton | BXN10222 | BXN10222-2 | T5 | bxn; cry1Ac |
| Cotton | BXN10224 | BXN10224-4 | T5 | bxn; cry1Ac |
| Cotton | COT102 | SYB-IR102-7 | T7 | vip3A(a) |
| Cotton | COT67B | SYB-IR67B-1 | T7 | cry1Ab |
| Cotton | COT202 | — | T7 | vip3A |
| Cotton | Event 1 | — | T7 | cry1Ac |
| Cotton | GMF Cry1A | GTL-GMF311-7 | T7 | cry1Ab-Ac |
| Cotton | GHB119 | BCS-GH005-8 | T7 | cry2Ac |
| Cotton | GHB614 | BCS-GH002-5 | T1 | 2mepsps |
| Cotton | GK12 | — | T7 | cry1Ab-Ac |
| Cotton | LLCotton25 | ACS-GH001-3 | T3 | bar |
| Cotton | MLS9124 | — | T7 | cry1C |
| Cotton | MON1076 | MIN-89924-2 | T7 | cry1Ac |
| Cotton | MON1445 | MON-01445-2 | T1 | cp4 epsps (aroA:CP4) |
| Cotton | MON15985 | MON-15985-7 | T7 | cry1Ac; cry2Ab2 |
| Cotton | MON1698 | MON-89393-1 | T7 | cp4 epsps (aroA:CP4) |
| Cotton | MON531 | MON-00531-6 | T7 | cry1Ac |
| Cotton | MON757 | MON-00757-7 | T7 | cry1Ac |
| Cotton | MON88913 | MON-88913-8 | T1 | cp4 epsps (aroA:CP4) |
| Cotton | Nqwe Chi 6 Bt | — | T7 | — |
| Cotton | SKG321 | — | T7 | cry1A; CpTI |
| Cotton | T303-3 | BCS-GH003-6 | T3, T7 | cry1Ab; bar |
| Cotton | 304-40 | BCS-GH004-7 | T3, T7 | cry1Ab; bar |
| Cotton | CE43-67B | — | T7 | cry1Ab |
| Cotton | CE46-02A | — | T7 | cry1Ab |
| Cotton | CE44-69D | — | T7 | cry1Ab |
| Cotton | 1143-14A | — | T7 | cry1Ab |
| Cotton | 1143-51B | — | T7 | cry1Ab |
| Cotton | T342-142 | — | T7 | cry1Ab |
| Cotton | PV-GBGT07 (1445) | — | T1 | cp4 epsps (aroA:CP4) |
| Cotton | EE-GH3 | — | T1 | mepsps |
| Cotton | EE-GH5 | — | T7 | cry1Ab |
| Cotton | MON88701 | MON-887013 | T3, T12 | Modified dmo; bar |
| Cotton | OsCr11 | — | T13 | Cryj |
| Flax | FP967 | CDC-FL001-2 | T11 | [symbol] |
| Lentil | RH44 | — | T16 | [symbol] |
| Maize | 3272 | SYN-E3272-4 | T17 | amy797E |
| Maize | 5307 | SYN-05307-1 | T7 | ecly3.1Ab |
| Maize | 59122 | DAS-59122-7 | T3, T7 | cry34Ab1; cry35Ab1; pat |
| Maize | 676 | PH-000676-7 | T3, T18 | pat; dam |
| Maize | 678 | PH-000678-9 | T3, T18 | pat; dam |
| Maize | 680 | PH-000680-2 | T3, T18 | pat; dam |
| Maize | 98140 | DP-098140-6 | T1, T11 | gat4621; zm-hra |
| Maize | B [symbol] 0 | — | T3, T7 | cry1Ab; pat |
| Maize | B [symbol] 176 (176) | SYN-EV176-9 | T3, T7 | cry1Ab; bar |
| Maize | BVLA30101 | — | T4 | phyA2 |
| Maize | CBH-351 | ACS-ZM004-3 | T3, T7 | cry9C; bar |
| Maize | DAS40278-9 | DAS40278-9 | T19 | asd-1 |
| Maize | DBT418 | DKB-89614-9 | T3, T7 | cry1Ac; pinll; bar |
| Maize | DLL25 (B16) | DKB-89790-5 | T3 | bar |
| Maize | GA21 | MON- [symbol] 021-9 | T1 | mepsps |
| Maize | GG25 | — | T1 | mepsps |
| Maize | GJ11 | — | T1 | mepsps |
| Maize | [symbol] 117 | — | T1 | mepsps |
| Maize | GAT-ZM1 | — | T3 | pat |
| Maize | LY038 | REN-00038-3 | T20 | cordapA |
| Maize | MIR162 | SYN-IR162-4 | T7 | vip3Aa20 |
| Maize | MIR604 | SYN-IR604-5 | T7 | mcry3A |
| Maize | MON801 (MON80100) | MON801 | T1, T7 | cry1Ab; cp4 epsps (aroA:CP4); |
| | | | | goxv247 |
| Maize | MON802 | MON-80200-7 | T1, T7 | cry1Ab; cp4 epsps (aroA:CP4); |
| | | | | goxv247 |
| Maize | MON809 | PH-MON-809-2 | T1, T7 | cry1Ab; cp4 epsps (aroA:CP4); |
| | | | | goxv247 |
| Maize | MON810 | MON-00810-6 | T1, T7 | cry1Ab; cp4 epsps (aroA:CP4); |
| | | | | goxv247 |
| Maize | MON832 | — | T1 | cp4 epsps (aroA:CP4); goxv247 |
| Maize | MON863 | MON-00863-5 | T7 | cry3Bb1 |
| Maize | MON87427 | MON-87427-7 | T1 | cp4 epsps (aroA:CP4) |
| Maize | MON87460 | MON-87460-4 | T21 | cs[B |
| Maize | MON88017 | MON-88017-3 | T1, T7 | cry3Bb1; cp4 epsps (amA:CP4) |
| Maize | MON89034 | MON-89034- | T7 | cry2Ab2; cry1A.105 |
| Maize | MS3 | ACS-ZM001-9 | T3, T18 | bar; barnase |
| Maize | MS6 | ACS-ZM005-4 | T3, T18 | bar; barnase |
| Maize | NK603 | MON-00603-6 | T1 | cp4 epsps (aroA:CP4) |
| Maize | T14 | ACS-ZM002-1 | T3 | pat (syn) |
| Maize | T25 | ACS-ZM003-2 | T3 | pat (syn) |
| Maize | TC1507 | DAS-01507-1 | T3, T7 | cry1Fa2; pat |
| Maize | TC6275 | DAS-06275-8 | T3, T7 | mocry1F; bar |
| Maize | VIP1034 | — | T3, T7 | vip3A; pat |
| Maize | 43A47 | DP-043A47-3 | T3, T7 | cry1F; cry34Ab1; cry35Ab1; pat |
| Maize | 40416 | DP-040416-8 | T3, T7 | cry1F; cry34Ab1; cry35Ab1; pat |
| Maize | 32316 | DP-032316-8 | T3, T7 | cry1F; cry34Ab1; cry35Ab1; pat |
| Maize | 4114 | DP-004114-3 | T3, T7 | cry1F; cry34Ab1; cry35Ab1; pat |
| Maize | Melon A | — | T22 | sam-k |
| Maize | Melon B | — | T22 | sam-k |
| Papaya | 55-1 | CUB-CP551-8 | T6 | prsv cp |
| Papaya | 63-1 | CUB-CP631-7 | T6 | prsv cp |
| Papaya | Huanong No. 1 | — | T6 | prsv cp |
| Papaya | X17-2 | UFL-X17CP-6 | T6 | prsv cp |
| Plum | C-5 | ARS-PLMC5-6 | T6 | prsv cp |
| Canola** | ZSR500 | — | T1 | cp4 epsps (aroA:CP4); goxv247 |
| Canola** | ZSR502 | — | T1 | cp4 epsps (aroA:CP4); goxv247 |
| Canola** | ZSR503 | — | T1 | cp4 epsps (aroA:CP4); goxv247 |
| Rice | 7Crp#22-95-7 | — | T13 | 7 [symbol] |
| Rice | 7Crp#10 | — | T13 | 7 [symbol] |
| Rice | GM Sl [symbol] | — | T7 | cry1Ab; cry1Ac |
| Rice | Huahui-1/TT51-1 | — | T7 | cry1Ab; cry1Ac |
| Rice | LLRICE06 | ACS-OS001-4 | T3 | bar |
| Rice | LLRICE0601 | BCS-OS003-7 | T3 | bar |
| Rice | LLRICE62 | ACS-OS002-5 | T3 | bar |
| Rice | Tarom molaii + cry1Ab | — | T7 | cry1Ab (truncated) |
| Rice | GAT-OS2 | — | T3 | bar |
| Rice | GAT-OS3 | — | T3 | bar |
| Rice | PE-7 | — | T7 | Cry1Ac |
| Rice | 7Crp#10 | — | T13 | 7 [symbol] |
| Rice | KPD624-8 | — | T27 | OASA1D |
| Rice | KPD722-4 | — | T27 | OASA1D |
| Rice | KA317 | — | T27 | OASA1D |
| Rice | HW5 | — | T27 | OASA1D |
| Rice | HW1 | — | T27 | OASA1D |
| Rice | B-4-1-18 | — | T28 | Δ OsBR11 |
| Rice | G-3-3-22 | — | T29 | OSGA2ox1 |
| Rice | AD77 | — | T6 | DEF |
| Rice | AD1 | — | T6 | DEF |
| Rice | AD48 | — | T6 | DEF |
| Rice | AD41 | — | T6 | DEF |
| Rice | 13pNasNa800725atAprt1 | — | T30 | HvNAS1; HvNAAT-A; APRT |
| Rice | 13pAprt1 | — | T30 | APRT |
| Rice | gHvNAS1-gHvNAAT-1 | — | T30 | HvNAS1; HvNAAT-A; HvNAAT-B |
| Rice | gHvIDS3-1 | — | T30 | HvID83 |
| Rice | gHvNAAT1 | — | T30 | HvNAAT-A; HvNAAT-B |
| Rice | gHvNAS1-1 | — | T30 | HvHAS1 |
| Rice | NIA-OS006-4 | — | T6 | WRKY4S |
| Rice | NIA-OS005-3 | — | T6 | WRKY4S |
| Rice | NIA-OS004-2 | — | T6 | WRKY4S |
| Rice | NIA-OS003-1 | — | T6 | WRKY4S |
| Rice | NIA-OS002-9 | — | T6 | WRKY4S |
| Rice | NIA-OS001-8 | — | T6 | WRKY4S |
| Rice | OsCr11 | — | T13 | Modified Cry j |
| Rice | 17053 | — | T1 | cp4 epsps (aroA:CP4) |
| Rice | 17314 | — | T1 | cp4 epsps (aroA:CP4) |
| Rice | WKS82/130-4-1 | IFD-52401-4 | T9 | SAT; bp40 ( [symbol] ) |
| Rice | WKS92/130-9-1 | IFD-52901-9 | T9 | SAT; bp40 ( [symbol] ) |
| Soybean | 260-65 (G94-1, G94-19, | — | T9 | gm- [symbol] 2-1 (silencing locus) |
| | G168) | | | |
| Soybean | A2704-12 | ACS-GM005-3 | T3 | pat |
| Soybean | A2704-21 | ACS-GM004-2 | T3 | pat |
| Soybean | A5547-124 | ACS-GM006-4 | T3 | pat |
| Soybean | A5547-35 | ACS-GM008-6 | T3 | pat |
| Soybean | CV127 | BPS-CV127-9 | T16 | csr1-2 |
| Soybean | DAS68416-4 | DAS68416-4 | T3 | pat |
| Soybean | DP305423 | DP-305423-1 | T11, T31 | gm-fad-1 (silencing locus); gm-hra |
| Soybean | Dp356043 | DP-356043-5 | T1, T31 | gm-fad2-1 (silencing locus); |
| | | | | gat4601 |
| Soybean | FG72 | MST-FG072-3 | T32, T1 | 2mepsps; hppdPF W336 |
| Soybean | GTS 40-3-2 (40-3-2) | MON-04032-6 | T1 | cp4 epsps (aroA:CP4) |
| Soybean | GU262 | ACS-GM003-1 | T3 | pat |
| Soybean | MON87701 | MON-87701-2 | T7 | cry1Ac |
| Soybean | MON87705 | MON-87705-6 | T1, T31 | fatb1-A (sense & antisense); fad2- |
| | | | | 1A (sense & antisense); cp4 epsps |
| | | | | (aroA:CP4) |
| Soybean | MON877708 | MON-87708-9 | T1, T12 | dmo; cp4 epsps (aroA:CP4) |
| Soybean | MON87769 | MON-87769-7 | T1, T31 | Pj.D6D; Nc.F [symbol] 3; ep4 epsps |
| | | | | (aroA:CP4) |
| Soybean | MON89788 | MON-89788-1 | T1 | cp4 epsps (aroA:CP4) |
| Soybean | W62 | ACS-GM002-9 | T33 | bar |
| Soybean | W98 | ACS-GM001-8 | T33 | bar |
| Soybean | MON87754 | MON-87754-1 | T33 | dgnt2A |
| Soybean | DAS21606 | DAS-21606 | T34, T3 | Modified aad-12; pat |
| Soybean | DAS44406 | DAS-44406-b | T1, T3, T34 | Modified aad-12; 2mepsps; pat |
| Soybean | SYHT04R | SYN-0004R-8 | T35 | Modified avhppd |
| Soybean | 9582.814.19.1 | — | T3, T7 | cry1Ac, cry1F, PAT |
| Squash | CZW3 | SEM-ØCZW3-2 | T6 | cmv cp, zymv cp, wmv cp |
| Squash | ZW20 | SEM-0ZW20-7 | T6 | zymv cp, wmv cp |
| Sugar Beet | GTSB77 (T9100152) | SY-GTSB77-8 | T1 | cp4 epsps (aroA:CP4); goxv247 |
| Sugar Beet | H7-1 | KM-000H71-4 | T1 | cp4 epsps (aroA:CP4) |
| Sugar Beet | T120-7 | ACS-BV001-3 | T3 | pat |
| Sugar Beet | T227-1 | — | T1 | cp4 epsps (aroA:CP4) |
| Sugarcane | NXI-1T | — | T21 | EcbetA |
| Sunflower | X81359 | — | T16 | als |
| Pepper | PK-SP01 | — | T6 | cmv cp |
| Tobacco | C/F/93/08-02 | — | T5 | bxa |
| Tobacco | Vector 21-41 | — | T36 | NtQPTI (antisense) |
| Sunflower | X81359 | — | T16 | als |
| Wheat | MON71800 | MON-718ØØ-3 | T1 | cp4 epsps (aroA:CP4) |

*Argentine (Brassica napus),
**Polish (B. rapa), #Eggplant [symbol]
indicates data missing or illegible when filed

When the herbicidal composition of the present invention is applied, an unexpected synergistic effect is achieved, and the herbicidal activity is greater than a single or the sum of the predicted activity of each herbicide. The synergistic effect is manifested by a reduced application rate, a broader weed control spectrum, and faster and more durable weeding action, all of which are required for weed control practives. In regarding to the described characteristics, the composition is significantly superior to the existing herbicides in the art. It is more environmentally friendly since the composition is used in less amount than that of the existing herbicides in the art.

The synergistic herbicidal composition of the present invention also has following advantages:

(1) The composition of the present invention is environmentally friendly, which is easily degraded in the environment.

(2) The herbicidal composition of the invention is of low cost and convenient in usage, and has great economic and social benefit for popularization and application thereof.

### SPECIFIC MODE FOR CARRYING OUT THE INVENTION

The following examples provided are not intend to limit the invention, but merely to illustrate how the invention is carried out. These examples show particularly significant effectiveness to certain weeds. Examples are as follows.

### A) Examples

1 Dispersible oil suspension of 10% penoxsulam⋅A1 (2+8)

2% penoxsulam+8% A1+5% calcium dodecylbenzen sulfonate+7% polyoxyethylene fatty alcohol ether+4% castor oil polyoxyethylene ether+5%200 # solvent oil+2.5% organobentonite+1.5% fumed silica+methyl oleate as balance.

2 Dispersible oil suspension of 12% penoxsulam⋅A2 (2+10)

2% penoxsulam+10% A2+5% calcium dodecylbenzen sulfonate+7% polyoxyethylene fatty alcohol ether+4% castor oil polyoxyethylene ether+5%200 # solvent oil+2.0% organobentonite+1.5% fumed silica+methyl oleate as balance.

3 Dispersible oil suspension of 14% penoxsulam⋅A4 (2+12)

2% penoxsulam+12% A4+5% calcium dodecylbenzen sulfonate+7% polyoxyethylene fatty alcohol ether+4% castor oil polyoxyethylene ether+5%200 # solvent oil+2.0% organobentonite+1.5% fumed silica+methyl oleate as balance.

4 Dispersible oil suspension of 10% bispyribac-sodium⋅A1 (2+8)

2% bispyribac-sodium+8% A1+6% calcium dodecylbenzen sulfonate+8% polyoxyethylene fatty alcohol ether+4% castor oil polyoxyethylene ether+5%200 # solvent oil+2.5% organobentonite+1.5% fumed silica+methyl oleate as balance.

5 Dispersible oil suspension of 12% bispyribac-sodium⋅A2 (2+10)

2% bispyribac-sodium+10% A2+6% calcium dodecylbenzen sulfonate+8% polyoxyethylene fatty alcohol ether+4% castor oil polyoxyethylene ether+5%200 # solvent oil+2.0% organobentonite+1.5% fumed silica+methyl oleate as balance.

6 Dispersible oil suspension of 14% bispyribac-sodium⋅A4 (2+12)

2% bispyribac-sodium+12% A4+6% calcium dodecylbenzen sulfonate+8% polyoxyethylene fatty alcohol ether+4% castor oil polyoxyethylene ether+5%200 # solvent oil+2.0% organobentonite+1.5% fumed silica+methyl oleate as balance.

7 Dispersible oil suspension of 10% pyrazosulfuron-ethyl⋅A1 (2+8)

2% pyrazosulfuron-ethyl+8% A1+1% urea+6% calcium dodecylbenzen sulfonate+8% polyoxyethylene fatty alcohol ether+4% castor oil polyoxyethylene ether+2.5% organobentonite+1.5% fumed silica+methyl oleate as balance.

8 Dispersible oil suspension of 12% pyrazosulfuron-ethyl⋅A2 (2+10)

2% pyrazosulfuron-ethyl+10% A2+1% urea+6% calcium dodecylbenzen sulfonate+8% polyoxyethylene fatty alcohol ether+4% castor oil polyoxyethylene ether+2.0% organobentonite+1.5% fumed silica+methyl oleate as balance.

9 Dispersible oil suspension of 14% pyrazosulfuron-ethyl⋅A3 (2+12)

2% pyrazosulfuron-ethyl+12% A3+1% urea+6% calcium dodecylbenzen sulfonate+8% polyoxyethylene fatty alcohol ether+4% castor oil polyoxyethylene ether+2.0% organobentonite+1.5% fumed silica+methyl oleate as balance.

10 Dispersible oil suspension of 12% nicosulfuron⋅A1 (4+8)

4% nicosulfuron+8% A1+1% urea+6% calcium dodecylbenzen sulfonate+8% polyoxyethylene fatty alcohol ether+4% castor oil polyoxyethylene ether+2.2% organobentonite+1.5% fumed silica+methyl oleate as balance.

11 Dispersible oil suspension of 14% nicosulfuron⋅A2 (4+10)

4% nicosulfuron+10% A2+1% urea+6% calcium dodecylbenzen sulfonate+8% polyoxyethylene fatty alcohol ether+4% castor oil polyoxyethylene ether+2.0% organobentonite+1.5% fumed silica+methyl oleate as balance.

12 Dispersible oil suspension of 16% nicosulfuron⋅A4 (4+12)

4% nicosulfuron+12% A4+1% urea+6% calcium dodecylbenzen sulfonate+8% polyoxyethylene fatty alcohol ether+4% castor oil polyoxyethylene ether+1.8% organobentonite+1.5% fumed silica+methyl oleate as balance.

13 Dispersible oil suspension of 8.3% florasulam⋅A1 (0.3+8)

0.3% florasulam+8% A1+1% urea+6% calcium dodecylbenzen sulfonate+8% dehydrated sorbitol fatty acid ester polyoxyethylene ether+4% castor oil polyoxyethylene ether+2.5% organobentonite+1.5% fumed silica+methyl oleate as balance.

14 Dispersible oil suspension of 10.3% florasulam⋅A2 (0.3+10)

0.3% florasulam+10% A2+1% urea+6% calcium dodecylbenzen sulfonate+8% dehydrated sorbitol fatty acid ester polyoxyethylene ether+4% castor oil polyoxyethylene ether+2.2% organobentonite+1.5% fumed silica+methyl oleate as balance.

15 Dispersible oil suspension of 12.3% florasulam⋅A3 (0.3+12)

0.3% florasulam+12% A3+1% urea+6% calcium dodecylbenzen sulfonate+8% dehydrated sorbitol fatty acid ester polyoxyethylene ether+4% castor oil polyoxyethylene ether+2.0% organobentonite+1.5% fumed silica+methyl oleate as balance.

16 Dispersible oil suspension of 10% rimsulfuron⋅A1 (2+8)

2% rimsulfuron+8% A1+1% urea+6% calcium dodecylbenzen sulfonate+8% polyoxyethylene fatty alcohol ether+4% castor oil polyoxyethylene ether+2.5% organobentonite+1.5% fumed silica+methyl oleate as balance.

17 Dispersible oil suspension of 12% rimsulfuron⋅A2 (2+10)

2% rimsulfuron+10% A2+1% urea+6% calcium dodecylbenzen sulfonate+8% polyoxyethylene fatty alcohol ether+4% castor oil polyoxyethylene ether+2.0% organobentonite+1.5% fumed silica+methyl oleate as balance.

18 Dispersible oil suspension of 14% rimsulfuron⋅A4 (2+12)

2% rimsulfuron+12% A4+1% urea+6% calcium dodecylbenzen sulfonate+8% polyoxyethylene fatty alcohol ether+4% castor oil polyoxyethylene ether+2.0% organobentonite+1.5% fumed silica+methyl oleate as balance.

19 Dispersible oil suspension of 14% imazethapyr⋅A1 (6+8)

6% imazethapyr+8% A1+6% calcium dodecylbenzen sulfonate+8% polyoxyethylene fatty alcohol ether+4% castor oil polyoxyethylene ether+2.0% organobentonite+1.5% fumed silica+methyl oleate as balance.

20 Dispersible oil suspension of 16% imazethapyr⋅A2 (6+10)

6% imazethapyr+10% A2+6% calcium dodecylbenzen sulfonate+8% polyoxyethylene fatty alcohol ether+4% castor oil polyoxyethylene ether+2.0% organobentonite+1.5% fumed silica+methyl oleate as balance.

21 Dispersible oil suspension of 18% imazethapyr⋅A4 (6+12)

6% imazethapyr+12% A4+6% calcium dodecylbenzen sulfonate+8% polyoxyethylene fatty alcohol ether+4% castor oil polyoxyethylene ether+1.8% organobentonite+1.5% fumed silica+methyl oleate as balance.

22 Dispersible oil suspension of 18% imazapic⋅A1 (10+8)

10% imazapic+8% A1+6% calcium dodecylbenzen sulfonate+8% polyoxyethylene fatty alcohol ether+4% castor oil polyoxyethylene ether+2.0% organobentonite+1.5% fumed silica+methyl oleate as balance.

23 Dispersible oil suspension of 20% imazapic⋅A2 (10+10)

10% imazapic+10% A2+6% calcium dodecylbenzen sulfonate+8% polyoxyethylene fatty alcohol ether+4% castor oil polyoxyethylene ether+2.0% organobentonite+1.5% fumed silica+methyl oleate as balance.

24 Dispersible oil suspension of 22% imazapic⋅A4 (10+12)

10% imazapic+12% A4+6% calcium dodecylbenzen sulfonate+8% polyoxyethylene fatty alcohol ether+4% castor oil polyoxyethylene ether+1.8% organobentonite+1.5% fumed silica+methyl oleate as balance.

25 Dispersible oil suspension of 12% imazamox⋅A1 (4+8)

4% imazamox+8% A1+6% calcium dodecylbenzen sulfonate+8% polyoxyethylene fatty alcohol ether+4% castor oil polyoxyethylene ether+2.2% organobentonite+1.5% fumed silica+methyl oleate as balance.

26 Dispersible oil suspension of 14% imazamox⋅A2 (4+10)

4% imazamox+10% A2+6% calcium dodecylbenzen sulfonate+8% polyoxyethylene fatty alcohol ether+4% castor oil polyoxyethylene ether+2.0% organobentonite+1.5% fumed silica+methyl oleate as balance.

27 Dispersible oil suspension of 16% imazamox⋅A4 (4+12)

4% imazamox+12% A4+6% calcium dodecylbenzen sulfonate+8% polyoxyethylene fatty alcohol ether+4% castor oil polyoxyethylene ether+1.8% organobentonite+1.5% fumed silica+methyl oleate as balance.

28 Dispersible oil suspension of 18% sulfometuron-methyl⋅A1 (10+8)

10% sulfometuron-methyl+8% A1+1% urea+6% calcium dodecylbenzen sulfonate+8% polyoxyethylene fatty alcohol ether+4% castor oil polyoxyethylene ether+2.0% organobentonite+1.5% fumed silica+methyl oleate as balance.

29 Dispersible oil suspension of 20% sulfometuron-methyl⋅A2 (10+10)

10% sulfometuron-methyl+10% A2+1% urea+6% calcium dodecylbenzen sulfonate+8% polyoxyethylene fatty alcohol ether+4% castor oil polyoxyethylene ether+1.8% organobentonite+1.5% fumed silica+methyl oleate as balance.

30 Dispersible oil suspension of 22% sulfometuron-methyl⋅A4 (10+12)

10% sulfometuron-methyl+12% A4+1% urea+6% calcium dodecylbenzen sulfonate+8% polyoxyethylene fatty alcohol ether+4% castor oil polyoxyethylene ether+1.6% organobentonite+1.5% fumed silica+methyl oleate as balance.

31 Dispersible oil suspension of 10% cloransulam-methyl⋅A1 (2+8)

2% cloransulam-methyl+8% A1+6% calcium dodecylbenzen sulfonate+8% dehydrated sorbitol fatty acid ester polyoxyethylene ether+4% castor oil polyoxyethylene ether+2.5% organobentonite+1.5% fumed silica+methyl oleate as balance.

32 Dispersible oil suspension of 12% cloransulam-methyl⋅A2 (2+10)

2% cloransulam-methyl+10% A2+6% calcium dodecylbenzen sulfonate+8% dehydrated sorbitol fatty acid ester polyoxyethylene ether+4% castor oil polyoxyethylene ether+2.2% organobentonite+1.5% fumed silica+methyl oleate as balance.

33 Dispersible oil suspension of 14% cloransulam-methyl⋅A3 (2+12)

2% cloransulam-methyl+12% A3+6% calcium dodecylbenzen sulfonate+8% dehydrated sorbitol fatty acid ester polyoxyethylene ether+4% castor oil polyoxyethylene ether+2.0% organobentonite+1.5% fumed silica+methyl oleate as balance.

34 Dispersible oil suspension of 18% cyhalofop-butyl⋅A1 (10+8)

10% cyhalofop-butyl+8% A1+6% calcium dodecylbenzen sulfonate+8% dehydrated sorbitol fatty acid ester polyoxyethylene ether+4% castor oil polyoxyethylene ether+2.0% organobentonite+1.5% fumed silica+15%150 # solvent oil+methyl oleate as balance.

35 Aqueous emulsion of 20% cyhalofop-butyl⋅A2 (10+10)

10% cyhalofop-butyl+10% A2+20%150 # solvent oil+3.5% phenylethyl phenol polyoxyethylene ether phosphate triethanolamine salt+5% castor oil polyoxyethylene ether+3% ethylene glycol+deionized water as balance.

36 Dispersible oil suspension of 22% cyhalofop-butyl⋅A4 (10+12)

10% cyhalofop-butyl+12% A4+6% calcium dodecylbenzen sulfonate+8% dehydrated sorbitol fatty acid ester polyoxyethylene ether+4% castor oil polyoxyethylene ether+2.0% organobentonite+1.5% fumed silica+15%150 # solvent oil+methyl oleate as balance.

37 Dispersible oil suspension of 11% clodinafop-propargyl⋅A1 (3+8)

3% clodinafop-propargyl+8% A1+6% calcium dodecylbenzen sulfonate+8% dehydrated sorbitol fatty acid ester polyoxyethylene ether+4% castor oil polyoxyethylene ether+2.5% organobentonite+2.0% fumed silica+15%150 # solvent oil+methyl oleate as balance.

38 Aqueous emulsion of 13% clodinafop-propargyl⋅A2 (3+10)

3% clodinafop-propargyl+10% A2+15%150 # solvent oil+5% cyclohexanone+3.5% phenylethyl phenol polyoxyethylene ether phosphate triethanolamine salt+5% castor oil polyoxyethylene ether+3% ethylene glycol+deionized water as balance.

39 Dispersible oil suspension of 15% clodinafop-propargyl⋅A3 (3+12)

3% clodinafop-propargyl+12% A3+6% calcium dodecylbenzen sulfonate+8% dehydrated sorbitol fatty acid ester polyoxyethylene ether+4% castor oil polyoxyethylene ether+2.0% organobentonite+1.5% fumed silica+15%150 # solvent oil+methyl oleate as balance.

40 Water suspension of 13% pinoxaden⋅A1 (5+8)

5% pinoxaden+8% A1+5% polycarboxylate+2% propylene glycol block polyether+2% polyoxyethylene fatty alcohol ether+0.2% xanthan gum+2.0% magnesium aluminum silicate+3% ethylene glycol+0.1% silicone as a defoaming agent+deionized water as balance.

41 Emulsifiable concentrate of 15% pinoxaden⋅A2 (5+10)

5% pinoxaden+10% A2+15% tetrahydrofurfuryl alcohol+1% triphenyl phosphate+5% calcium dodecylbenzen sulfonate+3.5% phenylethyl phenol polyoxyethylene ether+5% castor oil polyoxyethylene ether+150 # solvent oil as balance.

42 Dispersible oil suspension of 17% pinoxaden⋅A3 (5+12)

5% pinoxaden+12% A3+6% calcium dodecylbenzen sulfonate+8% dehydrated sorbitol fatty acid ester polyoxyethylene ether+4% castor oil polyoxyethylene ether+1.8% organobentonite+1.5% fumed silica+10%150 # solvent oil+methyl oleate as balance.

43 Dispersible oil suspension of 14% clethodim⋅A1 (6+8)

6% clethodim+8% A1+6% calcium dodecylbenzen sulfonate+8% dehydrated sorbitol fatty acid ester polyoxyethylene ether+4% castor oil polyoxyethylene ether+2.0% organobentonite+1.5% fumed silica+5%150 # solvent oil+methyl oleate as balance.

44 Emulsifiable concentrate of 16% clethodim⋅A2 (6+10)

6% clethodim+10% A2+4% calcium dodecylbenzen sulfonate+4% phenylethyl phenol polyoxyethylene ether+4% polyoxyethylene fatty alcohol ether+150 # solvent oil as balance.

45 Dispersible oil suspension of 18% clethodim⋅A4 (6+12)

6% clethodim+12% A4+6% calcium dodecylbenzen sulfonate+9% dehydrated sorbitol fatty acid ester polyoxyethylene ether+4% castor oil polyoxyethylene ether+1.8% organobentonite+1.5% fumed silica+5%150 # solvent oil+methyl oleate as balance.

46 Dispersible oil suspension of 23% sethoxydim⋅A1 (15+8)

15% sethoxydim+8% A1+6% calcium dodecylbenzen sulfonate+8% cardanol polyoxyethylene ether+4% castor oil polyoxyethylene ether+2.2% organobentonite+1.5% fumed silica+5%150 # solvent oil+methyl oleate as balance.

47 Emulsifiable concentrate of 25% sethoxydim⋅A2 (15+10)

15% sethoxydim+10% A2+4% calcium dodecylbenzen sulfonate+6% phenylethyl phenol polyoxyethylene ether+3% polyoxyethylene fatty alcohol ether+150 # solvent oil as balance.

48 Dispersible oil suspension of 27% sethoxydim⋅A4 (15+12)

15% sethoxydim+12% A4+6% calcium dodecylbenzen sulfonate+9% cardanol polyoxyethylene ether+4% castor oil polyoxyethylene ether+1.8% organobentonite+1.5% fumed silica+5%150 # solvent oil+methyl oleate as balance.

49 Dispersible oil suspension of 12% quizalofop-P-methyl⋅A1 (4+8)

4% quizalofop-P-methyl+8% A1+6% calcium dodecylbenzen sulfonate+8% cardanol polyoxyethylene ether+4% castor oil polyoxyethylene ether+2.4% organobentonite+1.5% fumed silica+20%150 # solvent oil+methyl oleate as balance.

50 Aqueous emulsion of 14% quizalofop-P-methyl⋅A2 (4+10)

4% quizalofop-P-methyl+10% A2+6% cyclohexanone+20%150 # solvent oil+3.5% phenylethyl phenol polyoxyethylene ether phosphate triethanolamine salt+4.5% castor oil polyoxyethylene ether+3% ethylene glycol+deionized water as balance.

51 Dispersible oil suspension of 16% quizalofop-P-methyl⋅A4 (4+12)

4% quizalofop-P-methyl+12% A4+6% calcium dodecylbenzen sulfonate+8% cardanol polyoxyethylene ether+4% castor oil polyoxyethylene ether+2.0% organobentonite+1.5% fumed silica+20%150 # solvent oil+methyl oleate as balance.

52 Dispersible oil suspension of 12% fluazifop-P-butyl⋅A1 (4+8)

4% fluazifop-P-butyl+8% A1+6% calcium dodecylbenzen sulfonate+8% cardanol polyoxyethylene ether+4% castor oil polyoxyethylene ether+2.4% organobentonite+1.5% fumed silica+5%150 # solvent oil+methyl oleate as balance.

53 Aqueous emulsion of 14% fluazifop-P-butyl⋅A2 (4+10)

4% fluazifop-P-butyl+10% A2+20%150 # solvent oil+3.5% phenylethyl phenol polyoxyethylene ether phosphate triethanolamine salt+4.5% castor oil polyoxyethylene ether+3% ethylene glycol+deionized water as balance.

54 Dispersible oil suspension of 16% fluazifop-P-butyl⋅A4 (4+12)

4% fluazifop-P-butyl+12% A4+6% calcium dodecylbenzen sulfonate+8% cardanol polyoxyethylene ether+4% castor oil polyoxyethylene ether+2.0% organobentonite+1.5% fumed silica+5%150 # solvent oil+methyl oleate as balance.

55 Dispersible oil suspension of 12% haloxyfop-P-methyl⋅A1 (4+8)

4% haloxyfop-P-methyl+8% A1+6% calcium dodecylbenzen sulfonate+8% cardanol polyoxyethylene ether+4% castor oil polyoxyethylene ether+2.4% organobentonite+1.5% fumed silica+5%150 # solvent oil+methyl oleate as balance.

56 Aqueous emulsion of 14% haloxyfop-P-methyl⋅A2 (4+10)

4% haloxyfop-P-methyl+10% A2+20%150 # solvent oil+3.5% phenylethyl phenol polyoxyethylene ether phosphate triethanolamine salt+4.5% castor oil polyoxyethylene ether+3% ethylene glycol+deionized water as balance.

57 Dispersible oil suspension of 16% haloxyfop-P-methyl⋅A4 (4+12)

4% haloxyfop-P-methyl+12% A4+6% calcium dodecylbenzen sulfonate+8% cardanol polyoxyethylene ether+4% castor oil polyoxyethylene ether+2.0% organobentonite+1.5% fumed silica+5%150 # solvent oil+methyl oleate as balance.

58 Dispersible oil suspension of 29% atrazine⋅A1 (25+4)

25% atrazine+4% A1+4% calcium dodecylbenzen sulfonate+8% dehydrated sorbitol fatty acid ester polyoxyethylene ether+4% castor oil polyoxyethylene ether+1.0% organobentonite+5%150 # solvent oil+methyl oleate as balance.

59 Dispersible oil suspension of 30% atrazine⋅A2 (25+5)

25% atrazine+5% A2+6% calcium dodecylbenzen sulfonate+8% dehydrated sorbitol fatty acid ester polyoxyethylene ether+4% castor oil polyoxyethylene ether+1.0% organobentonite+0.5% fumed silica+5%150 # solvent oil+methyl oleate as balance.

60 Dispersible oil suspension of 31% atrazine⋅A4 (25+6)

25% atrazine+6% A4+6% calcium dodecylbenzen sulfonate+8% dehydrated sorbitol fatty acid ester polyoxyethylene ether+4% castor oil polyoxyethylene ether+0.8% organobentonite+5%150 # solvent oil+methyl oleate as balance.

61 Dispersible oil suspension of 29% isoproturon⋅A1 (25+4)

25% isoproturon+4% A1+4% calcium dodecylbenzen sulfonate+8% dehydrated sorbitol fatty acid ester polyoxyethylene ether+4% castor oil polyoxyethylene ether+1.0% organobentonite+5%150 # solvent oil+methyl oleate as balance.

62 Dispersible oil suspension of 30% isoproturon⋅A2 (25+5)

25% isoproturon+5% A2+6% calcium dodecylbenzen sulfonate+8% dehydrated sorbitol fatty acid ester polyoxyethylene ether+4% castor oil polyoxyethylene ether+1.0% organobentonite+0.5% fumed silica+5%150 # solvent oil+methyl oleate as balance.

63 Dispersible oil suspension of 31% isoproturon⋅A3 (25+6)

25% isoproturon+6% A3+6% calcium dodecylbenzen sulfonate+8% dehydrated sorbitol fatty acid ester polyoxyethylene ether+4% castor oil polyoxyethylene ether+0.8% organobentonite+5%150 # solvent oil+methyl oleate as balance.

64 Dispersible oil suspension of 29% chlorotoluron⋅A1 (25+4)

25% chlorotoluron+4% A1+4% calcium dodecylbenzen sulfonate+8% dehydrated sorbitol fatty acid ester polyoxyethylene ether+4% castor oil polyoxyethylene ether+1.0% organobentonite+5%150 # solvent oil+methyl oleate as balance.

65 Dispersible oil suspension of 30% chlorotoluron⋅A2 (25+5)

25% chlorotoluron+5% A2+6% calcium dodecylbenzen sulfonate+8% dehydrated sorbitol fatty acid ester polyoxyethylene ether+4% castor oil polyoxyethylene ether+1.0% organobentonite+0.5% fumed silica+5%150 # solvent oil+methyl oleate as balance.

66 Dispersible oil suspension of 31% chlorotoluron⋅A3 (25+6)

25% chlorotoluron+6% A3+6% calcium dodecylbenzen sulfonate+8% dehydrated sorbitol fatty acid ester polyoxyethylene ether+4% castor oil polyoxyethylene ether+0.8% organobentonite+5%150 # solvent oil+methyl oleate as balance.

67 Dispersible oil suspension of 34% diuron⋅A1 (30+4)

30% diuron+4% A1+4% calcium dodecylbenzen sulfonate+8% dehydrated sorbitol fatty acid ester polyoxyethylene ether+4% castor oil polyoxyethylene ether+0.6% organobentonite+5%150 # solvent oil+methyl oleate as balance.

68 Dispersible oil suspension of 35% diuron⋅A2 (30+5)

30% diuron+5% A2+6% calcium dodecylbenzen sulfonate+8% dehydrated sorbitol fatty acid ester polyoxyethylene ether+4% castor oil polyoxyethylene ether+0.8% organobentonite+8%150 # solvent oil+methyl oleate as balance.

69 Dispersible oil suspension of 36% diuron⋅A4 (30+6)

30% diuron+6% A4+5% calcium dodecylbenzen sulfonate+7% dehydrated sorbitol fatty acid ester polyoxyethylene ether+4% castor oil polyoxyethylene ether+0.4% organobentonite+8%150 # solvent oil+methyl oleate as balance.

70 Aqueous solution of 48% bentazone⋅A1 (40+8)

40% bentazone+8% A1+5% NaOH+5% polyoxyethylene fatty alcohol ether+15% C8-10 alkyl glucoside+deionized water as balance.

71 Dispersible oil suspension of 25% bentazone⋅A2 (20+5)

20% bentazone+5% A2+6% calcium dodecylbenzen sulfonate+8% dehydrated sorbitol fatty acid ester polyoxyethylene ether+4% castor oil polyoxyethylene ether+0.8% organobentonite+0.8% fumed silica+8%150 # solvent oil+methyl oleate as balance.

72 Aqueous solution of 52% bentazone⋅A3 (40+12)

40% bentazone+12% A3+5.5% NaOH+5% polyoxyethylene fatty alcohol ether+15% C8-10 alkyl glucoside+deionized water as balance.

73 Aqueous solution of 20% bromoxynil⋅A1 (12+8)

12% bromoxynil+8% A1+4% NaOH+5% polyoxyethylene fatty alcohol ether+15% C8-10 alkyl glucoside+deionized water as balance.

74 Emulsifiable concentrate of 22% bromoxynil⋅A2 (12+10)

12% bromoxynil+10% A2+10%1-octylpyrrolidin-2-one+3% calcium dodecylbenzen sulfonate+5% polyoxyethylene fatty alcohol ether+4% castor oil polyoxyethylene ether+150 # solvent oil as balance.

75 Aqueous solution of 24% bromoxynil⋅A3 (12+12)

12% bromoxynil+12% A3+5% NaOH+5% polyoxyethylene fatty alcohol ether+15% C8-10 alkyl glucoside+deionized water as balance.

76 Dispersible oil suspension of 27% propanil⋅A1 (25+2)

25% propanil+2% A1+4% calcium dodecylbenzen sulfonate+8% cardanol polyoxyethylene ether+4% castor oil polyoxyethylene ether+0.6% organobentonite+methyl oleate as balance.

77 Emulsifiable concentrate of 27.5% propanil⋅A2 (25+2.5)

25% propanil+2.5% A2+10%1-octylpyrrolidin-2-one+10% N,N-dimethylcapramide+2% calcium dodecylbenzen sulfonate+10% polyoxyethylene fatty alcohol ether+4% castor oil polyoxyethylene ether+150 # solvent oil as balance.

78 Dispersible oil suspension of 28% propanil⋅A4 (25+3)

25% propanil+3% A4+5% calcium dodecylbenzen sulfonate+7% cardanol polyoxyethylene ether+4% castor oil polyoxyethylene ether+0.4% organobentonite+methyl oleate as balance.

79 Dispersible oil suspension of 17% cypyrafluone⋅A1 (9+8)

9% cypyrafluone+8% A1+4% calcium dodecylbenzen sulfonate+8% cardanol polyoxyethylene ether+4% castor oil polyoxyethylene ether+1.5% organobentonite+1.5% fumed silica+10%150 # solvent oil+methyl oleate as balance.

80 Dispersible oil suspension of 19% cypyrafluone⋅A2 (9+10)

9% cypyrafluone+10% A2+4% calcium dodecylbenzen sulfonate+8% cardanol polyoxyethylene ether+4% castor oil polyoxyethylene ether+2.0% organobentonite+2.0% fumed silica+10%150 # solvent oil+methyl oleate as balance.

81 Dispersible oil suspension of 21% cypyrafluone⋅A3 (9+12)

9% cypyrafluone+12% A3+4% calcium dodecylbenzen sulfonate+8% cardanol polyoxyethylene ether+4% castor oil polyoxyethylene ether+1.2% organobentonite+1.2% fumed silica+10%150 # solvent oil+methyl oleate as balance.

82 Dispersible oil suspension of 10% bipyrazone⋅A1 (2+8)

2% bipyrazone+8% A1+0.4% citricacid+4% calcium dodecylbenzen sulfonate+8% cardanol polyoxyethylene ether+4% castor oil polyoxyethylene ether+1.5% organobentonite+1.5% fumed silica+8%150 # solvent oil+methyl oleate as balance.

83 Dispersible oil suspension of 12% bipyrazone⋅A2 (2+10)

2% bipyrazone+10% A2+0.4% citric acid+4% calcium dodecylbenzen sulfonate+8% cardanol polyoxyethylene ether+4% castor oil polyoxyethylene ether+1.5% organobentonite+1.5% fumed silica+8%150 # solvent oil+methyl oleate as balance.

84 Dispersible oil suspension of 14% bipyrazone⋅A3 (2+12)

2% bipyrazone+12% A3+0.4% citric acid+4% calcium dodecylbenzen sulfonate+8% cardanol polyoxyethylene ether+4% castor oil polyoxyethylene ether+1.2% organobentonite+1.2% fumed silica+8%150 # solvent oil+methyl oleate as balance.

85 Dispersible oil suspension of 17% fenpyrazone⋅A1 (9+8)

9% fenpyrazone+8% A1+4% calcium dodecylbenzen sulfonate+8% cardanol polyoxyethylene ether+4% castor oil polyoxyethylene ether+1.5% organobentonite+1.5% fumed silica+5%150 # solvent oil+methyl oleate as balance.

86 Dispersible oil suspension of 19% fenpyrazone⋅A2 (9+10)

9% fenpyrazone+10% A2+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

87 Dispersible oil suspension of 21% fenpyrazone⋅A3 (9+12)

9% fenpyrazone+12% A3+4% calcium dodecylbenzen sulfonate+8% cardanol polyoxyethylene ether+4% castor oil polyoxyethylene ether+1.2% organobentonite+1.2% fumed silica+5%150 # solvent oil+methyl oleate as balance.

88 Dispersible oil suspension of 20% tripyrasulfone⋅A1 (12+8)

12% tripyrasulfone+8% A1+4% calcium dodecylbenzen sulfonate+8% cardanol polyoxyethylene ether+4% castor oil polyoxyethylene ether+1.5% organobentonite+1.5% fumed silica+5%150 # solvent oil+methyl oleate as balance.

89 Dispersible oil suspension of 22% tripyrasulfone⋅A2 (12+10)

12% tripyrasulfone+10% A2+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

90 Dispersible oil suspension of 24% tripyrasulfone⋅A4 (12+12)

12% tripyrasulfone+12% A4+4% calcium dodecylbenzen sulfonate+8% cardanol polyoxyethylene ether+4% castor oil polyoxyethylene ether+1.2% organobentonite+1.2% fumed silica+5%150 # solvent oil+methyl oleate as balance.

91 Dispersible oil suspension of 14% tefuryltrione⋅A1 (6+8)

6% tefuryltrione+8% A1+4% calcium dodecylbenzen sulfonate+8% cardanol polyoxyethylene ether+4% castor oil polyoxyethylene ether+1.8% organobentonite+1.8% fumed silica+5%150 # solvent oil+methyl oleate as balance.

92 Dispersible oil suspension of 16% tefuryltrione⋅A2 (6+10)

6% tefuryltrione+10% A2+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

93 Dispersible oil suspension of 18% tefuryltrione⋅A4 (6+12)

6% tefuryltrione+12% A4+4% calcium dodecylbenzen sulfonate+8% cardanol polyoxyethylene ether+4% castor oil polyoxyethylene ether+1.2% organobentonite+1.0% fumed silica+5%150 # solvent oil+methyl oleate as balance.

94 Dispersible oil suspension of 18% mesotrione⋅A1 (10+8)

10% mesotrione+8% A1+0.5% citric acid+4% calcium dodecylbenzen sulfonate+8% cardanol polyoxyethylene ether+4% castor oil polyoxyethylene ether+1.8% organobentonite+1.8% fumed silica+5%150 # solvent oil+methyl oleate as balance.

95 Dispersible oil suspension of 20% mesotrione⋅A2 (10+10)

10% mesotrione+10% A2+0.5% citric acid+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

96 Dispersible oil suspension of 22% mesotrione⋅A3 (10+12)

10% mesotrione+12% A3+0.5% citric acid+4% calcium dodecylbenzen sulfonate+8% cardanol polyoxyethylene ether+4% castor oil polyoxyethylene ether+1.2% organobentonite+1.0% fumed silica+5%150 # solvent oil+methyl oleate as balance.

97 Dispersible oil suspension of 14% tembotrione⋅A1 (6+8)

6% tembotrione+8% A1+1% citric acid+4% calcium dodecylbenzen sulfonate+8% cardanol polyoxyethylene ether+4% castor oil polyoxyethylene ether+1.8% organobentonite+1.8% fumed silica+5%150 # solvent oil+methyl oleate as balance.

98 Dispersible oil suspension of 16% tembotrione⋅A2 (6+10)

6% tembotrione+10% A2+1% citric acid+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

99 Dispersible oil suspension of 18% tembotrione⋅A3 (6+12)

6% tembotrione+12% A3+1% citric acid+4% calcium dodecylbenzen sulfonate+8% cardanol polyoxyethylene ether+4% castor oil polyoxyethylene ether+1.2% organobentonite+1.0% fumed silica+5%150 # solvent oil+methyl oleate as balance.

100 Dispersible oil suspension of 11% topramezone⋅A1 (3+8)

3% topramezone+8% A1+0.2% citric acid+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

101 Dispersible oil suspension of 13% topramezone⋅A2 (3+10)

3% topramezone+10% A2+0.2% citric acid+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

102 Dispersible oil suspension of 15% topramezone⋅A3 (3+12)

3% topramezone+12% A3+0.2% citric acid+4% calcium dodecylbenzen sulfonate+8% cardanol polyoxyethylene ether+4% castor oil polyoxyethylene ether+1.5% organobentonite+1.5% fumed silica+5%150 # solvent oil+methyl oleate as balance.

103 Dispersible oil suspension of 14% isoxaflutole⋅A1 (6+8)

6% isoxaflutole+8% A1+0.5% citric acid+4% calcium dodecylbenzen sulfonate+8% cardanol polyoxyethylene ether+4% castor oil polyoxyethylene ether+1.8% organobentonite+1.8% fumed silica+5%150 # solvent oil+methyl oleate as balance.

104 Dispersible oil suspension of 16% isoxaflutole⋅A2 (6+10)

6% isoxaflutole+10% A2+0.5% citric acid+4% calcium dodecylbenzen sulfonate+8% cardanol polyoxyethylene ether+4% castor oil polyoxyethylene ether+2.0% organobentonite+2.0% fumed silica+5%150 # solvent oil+methyl oleate as balance.

105 Dispersible oil suspension of 18% isoxaflutole⋅A4 (6+12)

6% isoxaflutole+12% A4+0.5% citric acid+4% calcium dodecylbenzen sulfonate+8% cardanol polyoxyethylene ether+4% castor oil polyoxyethylene ether+1.2% organobentonite+1.0% fumed silica+5%150 # solvent oil+methyl oleate as balance.

106 Dispersible oil suspension of 28% benzobicylon⋅A1 (20+8)

20% benzobicylon+8% A1+4% calcium dodecylbenzen sulfonate+8% cardanol polyoxyethylene ether+4% castor oil polyoxyethylene ether+1.0% organobentonite+5%150 # solvent oil+methyl oleate as balance.

107 Dispersible oil suspension of 30% benzobicylon⋅A2 (20+10)

20% benzobicylon+10% A2+4% calcium dodecylbenzen sulfonate+8% cardanol polyoxyethylene ether+4% castor oil polyoxyethylene ether+1.2% organobentonite+1.2% fumed silica+5%150 # solvent oil+methyl oleate as balance.

108 Dispersible oil suspension of 32% benzobicylon⋅A4 (20+12)

20% benzobicylon+12% A4+4% calcium dodecylbenzen sulfonate+8% cardanol polyoxyethylene ether+4% castor oil polyoxyethylene ether+0.5% organobentonite+5%150 # solvent oil+methyl oleate as balance.

109 Dispersible oil suspension of 18% diflufenican⋅A1 (10+8)

10% diflufenican+8% A1+4% calcium dodecylbenzen sulfonate+8% cardanol polyoxyethylene ether+4% castor oil polyoxyethylene ether+1.2% organobentonite+1.2% fumed silica+5%150 # solvent oil+methyl oleate as balance.

110 Dispersible oil suspension of 20% diflufenican⋅A2 (10+10)

10% diflufenican+10% A2+4% calcium dodecylbenzen sulfonate+8% cardanol polyoxyethylene ether+4% castor oil polyoxyethylene ether+1.5% organobentonite+1.5% fumed silica+5%150 # solvent oil+methyl oleate as balance.

111 Dispersible oil suspension of 22% diflufenican⋅A3 (10+12)

10% diflufenican+12% A3+4% calcium dodecylbenzen sulfonate+8% cardanol polyoxyethylene ether+4% castor oil polyoxyethylene ether+0.8% organobentonite+5%150 # solvent oil+methyl oleate as balance.

112 Dispersible oil suspension of 29% flurochloridone⋅A1 (25+4)

25% flurochloridone+4% A1+4% calcium dodecylbenzen sulfonate+8% cardanol polyoxyethylene ether+4% castor oil polyoxyethylene ether+2.0% organobentonite+2.0% fumed silica+15%150 # solvent oil+methyl oleate as balance.

113 Dispersible oil suspension of 60% flurochloridone⋅A2 (50+10)

50% flurochloridone+10% A2+6% calcium dodecylbenzen sulfonate+8% castor oil polyoxyethylene ether+10% cyclopentanone+150 # solvent oil as balance.

114 Dispersible oil suspension of 31% flurochloridone⋅A3 (25+6)

25% flurochloridone+6% A3+4% calcium dodecylbenzen sulfonate+8% cardanol polyoxyethylene ether+4% castor oil polyoxyethylene ether+1.8% organobentonite+1.8% fumed silica+15%150 # solvent oil+methyl oleate as balance.

115 Dispersible oil suspension of 38% clomazone⋅A1 (30+8)

30% clomazone+8% A1+5% calcium dodecylbenzen sulfonate+6% cardanol polyoxyethylene ether+4% castor oil polyoxyethylene ether+2.5% organobentonite+2.5% fumed silica+5%150 # solvent oil+methyl oleate as balance.

116 Emulsifiable concentrate of 40% clomazone⋅A2 (30+10)

30% clomazone+10% A2+6% calcium dodecylbenzen sulfonate+10% castor oil polyoxyethylene ether+10% ethanol+150 # solvent oil as balance.

117 Dispersible oil suspension of 42% clomazone⋅A4 (30+12)

30% clomazone+12% A4+4% calcium dodecylbenzen sulfonate+8% cardanol polyoxyethylene ether+4% castor oil polyoxyethylene ether+2.2% organobentonite+1.8% fumed silica+15%150 # solvent oil+methyl oleate as balance.

118 Suspoemulsion of 10% carfentrazone-ethyl⋅A1 (2+8)

2% carfentrazone-ethyl+8% A1+3% phenylethyl phenol polyoxyethylene ether phosphate triethanolamine salt+4% isooctyl alcohol block polyether+3% castor oil polyoxyethylene ether+10%150 # solvent oil+0.25% xanthan gum+2.0% magnesium aluminum silicate+2% ethylene glycol+deionized water as balance.

119 Aqueous emulsion of 12% carfentrazone-ethyl⋅A2 (2+10)

2% carfentrazone-ethyl+10% A2+3% phenylethyl phenol polyoxyethylene ether phosphate triethanolamine salt+5% castor oil polyoxyethylene ether+10%150 # solvent oil+3% ethylene glycol+deionized water as balance.

120 Aqueous emulsion of 14% carfentrazone-ethyl⋅A3 (2+12)

2% carfentrazone-ethyl+12% A3+3% phenylethyl phenol polyoxyethylene ether phosphate triethanolamine salt+5% castor oil polyoxyethylene ether+10%150 # solvent oil+0.25% xanthan gum+2% ethylene glycol+deionized water as balance.

121 Aqueous solution of 33% fomesafen⋅A1 (25+8)

25% fomesafen+8% A1+4% NaOH+5% polyoxyethylene fatty alcohol ether+15% C8-10 alkyl glucoside+deionized water as balance.

122 Microemulsion of 35% fomesafen⋅A2 (25+10)

25% fomesafen+10% A2+10% cyclohexanone+10% ethanol+6% sodium di-sec-octyl maleate sulfonate+10% C8-10 alkyl glucoside+deionized water as balance.

123 Aqueous solution of 37% fomesafen⋅A3 (25+12)

25% fomesafen+12% A3+4.5% NaOH+5% polyoxyethylene fatty alcohol ether+15% C8-10 alkyl glucoside+deionized water as balance.

124 Dispersible oil suspension of 9% fluoroglycofen⋅A1 (1+8)

1% fluoroglycofen+8% A1+4% calcium dodecylbenzen sulfonate+8% cardanol polyoxyethylene ether+4% castor oil polyoxyethylene ether+2.0% organobentonite+2.0% fumed silica+10%150 # solvent oil+methyl oleate as balance.

125 Aqueous emulsion of 11% fluoroglycofen⋅A2 (1+10)

1% fluoroglycofen+10% A2+3% phenylethyl phenol polyoxyethylene ether phosphate triethanolamine salt+4% castor oil polyoxyethylene ether+10%150 # solvent oil+0.1% xanthan gum+2% ethylene glycol+deionized water as balance.

126 Dispersible oil suspension of 13% fluoroglycofen⋅A3 (1+12)

1% fluoroglycofen+12% A3+4% calcium dodecylbenzen sulfonate+8% cardanol polyoxyethylene ether+4% castor oil polyoxyethylene ether+2.0% organobentonite+1.5% fumed silica+10%150 # solvent oil+methyl oleate as balance.

127 Dispersible oil suspension of 20% oxyfluorfen⋅A1 (12+8)

12% oxyfluorfen+8% A1+4% calcium dodecylbenzen sulfonate+8% cardanol polyoxyethylene ether+4% castor oil polyoxyethylene ether+5% oil-soluble polycarboxylate+1.4% organobentonite+10% soya-bean oil+methyl oleate as balance.

128 Emulsifiable concentrate of 22% oxyfluorfen⋅A2 (12+10)

12% oxyfluorfen+10% A2+10% cyclopentanone+3% calcium dodecylbenzen sulfonate+4% polyoxyethylene fatty alcohol ether+4% castor oil polyoxyethylene ether+150 # solvent oil as balance.

129 Dispersible oil suspension of 24% oxyfluorfen⋅A3 (12+12)

12% oxyfluorfen+12% A3+4% calcium dodecylbenzen sulfonate+8% cardanol polyoxyethylene ether+4% castor oil polyoxyethylene ether+5% oil-soluble polycarboxylate+1.4% organobentonite+10% soya-bean oil+methyl oleate as balance.

130 Dispersible oil suspension of 16% lactofen⋅A1 (8+8)

8% lactofen+8% A1+4% calcium dodecylbenzen sulfonate+8% cardanol polyoxyethylene ether+4% castor oil polyoxyethylene ether+1.8% organobentonite+1.8% fumed silica+5%150 # solvent oil+methyl oleate as balance.

131 Emulsifiable concentrate of 18% lactofen⋅A2 (8+10)

8% lactofen+10% A2+3% calcium dodecylbenzen sulfonate+6% polyoxyethylene fatty alcohol ether+4% castor oil polyoxyethylene ether+150 # solvent oil as balance.

132 Dispersible oil suspension of 20% lactofen⋅A3 (8+12)

8% lactofen+12% A3+4% calcium dodecylbenzen sulfonate+8% cardanol polyoxyethylene ether+4% castor oil polyoxyethylene ether+1.6% organobentonite+1.6% fumed silica+10%150 # solvent oil+methyl oleate as balance.

133 Aqueous solution of 38% acifluorfen-sodium⋅A1 (30+8)

30% acifluorfen-sodium+8% A1+4.5% NaOH+5% polyoxyethylene fatty alcohol ether+15% C8-10 alkyl glucoside+deionized water as balance.

134 Dispersible oil suspension of 20% acifluorfen-sodium⋅A2 (15+5)

15% acifluorfen-sodium+5% A2+4% calcium dodecylbenzen sulfonate+8% cardanol polyoxyethylene ether+4% castor oil polyoxyethylene ether+1.6% organobentonite+1.6% fumed silica+10%150 # solvent oil+methyl oleate as balance.

135 Aqueous solution of 42% acifluorfen-sodium⋅A3 (30+12)

30% acifluorfen-sodium+12% A3+5% NaOH+5% polyoxyethylene fatty alcohol ether+15% C8-10 alkyl glucoside+deionized water as balance.

136 Dispersible oil suspension of 14% flumioxazin⋅A1 (6+8)

6% flumioxazin+8% A1+4% calcium dodecylbenzen sulfonate+8% cardanol polyoxyethylene ether+4% castor oil polyoxyethylene ether+1.6% organobentonite+10% soya-bean oil+methyl oleate as balance.

137 Emulsifiable concentrate of 16% flumioxazin⋅A2 (6+10)

6% flumioxazin+10% A2+15% cyclopentanone+3% calcium dodecylbenzen sulfonate+4% polyoxyethylene fatty alcohol ether+4% castor oil polyoxyethylene ether+150 # solvent oil as balance.

138 Dispersible oil suspension of 18% flumioxazin⋅A3 (6+12)

6% flumioxazin+12% A3+4% calcium dodecylbenzen sulfonate+8% cardanol polyoxyethylene ether+4% castor oil polyoxyethylene ether+1.4% organobentonite+10% soya-bean oil+methyl oleate as balance.

139 Dispersible oil suspension of 32% sulfentrazone⋅A1 (24+8)

24% sulfentrazone+8% A1+4% calcium dodecylbenzen sulfonate+8% cardanol polyoxyethylene ether+4% castor oil polyoxyethylene ether+1.3% organobentonite+10%150 # solvent oil+methyl oleate as balance.

140 Suspoemulsion of 34% sulfentrazone⋅A2 (24+10)

24% sulfentrazone+10% A2+8%150 # solvent oil+4% phenylethyl phenol polyoxyethylene ether phosphate triethanolamine salt+4% propylene glycol block polyether+4% castor oil polyoxyethylene ether+0.15% xanthan gum+2% ethylene glycol+deionized water as balance.

141 Water suspension of 36% sulfentrazone⋅A4 (24+12)

24% sulfentrazone+12% A4+4% phenylethyl phenol polyoxyethylene ether phosphate triethanolamine salt+3% naphthalene sulfonate as a dispersant+2% polyoxyethylene fatty alcohol ether+0.15% xanthan gum+1% magnesium aluminum silicate+3% ethylene glycol+deionized water as balance.

142 Dispersible oil suspension of 32% saflufenacil⋅A1 (24+8)

24% saflufenacil+8% A1+4% calcium dodecylbenzen sulfonate+8% cardanol polyoxyethylene ether+4% castor oil polyoxyethylene ether+1.2% organobentonite+1.0% fumed silica+10%150 # solvent oil+methyl oleate as balance.

143 Suspoemulsion of 34% saflufenacil⋅A2 (24+10)

24% saflufenacil+10% A2+8%150 # solvent oil+4% phenylethyl phenol polyoxyethylene ether phosphate triethanolamine salt+4% propylene glycol block polyether+4% castor oil polyoxyethylene ether+0.12% xanthan gum+2% ethylene glycol+deionized water as balance.

144 Water suspension of 36% saflufenacil⋅A3 (24+12)

24% saflufenacil+12% A3+4% phenylethyl phenol polyoxyethylene ether phosphate triethanolamine salt+3% naphthalene sulfonate as a dispersant+2% polyoxyethylene fatty alcohol ether+0.15% xanthan gum+1.2% magnesium aluminum silicate+3% ethylene glycol+deionized water as balance.

145 Dispersible oil suspension of 24% oxadiazon⋅A1 (20+4)

20% oxadiazon+4% A1+4% calcium dodecylbenzen sulfonate+8% cardanol polyoxyethylene ether+4% castor oil polyoxyethylene ether+1.2% organobentonite+1.0% fumed silica+10%150 # solvent oil+methyl oleate as balance.

146 Dispersible oil suspension of 25% oxadiazon⋅A2 (20+5)

20% oxadiazon+5% A2+4% calcium dodecylbenzen sulfonate+8% cardanol polyoxyethylene ether+4% castor oil polyoxyethylene ether+1.0% organobentonite+10%150 # solvent oil+methyl oleate as balance.

147 Dispersible oil suspension of 26% oxadiazon⋅A4 (20+6)

20% oxadiazon+6% A4+4% calcium dodecylbenzen sulfonate+8% cardanol polyoxyethylene ether+4% castor oil polyoxyethylene ether+1.2% organobentonite+10%150 # solvent oil+methyl oleate as balance.

148 Dispersible oil suspension of 14% oxadiargyl⋅A1 (6+8)

6% oxadiargyl+8% A1+4% calcium dodecylbenzen sulfonate+8% cardanol polyoxyethylene ether+4% castor oil polyoxyethylene ether+1.6% organobentonite+1.5% fumed silica+10%150 # solvent oil+methyl oleate as balance.

149 Dispersible oil suspension of 16% oxadiargyl⋅A2 (6+10)

6% oxadiargyl+10% A2+4% calcium dodecylbenzen sulfonate+8% cardanol polyoxyethylene ether+4% castor oil polyoxyethylene ether+1.5% organobentonite+1.5% fumed silica+10%150 # solvent oil+methyl oleate as balance.

150 Dispersible oil suspension of 18% oxadiargyl⋅A4 (6+12)

6% oxadiargyl+12% A4+4% calcium dodecylbenzen sulfonate+8% cardanol polyoxyethylene ether+4% castor oil polyoxyethylene ether+1.4% organobentonite+1.2% fumed silica+10%150 # solvent oil+methyl oleate as balance.

151 Dispersible oil suspension of A172+glyphosate (20+30)

20% A172+30% glyphosate+6% calcium dodecylbenzen sulfonate+6% polyoxyethylene fatty alcohol ether+6% castor oil polyoxyethylene ether+0.5% organobentonite+15%100 # solvent oil+methyl oleate as balance.

152 Dispersible oil suspension of A67+glyphosate (10+30)

10% A67+30% glyphosate+5% calcium dodecylbenzen sulfonate+6% polyoxyethylene fatty alcohol ether+5% castor oil polyoxyethylene ether+0.5% organobentonite+15%100 # solvent oil+methyl oleate as balance.

153 Dispersible oil suspension of A1+glyphosate (9+30)

9% A1+30% glyphosate+5% calcium dodecylbenzen sulfonate+6% polyoxyethylene fatty alcohol ether+5% castor oil polyoxyethylene ether+0.5% organobentonite+15%100 # solvent oil+methyl oleate as balance.

154 Dispersible oil suspension of A4+glyphosate (12+30)

12% A4+30% glyphosate+5% calcium dodecylbenzen sulfonate+6% polyoxyethylene fatty alcohol ether+5% castor oil polyoxyethylene ether+0.5% organobentonite+15%100 # solvent oil+methyl oleate as balance.

155 Dispersible oil suspension of A171+glyphosate (20+30)

20% A171+30% glyphosate+5% calcium dodecylbenzen sulfonate+6% polyoxyethylene fatty alcohol ether+6% castor oil polyoxyethylene ether+0.5% organobentonite+15%100 # solvent oil+methyl oleate as balance.

156 Dispersible oil suspension of A211+glyphosate (10+30)

10% A211+30% glyphosate+5% calcium dodecylbenzen sulfonate+6% polyoxyethylene fatty alcohol ether+6% castor oil polyoxyethylene ether+0.5% organobentonite+15%100 # solvent oil+methyl oleate as balance.

157 Dispersible oil suspension of A94+glyphosate (20+30)

20% A94+30% glyphosate+5% calcium dodecylbenzen sulfonate+6% polyoxyethylene fatty alcohol ether+6% castor oil polyoxyethylene ether+0.5% organobentonite+15%100 # solvent oil+methyl oleate as balance.

158 Dispersible oil suspension of A173+glyphosate (10+30)

10% A173+30% glyphosate+5% calcium dodecylbenzen sulfonate+6% polyoxyethylene fatty alcohol ether+6% castor oil polyoxyethylene ether+0.5% organobentonite+15%100 # solvent oil+methyl oleate as balance.

159 Dispersible oil suspension of A212+glyphosate (20+30)

20% A212+30% glyphosate+5% calcium dodecylbenzen sulfonate+6% polyoxyethylene fatty alcohol ether+6% castor oil polyoxyethylene ether+0.5% organobentonite+15%100 # solvent oil+methyl oleate as balance.

160 Dispersible oil suspension of A141+glyphosate (10+30)

10% A141+30% glyphosate+5% calcium dodecylbenzen sulfonate+6% polyoxyethylene fatty alcohol ether+6% castor oil polyoxyethylene ether+0.5% organobentonite+15%100 # solvent oil+methyl oleate as balance.

161 Dispersible oil suspension of A163+glyphosate (10+30)

10% A163+30% glyphosate+5% calcium dodecylbenzen sulfonate+8% polyoxyethylene fatty alcohol ether+5% castor oil polyoxyethylene ether+0.5% organobentonite+15%100 # solvent oil+methyl oleate as balance.

162 Dispersible oil suspension of A130+glyphosate (10+30)

10% A130+30% glyphosate+5% calcium dodecylbenzen sulfonate+7% polyoxyethylene fatty alcohol ether+5% castor oil polyoxyethylene ether+0.5% organobentonite+15%100 # solvent oil+methyl oleate as balance.

163 Dispersible oil suspension of A213+glyphosate (10+30)

10% A213+30% glyphosate+5% calcium dodecylbenzen sulfonate+7% polyoxyethylene fatty alcohol ether+5% castor oil polyoxyethylene ether+0.5% organobentonite+15%100 # solvent oil+methyl oleate as balance.

164 Dispersible oil suspension of A214+glyphosate (10+30)

10% A214+30% glyphosate+5% calcium dodecylbenzen sulfonate+7% polyoxyethylene fatty alcohol ether+5% castor oil polyoxyethylene ether+0.5% organobentonite+15%100 # solvent oil+methyl oleate as balance.

165 Dispersible oil suspension of A2+glyphosate (10+30)

10% A2+30% glyphosate+5% calcium dodecylbenzen sulfonate+7% polyoxyethylene fatty alcohol ether+5% castor oil polyoxyethylene ether+0.5% organobentonite+15%100 # solvent oil+methyl oleate as balance.

The equipments for processing the above dispersible oil suspensions: a mixing tank, a colloid mill, a sand mill, and a shearer etc.

The process for processing the above dispersible oil suspensions: all of the materials were fed into the mixing tank and mixed under stirring, introduced into the colloid mill, then subjected to 3-grade grinding in the sand mill, and finally sheared uniformly in the shearer, and transferred to the storage tank after passing the inspection.

The equipments for processing the above water suspensions: a mixing tank, a colloid mill, a sand mill, and a shearer etc.

The process for processing the above water suspensions: all of the materials were fed into the mixing tank and mixed under stirring, introduced into the colloid mill, then subjected to 3-grade grinding in the sand mill, and finally sheared uniformly in the shearer, and transferred to the storage tank after passing the inspection.

The equipments for processing the above suspoemulsions: a mixing tank, a colloid mill, a sand mill, and a shearer etc.

The process for processing the above suspoemulsions: some of the materials and additives were fed into the mixing tank and mixed under stirring, introduced into the colloid mill, then subjected to 3-grade grinding in the sand mill, and then transferred to the intermediate tank as the aqueous phase; then the remainder of the materials and cosolvent were fed into the charging tank and dissolved by stirring until they were completely transparent, and then stirred until even as the oil phase; and finally sheared in the shearer; the oil phase was slowly dripped into the aqueous phase; after all the material were dripped, shearing was continued for 1 hour, and transferred to the storage tank after passing the inspection.

The equipments for processing the above aqueous emulsions: a vacuum pump, a dosing tank, a storage tank, and a shearing tank.

The process for processing the above aqueous emulsions: the technical materials and solvent were fed into the dosing tank, stirred and dissolved until completely transparent; and the emulsifier was added, and then stirred until even as the oil phase; after that, the glycol, antifoam and deionized water are pumped into the shearing tank; and finally in the shear state, the oil phase was slowly pumped into the shearing tank; after all the materials were pumped, shearing was continued for 1 hour, and transferred to the storage tank after passing the inspection.

The equipments for processing the above microemulsions: a vacuum pump, a dosing tank, and a storage tank.

The process for processing the above microemulsions: the technical materials and solvent were fed into the dosing tank, stirred and dissolved until completely transparent; and the emulsifier was added, and then stirred until even; and the deionized water was added, and then stirred until completely transparent; and transferred to the storage tank after passing the inspection.

The equipments for processing the above emulsifiable concentrates: a vacuum pump, a dosing tank, and a storage tank.

The process for processing the above emulsifiable concentrates: the technical materials and solvent were fed into the dosing tank, stirred and dissolved until completely transparent; and the emulsifier was added, and then stirred until completely transparent; and transferred to the storage tank after passing the inspection.

The equipments for processing the above aqueous solutions: a vacuum pump, a dosing tank, and a storage tank.

The process for processing the above aqueous solutions: the technical materials and the deionized water were fed into the dosing tank, stirred and dissolved until completely transparent; and the emulsifier was added, and then stirred until completely transparent; and transferred to the storage tank after passing the inspection.

### B) Efficacy Assays

Post-Emergence Treatment by Performing Foliage Spray

1) Experimental Conditions

1.1) Tested Targets

Table 1-48, 51-98, 101-148: Echinochloa crusgalli var. zelayensis, Eclipta prostrate, Galium aparine L., Alopecurus aequalis, Alopecurus japonicus, Lindernia procumbens, Veronica persica¹, Malachium aquaticum, Beckmannia syzigachne, Stellaria media were collected in Huai'an of Jiangsu Province; Commelina communis, Sonchus arvensis, Setaria glauca, Chloris virgata, Setaria faberi, Sonchus oleraceus L., Echinochloa oryzoides, Cirsium setosum, Xanthium strumarium were collected in Qiqiha'er of Heilongjiang Province; Sinapis arvensis, Veronica persica² were collected in Zhumadian of Henan Province; Ludwigia prostrate, Ammannia arenaria were collected in Zhuji of Zhejiang Province; Amaranthus retrojlexus, Descurainia sophia, Digitaria sanguinalis, Setaria viridis, Conyza Canadensis, Capsella bursa-pastoris, Eleusine indica, Ipomoea purpurea, Abutilon theophrasti, Chenopodium album, Acalypha australis, Solanum nigrum were collected in Qingdao of Shandong Province; Echinochloa caudate were collected in Pingluo of Ningxia Province.

Table 151-206: Digitaria sanguinalis, Amaranthus retroflexus, Conyza Canadensis, Capsella bursa-pastoris, Eleusine indica were collected in Huangdao of Shandong Province, Sinapis arvensis were collected in Sixian of Anhui Province, Alopecurus japonicus were collected in Tianchang of Anhui Province, Veronica didyma were collected in Siyang of Jiangsu Province.

The above weeds were cultivated by a pot culture method. A 180×140 mm plastic nutritional bowl contained 4/5 topsoil from the field was placed in an enamel pan, wherein the soil had been air-dried and screened and had an initial moisture content of 20%. Full and uniform weed seeds were selected, soaked in warm water at 25° C. for 6 hours, and germinated in a 28° C. biochemical incubator (darkness). The weed seeds that had just germinatedwere evenly placed on the surface of the soil and then covered with 0.5-1 cm soil according to the sizes of seeds.

1.2) Culture Conditions

The culture was carried out in a controllable sunlight greenhouse at 20 to 30° C., in natural light, and relative humidity of 57% to 72%.

The soil was loam with an organic matter content of 1.63%, a pH value of 7.1, an alkali-hydrolyzable nitrogen of 84.3 mg/kg, a rapidly available phosphorus of 38.5 mg/kg, and a rapidly available potassium 82.1 mg/kg.

1.3) Equipments and Apparatuses

3WP-2000-type Walking Spray Tower (Nanjing Institute of Agricultural Machinery, the Ministry of Agriculture); GA10-type ten thousandth Electronic Balance (Germany); ZDR2000-type Intelligent Data Recorder (Hangzhou Zeda Instrument Co., Ltd.); and SPX-type Intelligent Biochemical Incubator (Ningbo Jiangnan Instrument Factory).

2) Designs of Experiments

2.1) Reagents

The desired active ingredient A is prepared based on patent CN201911321469.4. The examples of representative compounds are as follows, the synthetic methods of other compounds are similar, and will not be described in detail here.)

(1) Synthesis of Compound A67 and A1

Compound a (0.5 g, 2.13 mmol), compound b (313 mg, 2.55 mmol), a catalytic amount of TBAB (10 mg), and DMF (10 mL) were added to a round-bottom flask, and stirred at room temperature 15° C. for 24 hr. When there was a small amount of starting materials remained according to LC-MS detection, a further treatment was made. The reaction solution was poured into 50 mL of water, and extracted with methyl tert-butyl ether twice (50 mL×2). The organic phase was dried, concentrated, and separated by column chromatography, to obtain compound A67 (300 mg, yield 50%), as a white solid.

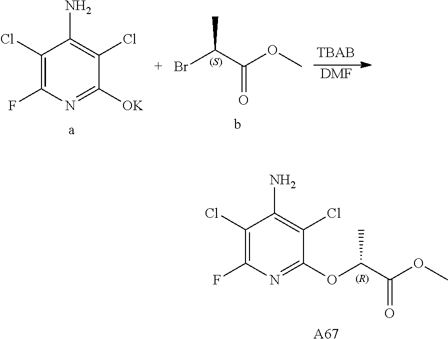

Compound A67 (0.3 g, 1.06 mmol), methanol (20 mL) were added to a 100 mL single-port flask, lithium hydroxide (44.5 mg, 1.06 mmol) was dissolved in 2 mL of water, and slowly added dropwise to the single-port flask at room temperature, followed by stirring at room temperature for 12 hr. After completed reaction of the starting materials according to LC-MS detection, the reaction solution was adjusted with 0.5M dilute HCl to pH=5-6, concentrated, and then extracted with water and ethyl acetate. The organic phase was dried, and concentrated to obtain compound A1 (200 mg, yield 70%) as a white solid.

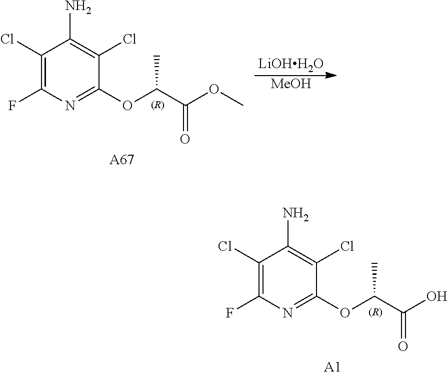

(2) Synthesis of Compound A2

Compound A1 (200 mg, 0.74 mmol), compound c (75 mg, 0.74 mmol), DCC (152 mg, 0.74 mmol), and anhydrous DCM (20 mL) were added to a 100 mL round-bottom flask, and reacted at room temperature for 12 hr. After completed reaction of the starting materials according to LC-MS detection, the reaction solution was concentrated, and separated by column chromatography to obtain compound A2 (200 mg, yield 77%), as a white solid.

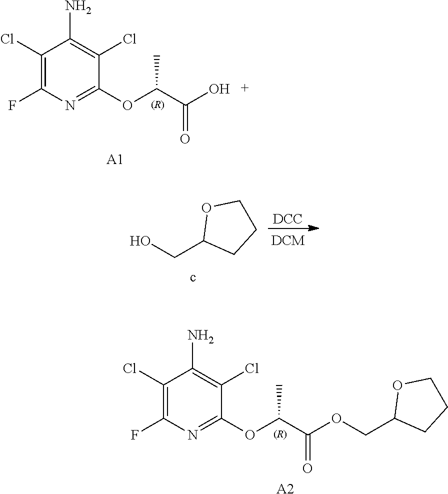

(3) Synthesis of Compound A211

Compound A1 (200 mg, 0.74 mmol), compound c (85 mg, 0.74 mmol), DCC (152 mg, 0.74 mmol), and anhydrous DCM (20 mL) were added to a 100 mL round-bottom flask, and reacted at room temperature for 12 hr. After completed reaction of the starting materials according to LC-MS detection, the reaction solution was concentrated, and separated by column chromatography to obtain compound A211 (200 mg, yield 73%), as a white solid.

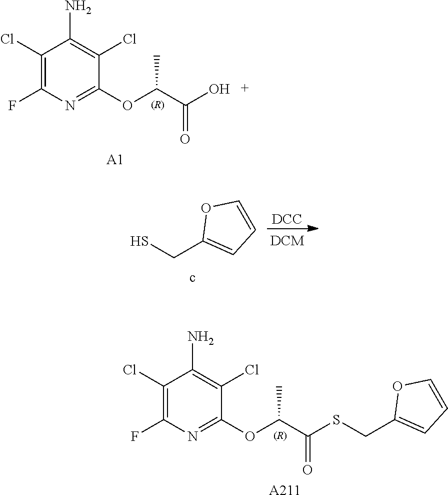

(4) Synthesis of Compound A173

Compound d (2 g, 18.16 mmol), compound b (3.64 g, 21.80 mmol), a catalytic amount of TBAB (10 mg), and DMF (20 mL) were added to a round-bottom flask, and stirred at room temperature 15° C. for 24 hr. When there was a small amount of starting materials remained according to LC-MS detection, a further treatment was made. The reaction solution was poured into 50 mL of water, and extracted with methyl tert-butyl ether twice (100 mL×2). The organic phase was dried, concentrated, and separated by column chromatography, to obtain compound e (1.5 mg, yield 42%), as a white solid.

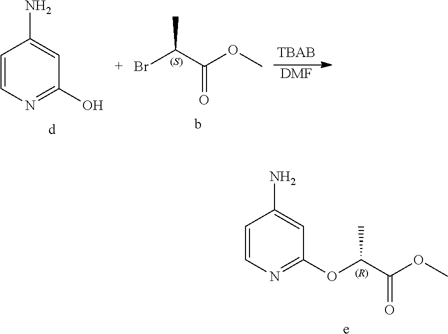

Compound e (0.5 g, 2.55 mmol) was dissolved in acetonitrile (20 mL) and placed in a 100 mL single-port flask. NCS (850.7 mg, 6.37 mmol) and a catalytic amount of BPO (10 mg) were added at room temperature, and the temperature was increased to 70° C. and reaction was continued for 2 hours. After completed reaction of the starting materials according to LC-MS detection, the reaction solution was concentrated, and separated by column chromatography to obtain compound A173 (300 mg, yield 44%), as a white solid.

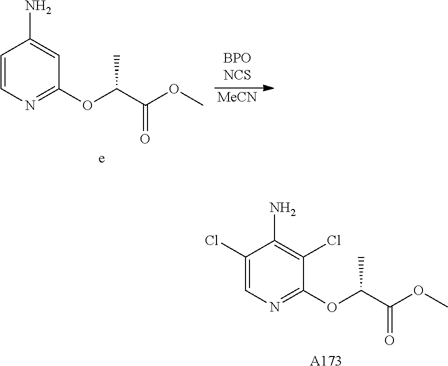

(5) Synthesis of compound A174 and A212 Compound e (0.5 g, 2.55 mmol) was dissolved in acetonitrile (20 mL) and placed in a 100 mL single-port flask. NBS (1.13 mg, 6.37 mmo) and a catalytic amount of BPO (10 mg) were added at room temperature, and the temperature was increased to 70° C. and reaction was continued for 2 hours. After completed reaction of the starting materials according to LC-MS detection, the reaction solution was concentrated, and separated by column chromatography to obtain compound A174 (500 mg, yield 54%), as a white solid.

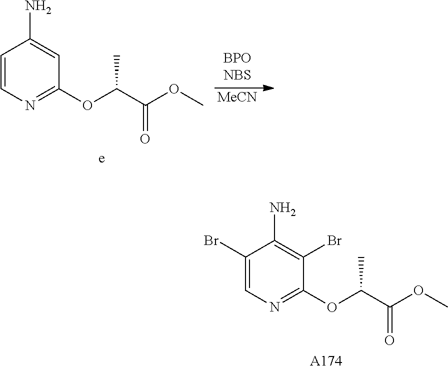

Compound A174 (0.5 g, 1.41 mmol) and methanol (20 mL) were added to a 100 mL single-port flask, lithium hydroxide (59.3 mg, 1.41 mmol) was dissolved in 2 mL of water, and slowly added dropwise to the single-port flask at room temperature, followed by stirring at room temperature for 12 hr. After completed reaction of the starting materials according to LC-MS detection, the reaction solution was adjusted with 0.5M dilute HCl to pH=5-6, concentrated, and then extracted with water and ethyl acetate. The organic phase was dried, and concentrated to obtain compound A212 (350 mg, yield 73%) as a white solid.

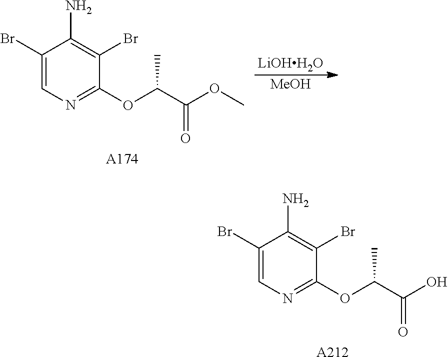

The active ingredient B for example cypyrafluone, bipyrazone, fenpyrazone and tripyrasulfone was produced by our company, and the others were purchased from reagent companies. The technical materials were all dissolved in acetone, and diluted with an aqueous solution containing 0.1% emulsifier Tween-80. The dilution is performed as required.

2.2) Experimental Treatments

2.2.1) Determination of Dosage

A ratio of the active ingredient A to the active ingredient B and amounts thereof in each group depends on the characteristics and toxicity of the two agents, as well as the main application purpose of a corresponding formulation. Based on the pre-tests in this study, the dosage of the active ingredient A and B applied alone and in combination were shown in the tables. Water containing the solvent and emulsifier same with the above groups but free of the agents was used as a blank control.

2.2.2) Repetition of Experiments

Table 1-48, 51-98, 101-148, 151-206: 3 pots with 20 weed seeds per pot were treated in one treatment with 4 replications per treatment, that is, a total of 60 weeds were treated in one treatment.

Table 207-216: 10 pots with 10 weed seeds per pot were treated in one treatment with 4 replications per treatment, and then 3 weeds per pot were maintained.

2.3) Treatment Method

2.3.1) The Timing and Frequency of the Treatment

Table 1-48, 51-98, 101-148: The agents were used for only once in the experiment. In the stage of weeds with 3˜4 leaves, the weeds were thinned out to maintain 15 weeds per pot and 45 weeds for each treatment, then continued to be cultured to 5˜6 leaves stage of grassy weeds, 6˜7 leaves stage of broadleaf weeds, and treated.

Table 151-206: The agents were used for only once in the experiment. In the stage of weeds with 3˜4 leaves, the weeds were thinned out to maintain 15 weeds per pot and 45 weeds for each treatment, then continued to be cultured to 4˜5 leaves stage of grassy weeds, 5˜6 leaves stage of broadleaf weeds, and treated.

Table 207-216: The agents were used for only once in the experiment. In the stage of weeds with 6˜8 leaves, the weeds were thinned out to maintain 3 weeds per pot and 30 weeds for each treatment, then continued to be cultured to Conyza Canadensis with a height of 10 cm, and treated.

2.3.2) Equipments and Methods for Applying Agents

The well-cultured weeds were evenly placed on a platform with an area of 0.5 m², and a solution of agents was sprayed on the stems and leaves thereof by the 3WP-2000-type walking spray tower at a dosage of 450 kg/ha and at a spray pressure of 0.3 MPa. After all the solution was sprayed, the valve was closed. After 30 seconds, the door of the spray tower was opened, and the nutritional bowl was taken out. Then the valve was opened, and the spray tube was cleaned by spraying 50 ml of water.

3) Experimental Methods

A pot-culture method was employed. For the cultivation of weeds, please refer to the Section 1.1), and “Pesticide guidelines for laboratory bioactivity tests—herbicides”. As to a method for applying agents, please refer to the section 2.3.2), that is, a foliage treatment was employed. After the treatment, the weeds were routinely cultured in a greenhouse.

4) Data Investigation and Statistical Analysis

4.1) Investigation Methods

A method for investigating absolute number was employed, wherein whole seedlings of survival weeds were cut off with a blade along the soil surface, and the fresh weight of the weeds was weighed with an analytical balance. For dead weeds, the fresh weight thereof was zero.

4.2) Investigation Timing and Frequency

Table 1-48, 51-98, 101-148, 207-216: The investigation was performed after 24 days of the treatment for only once.

Table 151-206: The investigation was performed after 20 days of the treatment for only once.

4.3) Statistical Analysis of the Data

Theoretical fresh weight inhibition rate of a combination of two active ingredients in each group was calculated by the Gowing method (E0=X+Y−X*Y/100), and then compared with an actually measured inhibition rate (E), thereby effect of the combination (hereafter referred to as combined effect) on weeds was evaluated: the value of E-E0, which was greater than 10%, corresponded to a synergistic effect, the value of E-E0, which was less than −10%, corresponded to an antagonistic effect, and the value of E-E0, which was from −10% to 10%, corresponded to an additional effect. An optimum ratio of the two active ingredients was determined by the actual control effect, characteristics of herbicides, and balance of a corresponding formula. Wherein, in the formula, X represented the fresh weight inhibition rate of the active ingredient A in a dosage of P, and Y represented the fresh weight inhibition rate of the active ingredient B in a dosage of Q.

Soil Sealing Treatment:

1) Experimental Conditions

1.1) Tested Targets

Echinochloa crusgalli var zelayensis were collected in Huai'an of Jiangsu Province; Echinochloa caudate were collected in Pingluo of Ningxia Province; Echinochloa oryzoides were collected in Qiqiha'er of Heilongjiang Province.

1.2) Culture Conditions

The culture was carried out in a controllable sunlight greenhouse at 20 to 30° C., in natural light, and relative humidity of 57% to 72%. The soil was loam with an organic matter content of 1.63%, a pH value of 7.1, an alkali-hydrolyzable nitrogen of 84.3 mg/kg, a rapidly available phosphorus of 38.5 mg/kg, and a rapidly available potassium 82.1 mg/kg. The test soil was placed quantitatively to ¾ of the pots and then watered from the bottom of the pots to completely wet the soil to saturation. The pretreated test weed seeds were uniformly sowed on the surface, then covered with 0.5-2 cm soil according to the seed size, and ready-for use 24 hours after sowing.

1.3) Equipments and Apparatuses

GA10-type ten thousandth Electronic Balance (Germany); ZDR2000-type Intelligent Data Recorder (Hangzhou Zeda Instrument Co., Ltd.); SPX-type Intelligent Biochemical Incubator (Ningbo Jiangnan Instrument Factory) and pipettor etc.

2) Designs of Experiments

2.1) Reagents

The technical materials were all dissolved in acetone, and diluted with an aqueous solution containing 0.1% emulsifier T-80. The dilution is performed as required.

2.2) Experimental Treatments

2.2.1) Determination of Dosage

A ratio of A to the active ingredient B and amounts thereof in each group depends on the characteristics and toxicity of the two agents, as well as the main application purpose of a corresponding formulation. Based on the pre-tests in this study, the dosage of A and the active ingredient B applied alone and in combination were shown in the tables. Water containing the solvent and emulsifier same with the above groups but free of the agents was used as a blank control.

2.2.2) Repetition of Experiments

3 pots with 30 weed seeds per pot were treated in one treatment with 4 replications per treatment.

3) Experimental Methods

The pots which were sowed and mulched were evenly placed on a platform with an area of 0.5 m², and a solution of agents was sprayed on soil surface thereof by the 3WP-2000-type walking spray tower at a dosage of 675 kg/ha and at a spray pressure of 0.3 MPa. After all the solution was sprayed, the valve was closed. After 30 seconds, the door of the spray tower was opened, and the nutritional bowl was taken out. Then the valve was opened, and the spray tube was cleaned by spraying 50 ml of water.

4) Data Investigation and Statistical Analysis

This section was same as the section 4) in the post-emergence treatment by performing foliage spray, and was not repeated herein.

The statistical results were shown in the tables 1-216 below. Apart from those marked as soil sealing treatments, others are all post-emergence treatments by performing foliage spray.

TABLE 1
Control effects of A2 or penoxsulam alone and of a combination thereof on
Echinochloa crusgalli var. zelayensis

| | | Control effect | Control effect | | | |
|---|---|---|---|---|---|---|
| | | (%) of A | (%) of B | | | |
| | | applied alone | applied alone | | | |
| A + B dose | | in corresponding | in corresponding | Control effect | | E − E0 |
| g a.i/ha | A:B | dose | dose | of A + B (%), E | E0 (%) | (%) |
| 150 + 1.875 | 80:1 | 75.3 | 2.4 | 89.4 | 75.9 | 13.5 |
| 150 + 3.75 | 40:1 | 75.3 | 10.9 | 90.2 | 78.0 | 12.2 |
| 75 + 7.5 | 10:1 | 54.2 | 48.8 | 88.9 | 76.6 | 12.3 |
| 75 + 15 | 5:1 | 54.2 | 70.1 | 99.7 | 86.3 | 13.4 |

TABLE 2
Control effects of A2 or bispyribac-sodium alone and of a combination thereof on
Echinochloa crusgalli var. zelayensis

| | | Control effect | Control effect | | | |
|---|---|---|---|---|---|---|
| | | (%) of A | (%) of B | | | |
| | | applied alone | applied alone | | | |
| A + B dose | | in corresponding | in corresponding | Control effect | | E − E0 |
| g a.i/ha | A:B | dose | dose | of A + B (%), E | E0 (%) | (%) |
| 150 + 1.875 | 80:1 | 75.3 | 5.3 | 87.9 | 76.6 | 11.3 |
| 150 + 3.75 | 40:1 | 75.3 | 17.4 | 92.1 | 79.6 | 12.5 |
| 75 + 7.5 | 10:1 | 54.2 | 43.4 | 86.2 | 74.1 | 12.1 |
| 75 + 15 | 5:1 | 54.2 | 62.9 | 95.2 | 83.0 | 12.2 |

TABLE 3
Control effects of A2 or pyrazosulfuron-ethyl alone and of combination thereof on
Eclipta prostrate

| | | Control effect | Control effect | | | |
|---|---|---|---|---|---|---|
| | | (%) of A | (%) of B | | | |
| | | applied alone | applied alone | | | |
| A + B dose | | in corresponding | in corresponding | Control effect | | E − E0 |
| g a.i/ha | A:B | dose | dose | of A + B (%), E | E0 (%) | (%) |
| 150 + 1.875 | 80:1 | 68.4 | 9.5 | 83.5 | 71.4 | 12.1 |
| 150 + 3.75 | 40:1 | 68.4 | 19.9 | 87.2 | 74.7 | 12.5 |
| 75 + 7.5 | 10:1 | 32.3 | 51.0 | 80.4 | 66.8 | 13.6 |
| 75 + 15 | 5:1 | 32.3 | 76.1 | 96.2 | 83.8 | 12.4 |

TABLE 4
Control effects of A2 or nicosulfuron alone and of a combination thereof on
Echinochloa crusgalli var. zelayensis

| | | Control effect | Control effect | | | |
|---|---|---|---|---|---|---|
| | | (%) of A | (%) of B | | | |
| | | applied alone | applied alone | | | |
| A + B dose | | in corresponding | in corresponding | Control effect | | E − E0 |
| g a.i/ha | A:B | dose | dose | of A + B (%), E | E0 (%) | (%) |
| 150 + 3.75 | 40:1 | 75.3 | 7.3 | 88.1 | 77.1 | 11.0 |
| 150 + 7.5 | 20:1 | 75.3 | 15.4 | 91.4 | 79.1 | 12.3 |
| 75 + 15 | 5:1 | 54.2 | 39.3 | 86.5 | 72.2 | 14.3 |
| 75 + 30 | 5:2 | 54.2 | 58.7 | 94.0 | 81.1 | 12.9 |

TABLE 5
Control effects of A2 or florasulam alone and of combination thereof on Galium aparine L.

| | | Control effect | Control effect | | | |
|---|---|---|---|---|---|---|
| | | (%) of A | (%) of B | | | |
| | | applied alone | applied alone | | | |
| A + B dose | | in corresponding | in corresponding | Control effect | | E − E0 |
| g a.i/ha | A:B | dose | dose | of A + B (%), E | E0 (%) | (%) |
| 150 + 0.375 | 40:1 | 68.5 | 4.8 | 82.6 | 70.0 | 12.6 |
| 15 + 0.75 | 20:1 | 68.5 | 20.6 | 88.2 | 75.0 | 13.2 |
| 7.5 + 1.5 | 5:1 | 34.8 | 56.3 | 86.4 | 71.5 | 14.9 |
| 7.5 + 3.0 | 5:2 | 34.8 | 76.2 | 98.2 | 84.5 | 13.7 |

TABLE 6
Control effects of A2 or rimsulfuron alone and of a combination thereof on
Echinochloa crusgalli var. zelayensis

| | | Control effect | Control effect | | | |
|---|---|---|---|---|---|---|
| | | (%) of A | (%) of B | | | |
| | | applied alone | applied alone | | | |
| A + B dose | | in corresponding | in corresponding | Control effect | | E − E0 |
| g a.i/ha | A:B | dose | dose | of A + B (%), E | E0 (%) | (%) |
| 150 + 1.875 | 80:1 | 75.3 | 7.7 | 88.4 | 77.2 | 11.2 |
| 150 + 3.75 | 40:1 | 75.3 | 25.5 | 93.6 | 81.6 | 12.0 |
| 75 + 7.5 | 10:1 | 54.2 | 39.7 | 87.0 | 72.4 | 14.6 |
| 75 + 15 | 5:1 | 54.2 | 67.7 | 97.9 | 85.2 | 12.7 |

TABLE 7
Control effects of A2 or imazethapyr alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 7.5 | 20:1 | 75.3 | 3.2 | 86.6 | 76.1 | 10.5 |
| 150 + 15 | 10:1 | 75.3 | 19.8 | 93.9 | 80.2 | 13.7 |
| 75 + 30 | 5:2 | 54.2 | 31.2 | 83.3 | 68.5 | 14.8 |
| 75 + 60 | 5:4 | 54.2 | 59.2 | 93.7 | 81.3 | 12.4 |

TABLE 8
Control effects of A2 or imazapic alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 9.375 | 16:1 | 75.3 | 1.2 | 87.9 | 75.6 | 12.3 |
| 150 + 18.75 | 8:1 | 75.3 | 18.6 | 92.3 | 79.9 | 12.4 |
| 75 + 37.5 | 2:1 | 54.2 | 26.9 | 82.2 | 66.5 | 15.7 |
| 75 + 75 | 1:1 | 54.2 | 57.0 | 92.4 | 80.3 | 12.1 |

TABLE 9
Control effects of A2 or imazamox alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 3.75 | 40:1 | 75.3 | 6.9 | 89.2 | 77.0 | 12.2 |
| 150 + 7.5 | 20:1 | 75.3 | 14.2 | 91.4 | 78.8 | 12.6 |
| 75 + 15 | 5:1 | 54.2 | 25.1 | 81.1 | 65.7 | 15.4 |
| 75 + 30 | 5:2 | 54.2 | 54.8 | 91.1 | 79.3 | 11.8 |

TABLE 10
Control effects of A2 or sulfometuron-methyl alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 9.375 | 16:1 | 75.3 | 2.0 | 85.9 | 75.8 | 10.1 |
| 150 + 18.75 | 8:1 | 75.3 | 13.8 | 94.5 | 78.7 | 15.8 |
| 75 + 37.5 | 2:1 | 54.2 | 24.5 | 79.1 | 65.4 | 13.7 |
| 75 + 75 | 1:1 | 54.2 | 54.8 | 91.8 | 79.3 | 12.5 |

TABLE 11
Control effects of A2 or cloransulam-methyl alone and of a
combination thereof on Commelina communis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 60 + 1.875 | 32:1 | 67.8 | 4.7 | 81.2 | 69.3 | 11.9 |
| 60 + 3.75 | 16:1 | 67.8 | 15.2 | 86.9 | 72.7 | 14.2 |
| 30 + 7.5 | 4:1 | 32.3 | 53.5 | 82.3 | 68.5 | 13.8 |
| 30 + 15 | 2:1 | 32.3 | 71.8 | 93.4 | 80.9 | 12.5 |

TABLE 12
Control effects of A2 or cyhalofop-butyl alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 9.375 | 16:1 | 75.3 | 1.6 | 86.7 | 75.7 | 11.0 |
| 150 + 18.75 | 8:1 | 75.3 | 17.4 | 89.8 | 79.6 | 10.2 |
| 75 + 37.5 | 2:1 | 54.2 | 31.0 | 81.3 | 68.4 | 12.9 |
| 75 + 75 | 1:1 | 54.2 | 70.3 | 98.6 | 86.4 | 12.2 |

TABLE 13
Control effects of A2 or clodinafop-propargyl alone and of a
combination thereof on Alopecurus aequalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 3.75 | 40:1 | 45.5 | 6.1 | 61.1 | 48.8 | 12.3 |
| 150 + 7.5 | 20:1 | 45.5 | 16.3 | 68.2 | 54.4 | 13.8 |
| 75 + 15 | 5:1 | 23.8 | 59.3 | 83.4 | 69.0 | 14.4 |
| 75 + 30 | 5:2 | 23.8 | 81.1 | 98.3 | 85.6 | 12.7 |

TABLE 14
Control effects of A2 or pinoxaden alone and of a combination
thereof on Alopecurus aequalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 3.75 | 40:1 | 45.5 | 3.5 | 58.8 | 47.4 | 11.4 |
| 150 + 7.5 | 20:1 | 45.5 | 14.1 | 67.3 | 53.2 | 14.1 |
| 75 + 15 | 5:1 | 23.8 | 43.0 | 71.9 | 56.6 | 15.3 |
| 75 + 30 | 5:2 | 23.8 | 72.4 | 92.1 | 79.0 | 13.1 |

TABLE 15
Control effects of A2 or clethodim alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 7.5 | 20:1 | 75.3 | 8.5 | 87.9 | 77.4 | 10.5 |
| 150 + 15 | 10:1 | 75.3 | 23.9 | 93.1 | 81.2 | 11.9 |
| 75 + 30 | 5:2 | 54.2 | 44.3 | 87.6 | 74.5 | 13.1 |
| 75 + 60 | 5:4 | 54.2 | 68.8 | 98.4 | 85.7 | 12.7 |

TABLE 16
Control effects of A2 or sethoxydim alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 15 | 10:1 | 75.3 | 6.5 | 88.1 | 76.9 | 11.2 |
| 150 + 30 | 5:1 | 75.3 | 22.3 | 93.4 | 80.8 | 12.6 |
| 75 + 60 | 5:4 | 54.2 | 42.4 | 87.9 | 73.6 | 14.3 |
| 75 + 120 | 5:8 | 54.2 | 62.4 | 97.2 | 82.8 | 14.4 |

TABLE 17
Control effects of A2 or quizalofop-P-methyl alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 3.75 | 40:1 | 75.3 | 8.5 | 89.3 | 77.4 | 11.9 |
| 150 + 7.5 | 20:1 | 75.3 | 12.6 | 91.7 | 78.4 | 13.3 |
| 75 + 15 | 5:1 | 54.2 | 40.4 | 88.2 | 72.7 | 15.5 |
| 75 + 30 | 5:2 | 54.2 | 71.0 | 99.4 | 86.7 | 12.7 |

TABLE 18
Control effects of A2 or fluazifop-P-butyl alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 3.75 | 40:1 | 75.3 | 2.0 | 88.6 | 75.8 | 12.8 |
| 150 + 7.5 | 20:1 | 75.3 | 18.2 | 92.8 | 79.8 | 13.0 |
| 75 + 15 | 5:1 | 54.2 | 37.3 | 87.1 | 71.3 | 15.8 |
| 75 + 30 | 5:2 | 54.2 | 73.1 | 98.1 | 87.7 | 10.4 |

TABLE 19
Control effects of A2 or haloxyfop-P-methyl alone and of a
combination thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 3.75 | 40:1 | 75.3 | 3.6 | 87.9 | 76.2 | 11.7 |
| 150 + 7.5 | 20:1 | 75.3 | 11.7 | 90.9 | 78.2 | 12.7 |
| 75 + 15 | 5:1 | 54.2 | 40.8 | 86.0 | 72.9 | 13.1 |
| 75 + 30 | 5:2 | 54.2 | 74.5 | 99.8 | 88.3 | 11.5 |

TABLE 20
Control effects of A2 or atrazine alone and of a combination
thereof on Echinochloa crusgalli var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 75 | 2:1 | 75.3 | 4.5 | 89.4 | 76.4 | 13.0 |
| 150 + 150 | 1:1 | 75.3 | 15.4 | 90.2 | 79.1 | 11.1 |
| 75 + 300 | 1:4 | 54.2 | 26.9 | 78.8 | 66.5 | 12.3 |
| 75 + 600 | 1:8 | 54.2 | 65.5 | 94.7 | 84.2 | 10.5 |

TABLE 21
Control effects of A2 or isoproturon alone and of a combination
thereof on Alopecurus aequalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B (%), | | |
| g a.i./ha | A:B | dose | dose | E | E0 (%) | E − E0 (%) |
| 150 + 75 | 2:1 | 45.5 | 2.6 | 59.4 | 46.9 | 12.5 |
| 150 + 150 | 1:1 | 45.5 | 11.9 | 64.7 | 52.0 | 12.7 |
| 75 + 300 | 1:4 | 23.8 | 57.2 | 81.9 | 67.4 | 14.5 |
| 75 + 600 | 1:8 | 23.8 | 76.5 | 95.3 | 82.1 | 13.2 |

TABLE 22
Control effects of A2 or chlorotoluron alone and of a combination thereof on Alopecurus aequalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 45.5 | 1.7 | 56.5 | 46.4 | 10.1 |
| 150 + 150 | 1:1 | 45.5 | 12.8 | 63.9 | 52.5 | 11.4 |
| 75 + 300 | 1:4 | 23.8 | 40.6 | 68.5 | 54.7 | 13.8 |
| 75 + 600 | 1:8 | 23.8 | 71.9 | 91.2 | 78.6 | 12.6 |

TABLE 23
Control effects of A2 or diuron alone and of a combination thereof on Echinochloa crusgalli var.
zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 75.3 | 2.0 | 86.6 | 75.8 | 10.8 |
| 150 + 150 | 1:1 | 75.3 | 13.0 | 91.3 | 78.5 | 12.8 |
| 75 + 300 | 1:4 | 54.2 | 29.3 | 79.1 | 67.6 | 11.5 |
| 75 + 600 | 1:8 | 54.2 | 55.0 | 91.5 | 79.4 | 12.1 |

TABLE 24
Control effects of A2 or bentazone alone and of a combination thereof on Lindernia procumbens

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 15 + 18.75 | 4:5 | 78.9 | 4.3 | 91.2 | 79.8 | 11.4 |
| 15 + 37.5 | 2:5 | 78.9 | 10.0 | 93.2 | 81.0 | 12.2 |
| 7.5 + 75 | 1:10 | 42.3 | 45.4 | 82.3 | 68.5 | 13.8 |
| 7.5 + 150 | 1:20 | 42.3 | 76.1 | 98.7 | 86.2 | 12.5 |

TABLE 25
Control effects of A2 or bromoxynil alone and of a combination thereof on Amaranthus retroflexus

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 15 + 18.75 | 8:1 | 52.4 | 3.2 | 64.2 | 53.9 | 10.3 |
| 15 + 37.5 | 4:1 | 52.4 | 9.2 | 68.1 | 56.8 | 11.3 |
| 75 + 75 | 1:1 | 22.9 | 57.8 | 81.2 | 67.5 | 13.7 |
| 75 + 150 | 1:2 | 22.9 | 83.7 | 99.6 | 87.4 | 12.2 |

TABLE 26
Control effects of A2 or propanil alone and of a combination thereof on Echinochloa crusgalli var.
zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 75.3 | 6.1 | 88.9 | 76.8 | 12.1 |
| 150 + 150 | 1:1 | 75.3 | 18.6 | 93.4 | 79.9 | 13.5 |
| 75 + 300 | 1:4 | 54.2 | 35.2 | 82.1 | 70.3 | 11.8 |
| 75 + 600 | 1:8 | 54.2 | 52.6 | 90.2 | 78.3 | 11.9 |

TABLE 27
Control effects of A2 or cypyrafluone alone and of a combination thereof on Alopecurus aequalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 15 + 18.75 | 8:1 | 45.5 | 4.6 | 60.2 | 48.0 | 12.2 |
| 15 + 37.5 | 4:1 | 45.5 | 10.1 | 64.7 | 51.0 | 13.7 |
| 75 + 75 | 1:1 | 23.8 | 55.9 | 79.3 | 66.4 | 12.9 |
| 75 + 150 | 1:2 | 23.8 | 81.8 | 97.6 | 86.1 | 11.5 |

TABLE 28
Control effects of A2 or bipyrazone alone and of a combination thereof on Descurainia sophia

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 30 + 1.875 | 16:1 | 74.2 | 4.3 | 86.5 | 75.3 | 11.2 |
| 30 + 3.75 | 8:1 | 74.2 | 19.0 | 92.7 | 79.1 | 13.6 |
| 15 + 7.5 | 2:1 | 35.7 | 48.7 | 80.2 | 67.0 | 13.2 |
| 15 + 15 | 1:1 | 35.7 | 82.9 | 99.3 | 89.0 | 10.3 |

TABLE 29
Control effects of A2 or fenpyrazone alone and of a combination thereof on Digitaria sanguinalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 7.5 | 20:1 | 48.9 | 5.3 | 62.4 | 51.6 | 10.8 |
| 150 + 15 | 10:1 | 48.9 | 14.7 | 72.3 | 56.4 | 15.9 |
| 75 + 30 | 5:2 | 22.4 | 40.2 | 67.2 | 53.6 | 13.6 |
| 75 + 60 | 5:4 | 22.4 | 79.6 | 95.4 | 84.2 | 11.2 |

TABLE 30
Control effects of A2 or tripyrasulfone alone and of a combination thereof on Echinochloa crusgalli
var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 18.75 | 8:1 | 75.3 | 6.9 | 88.2 | 77.0 | 11.2 |
| 150 + 37.5 | 4:1 | 75.3 | 16.2 | 94.5 | 79.3 | 15.2 |
| 75 + 75 | 1:1 | 54.2 | 42.8 | 87.9 | 73.8 | 14.1 |
| 75 + 150 | 1:2 | 54.2 | 74:5 | 98.9 | 88.3 | 10.6 |

TABLE 31
Control effects of A2 or tefuryltrione alone and of a combination thereof on Echinochloa crusgalli var.
zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 7.5 | 20:1 | 75.3 | 6.9 | 89.2 | 77.0 | 12.2 |
| 150 + 15 | 10:1 | 75.3 | 17.0 | 91.6 | 79.5 | 12.1 |
| 75 + 30 | 5:2 | 54.2 | 44.3 | 86.8 | 74.5 | 12.3 |
| 75 + 60 | 5:4 | 54.2 | 68.3 | 97.6 | 85.5 | 12.1 |

TABLE 32
Control effects of A2 or mesotrione alone and of a combination thereof on Digitaria sanguinalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 15 | 10:1 | 48.9 | 6.3 | 62.6 | 52.1 | 10.5 |
| 150 + 30 | 5:1 | 48.9 | 13.3 | 69.2 | 55.7 | 13.5 |
| 75 + 60 | 5:4 | 22.4 | 38.5 | 64.7 | 52.3 | 12.4 |
| 75 + 120 | 5:8 | 22.4 | 75.6 | 93.2 | 81.1 | 12.1 |

TABLE 33
Control effects of A2 or tembotrione alone and of a combination thereof on Digitaria sanguinalis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 3.75 | 40:1 | 48.9 | 3.7 | 61.5 | 50.8 | 10.7 |
| 150 + 7.5 | 20:1 | 48.9 | 12.1 | 69.9 | 55.1 | 14.8 |
| 75 + 15 | 5:1 | 22.4 | 41.2 | 68.6 | 54.4 | 14.2 |
| 75 + 30 | 5:2 | 22.4 | 73.8 | 91.2 | 79.7 | 11.5 |

TABLE 34
Control effects of A2 or topramezone alone and of a combination thereof on Setaria viridis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 60 + 1.875 | 32:1 | 56.3 | 2.3 | 69.5 | 57.3 | 12.2 |
| 60 + 3.75 | 16:1 | 56.3 | 11.0 | 74.7 | 61.1 | 13.6 |
| 30 + 7.5 | 4:1 | 32.7 | 37.0 | 72.1 | 57.6 | 14.5 |
| 30 + 15 | 2:1 | 32.7 | 76.1 | 95.3 | 83.9 | 11.4 |

TABLE 35
Control effects of A2 or isoxaflutole alone and of a combination thereof on Echinochloa crusgalli var.
zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 7.5 | 20:1 | 75.3 | 6.1 | 89.6 | 76.8 | 12.8 |
| 150 + 15 | 10:1 | 75.3 | 17.8 | 94.5 | 79.7 | 14.8 |
| 75 + 30 | 5:2 | 54.2 | 49.0 | 89.2 | 76.7 | 12.5 |
| 75 + 60 | 5:4 | 54.2 | 64.4 | 94.5 | 83.7 | 10.8 |

TABLE 36
Control effects of A2 or benzobicylon alone and of a combination thereof on Echinochloa crusgalli
var. zelayensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 37.5 | 4:1 | 75.3 | 7.3 | 90.2 | 77.1 | 13.1 |
| 150 + 75 | 2:1 | 75.3 | 16.2 | 91.8 | 79.3 | 12.5 |
| 75 + 150 | 1:2 | 54.2 | 44.9 | 86.5 | 74.8 | 11.7 |
| 75 + 300 | 1:4 | 54.2 | 55.9 | 91.3 | 79.8 | 11.5 |

TABLE 37
Control effects of A2 or diflufenican alone and of a combination thereof on Veronica persica¹

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 15 | 10:1 | 38.4 | 2.1 | 51.2 | 39.7 | 11.5 |
| 150 + 30 | 5:1 | 38.4 | 14.4 | 61.8 | 47.3 | 14.5 |
| 75 + 60 | 5:4 | 18.2 | 41.3 | 65.8 | 52.0 | 13.8 |
| 75 + 120 | 5:8 | 18.2 | 76.7 | 93.3 | 80.9 | 12.4 |

TABLE 38
Control effects of A2 or flurochloridone alone and of a combination thereof on Veronica persica¹

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 75 | 2:1 | 38.4 | 4.9 | 53.7 | 41.4 | 12.3 |
| 150 + 150 | 1:1 | 38.4 | 13.1 | 59.9 | 46.5 | 13.4 |
| 75 + 300 | 1:4 | 18.2 | 45.5 | 71.2 | 55.4 | 15.8 |
| 75 + 600 | 1:8 | 18.2 | 80.0 | 97.2 | 83.6 | 13.6 |

TABLE 39
Control effects of A2 or clomazone alone and of a combination thereof on Echinochloa
crusgalli var. zelayensis

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 45 | 10:3 | 75.3 | 5.7 | 89.4 | 76.7 | 12.7 |
| 150 + 90 | 5:3 | 75.3 | 10.1 | 90.2 | 77.8 | 12.4 |
| 75 + 180 | 5:12 | 54.2 | 48.8 | 88.9 | 76.6 | 12.3 |
| 75 + 360 | 5:24 | 54.2 | 70.7 | 99.7 | 86.6 | 13.1 |

TABLE 40
Control effects of A2 or carfentrazone-ethyl alone and of a combination thereof on Veronica persica¹

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 1.875 | 80:1 | 38.4 | 2.4 | 51.8 | 39.9 | 11.9 |
| 150 + 3.75 | 40:1 | 38.4 | 11.5 | 58.3 | 45.5 | 12.8 |
| 75 + 7.5 | 10:1 | 18.2 | 37.3 | 62.4 | 48.7 | 13.7 |
| 75 + 15 | 5:1 | 18.2 | 68.7 | 87.1 | 74.4 | 12.7 |

TABLE 41
Control effects of A2 or fomesafen alone and of a combination thereof on Amaranthus retroflexus

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 22.5 | 20:3 | 52.4 | 5.0 | 64.9 | 54.8 | 10.1 |
| 150 + 45 | 10:3 | 52.4 | 11.3 | 71.2 | 57.8 | 13.4 |
| 75 + 90 | 5:6 | 22.9 | 45.5 | 72.6 | 58.0 | 14.6 |
| 75 + 180 | 5:12 | 22.9 | 82.0 | 98.5 | 86.1 | 12.4 |

TABLE 42
Control effects of A2 or fluoroglycofen alone and of a combination thereof on Amaranthus retroflexus

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 0.9375 | 160:1 | 52.4 | 2.5 | 65.4 | 53.6 | 11.8 |
| 150 + 1.875 | 80:1 | 52.4 | 14.5 | 71.3 | 59.3 | 12.0 |
| 75 + 3.75 | 20:1 | 22.9 | 40.1 | 67.6 | 53.8 | 13.8 |
| 75 + 7.5 | 10:1 | 22.9 | 70.7 | 89.9 | 77.4 | 12.5 |

TABLE 43
Control effects of A2 or oxyfluorfen alone and of a combination thereof on Amaranthus retroflexus

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 7.5 | 20:1 | 52.4 | 3.2 | 64.1 | 53.9 | 10.2 |
| 150 + 15 | 10:1 | 52.4 | 11.1 | 68.4 | 57.7 | 10.7 |
| 75 + 30 | 5:2 | 22.9 | 30.9 | 59.8 | 46.7 | 13.1 |
| 75 + 60 | 5:4 | 22.9 | 68.1 | 87.3 | 75.4 | 11.9 |

TABLE 44
Control effects of A2 or lactofen alone and of a combination thereof on Amaranthus retroflexus

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 7.5 | 20:1 | 52.4 | 1.3 | 63.5 | 53.0 | 10.5 |
| 150 + 15 | 10:1 | 52.4 | 12.2 | 71.2 | 58.2 | 13.0 |
| 75 + 30 | 5:2 | 22.9 | 39.8 | 65.8 | 53.6 | 12.2 |
| 75 + 60 | 5:4 | 22.9 | 65.5 | 84.2 | 73.4 | 10.8 |

TABLE 45
Control effects of A2 or acifluorfen-sodium alone and of a combination thereof on Amaranthus
retroflexus

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 37.5 | 4:1 | 52.4 | 4.4 | 65.7 | 54.5 | 11.2 |
| 150 + 75 | 2:1 | 52.4 | 10.3 | 67.6 | 57.3 | 10.3 |
| 75 + 150 | 1:2 | 22.9 | 45.1 | 70.8 | 57.7 | 13.1 |
| 75 + 300 | 1:4 | 22.9 | 85.0 | 98.7 | 88.4 | 10.3 |

TABLE 46
Control effects of A2 or flumioxazin alone and of a combination thereof on Amaranthus retroflexus

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 7.5 | 20:1 | 52.4 | 5.5 | 67.5 | 55.0 | 12.5 |
| 150 + 15 | 10:1 | 52.4 | 12.4 | 71.3 | 58.3 | 13.0 |
| 75 + 30 | 5:2 | 22.9 | 37.4 | 63.9 | 51.7 | 12.2 |
| 75 + 60 | 5:4 | 22.9 | 78.9 | 94.5 | 83.7 | 10.8 |

TABLE 47
Control effects of A2 or sulfentrazone alone and of a combination thereof on Echinochloa
crusgalli var. zelayensis

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 1.875 | 80:1 | 75.3 | 2.8 | 87.1 | 76.0 | 11.1 |
| 150 + 3.75 | 40:1 | 75.3 | 15.4 | 92.4 | 79.1 | 13.3 |
| 75 + 7.5 | 10:1 | 54.2 | 26.9 | 78.8 | 66.5 | 12.3 |
| 75 + 15 | 5:1 | 54.2 | 54.1 | 90.2 | 79.0 | 11.2 |

TABLE 48
Control effects of A2 or saflufenacil alone and of a combination thereof on Conyza Canadensis

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 3.75 | 40:1 | 57.2 | 3.0 | 70.8 | 58.5 | 12.3 |
| 150 + 7.5 | 20:1 | 57.2 | 11.9 | 75.5 | 62.3 | 13.2 |
| 75 + 15 | 5:1 | 36.7 | 39.2 | 75.7 | 61.5 | 14.2 |
| 75 + 30 | 5:2 | 36.7 | 76.5 | 98.3 | 85.1 | 13.2 |

TABLE 49
Control effects of A2 or oxadiazon alone and of a combination thereof on Echinochloa crusgalli
var. zelayensis (soil sealing treatment)

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 37.5 | 4:1 | 45.2 | 4.2 | 59.1 | 47.5 | 11.6 |
| 150 + 75 | 2:1 | 45.2 | 25.4 | 71.2 | 59.1 | 12.1 |
| 75 + 150 | 1:2 | 21.4 | 41.5 | 66.3 | 54.0 | 12.3 |
| 75 + 300 | 1:4 | 21.4 | 64.2 | 85.2 | 71.9 | 13.3 |

TABLE 50
Control effects of A2 or oxadiargyl alone and of a combination thereof on Echinochloa crusgalli
var. zelayensis (soil sealing treatment)

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 7.5 | 20:1 | 45.2 | 1.6 | 56.5 | 46.1 | 10.4 |
| 150 + 15 | 10:1 | 45.2 | 10.4 | 61.2 | 50.9 | 10.3 |
| 75 + 30 | 5:2 | 21.4 | 38.8 | 64.2 | 51.9 | 12.3 |
| 75 + 60 | 5:4 | 21.4 | 63.5 | 82.7 | 71.3 | 11.4 |

TABLE 51
Control effects of A1 orpenoxsulam alone and of a combination thereof on Echinochloa caudate

| | | Control effect | Control effect | | | |
|---|---|---|---|---|---|---|
| | | (%) of A | (%) of B | | | |
| | | applied alone | applied alone | Control effect | | |
| A + B dose | | in corresponding | in corresponding | of A + B | E0 | E-E0 |
| (g a.i./ha) | A:B | dose | dose | (%), E | (%) | (%) |
| 150 + 1.875 | 80:1 | 76.3 | 3.8 | 87.4 | 77.2 | 10.2 |
| 150 + 3.75 | 40:1 | 76.3 | 15.6 | 92.2 | 80.0 | 12.2 |
| 75 + 7.5 | 10:1 | 55.2 | 46.5 | 88.9 | 76.1 | 12.8 |
| 75 + 15 | 5:1 | 55.2 | 69.4 | 99.7 | 86.3 | 13.4 |

TABLE 52
Control effects of A1 or bispyribac-sodium alone and of a combination thereof
on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 1.875 | 80:1 | 76.3 | 5.5 | 88.9 | 77.6 | 11.3 |
| 150 + 3.75 | 40:1 | 76.3 | 16.0 | 92.8 | 80.1 | 12.7 |
| 75 + 7.5 | 10:1 | 55.2 | 44.9 | 87.2 | 75.3 | 11.9 |
| 75 + 15 | 5:1 | 55.2 | 62.1 | 95.6 | 83.0 | 12.6 |

TABLE 53
Control effects of A1 or pyrazosulfuron-ethyl alone and of a combination
thereof on Ludwigia prostrate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 1.875 | 80:1 | 72.4 | 7.6 | 86.8 | 74.5 | 12.3 |
| 150 + 3.75 | 40:1 | 72.4 | 13.0 | 89.1 | 76.0 | 13.1 |
| 75 + 7.5 | 10:1 | 34.3 | 52.2 | 81.2 | 68.6 | 12.6 |
| 75 + 15 | 5:1 | 34.3 | 75.3 | 95.9 | 83.8 | 12.1 |

TABLE 54
Control effects of A1 or nicosulfuron alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 3.75 | 40:1 | 76.3 | 3.8 | 88.4 | 77.2 | 11.2 |
| 150 + 7.5 | 20:1 | 76.3 | 14.3 | 91.6 | 79.7 | 11.9 |
| 75 + 15 | 5:1 | 55.2 | 40.2 | 87.5 | 73.2 | 14.3 |
| 75 + 30 | 5:2 | 55.2 | 58.5 | 94.3 | 81.4 | 12.9 |

TABLE 55
Control effects of A1 or florasulam alone and of a combination
thereof on Malachium aquaticum

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 15 + 0.375 | 40:1 | 69.6 | 3.6 | 80.9 | 70.7 | 10.2 |
| 15 + 0.75 | 20:1 | 69.6 | 17.4 | 86.2 | 74.9 | 11.3 |
| 7.5 + 1.5 | 5:1 | 35.8 | 56.4 | 85.9 | 72.0 | 13.9 |
| 7.5 + 3.0 | 5:2 | 35.8 | 77.6 | 98.2 | 85.6 | 12.6 |

TABLE 56
Control effects of A1 or rimsulfuron alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 1.875 | 80:1 | 76.3 | 5.5 | 87.8 | 77.6 | 10.2 |
| 150 + 3.75 | 40:1 | 76.3 | 25.3 | 94.6 | 82.3 | 12.3 |
| 75 + 7.5 | 10:1 | 55.2 | 37.9 | 87.8 | 72.2 | 15.6 |
| 75 + 15 | 5:1 | 55.2 | 65.8 | 97.6 | 84.7 | 12.9 |

TABLE 57
Control effects of A1 or imazethapyr alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 76.3 | 4.2 | 87.8 | 77.3 | 10.5 |
| 150 + 15 | 10:1 | 76.3 | 18.1 | 94.3 | 80.6 | 13.7 |
| 75 + 30 | 5:2 | 55.2 | 34.8 | 85.6 | 70.8 | 14.8 |
| 75 + 60 | 5:4 | 55.2 | 55.6 | 93.7 | 80.1 | 13.6 |

TABLE 58
Control effects of A1 or imazapic alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 9.375 | 16:1 | 76.3 | 6.8 | 89.9 | 77.9 | 12.0 |
| 150 + 18.75 | 8:1 | 76.3 | 21.5 | 92.8 | 81.4 | 11.4 |
| 75 + 37.5 | 2:1 | 55.2 | 28.6 | 81.2 | 68.0 | 13.2 |
| 75 + 75 | 1:1 | 55.2 | 55.6 | 93.4 | 80.1 | 13.3 |

TABLE 59
Control effects of A1 or imazamox alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 3.75 | 40:1 | 76.3 | 7.6 | 90.2 | 78.1 | 12.1 |
| 150 + 7.5 | 20:1 | 76.3 | 16.5 | 93.4 | 80.2 | 13.2 |
| 75 + 15 | 5:1 | 55.2 | 24.8 | 81.8 | 66.3 | 15.5 |
| 75 + 30 | 5:2 | 55.2 | 53.8 | 92.1 | 79.3 | 12.8 |

TABLE 60
Control effects of A1 or sulfometuron-methyl alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 9.375 | 16:1 | 76.3 | 3.8 | 87.3 | 77.2 | 10.1 |
| 150 + 18.75 | 8:1 | 76.3 | 13.9 | 95.5 | 79.6 | 15.9 |
| 75 + 37.5 | 2:1 | 55.2 | 24.6 | 79.6 | 66.2 | 13.4 |
| 75 + 75 | 1:1 | 55.2 | 52.7 | 91.6 | 78.8 | 12.8 |

TABLE 61
Control effects of A1 or cloransulam-methyl alone and of a combination
thereof on Sonchus arvensis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 60 + 1.875 | 32:1 | 70.7 | 6.5 | 84.1 | 72.6 | 11.5 |
| 60 + 3.75 | 16:1 | 70.7 | 15.0 | 89.6 | 75.1 | 14.5 |
| 30 + 7.5 | 4:1 | 33.3 | 52.8 | 82.2 | 68.5 | 13.7 |
| 30 + 15 | 2:1 | 33.3 | 72.9 | 93.8 | 81.9 | 11.9 |

TABLE 62
Control effects of A1 or cyhalofop-butyl alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 9.375 | 16:1 | 76.3 | 5.9 | 87.9 | 77.7 | 10.2 |
| 150 + 18.75 | 8:1 | 76.3 | 11.4 | 89.6 | 79.0 | 10.6 |
| 75 + 37.5 | 2:1 | 55.2 | 29.9 | 81.4 | 68.6 | 12.8 |
| 75 + 75 | 1:1 | 55.2 | 69.6 | 97.6 | 86.4 | 11.2 |

TABLE 63
Control effects of A1 or clodinafop-propargyl alone and of a combination
thereof on Alopecurus japonicus

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 3.75 | 40:1 | 48.1 | 3.0 | 61.4 | 49.7 | 11.8 |
| 150 + 7.5 | 20:1 | 48.1 | 10.6 | 69.0 | 53.6 | 15.4 |
| 75 + 15 | 5:1 | 25.6 | 57.8 | 83.8 | 68.6 | 15.2 |
| 75 + 30 | 5:2 | 25.6 | 79.9 | 98.8 | 85.1 | 13.8 |

TABLE 64
Control effects of A1 or pinoxaden alone and of a combination
thereof on Alopecurus japonicus

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 3.75 | 40:1 | 48.1 | 2.5 | 61.3 | 49.4 | 11.9 |
| 150 + 7.5 | 20:1 | 48.1 | 12.1 | 68.6 | 54.4 | 14.2 |
| 75 + 15 | 5:1 | 25.6 | 41.7 | 72.7 | 56.6 | 16.1 |
| 75 + 30 | 5:2 | 25.6 | 71.8 | 92.5 | 79.0 | 13.5 |

TABLE 65
Control effects of A1 or clethodim alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 76.3 | 3.4 | 87.3 | 77.1 | 10.2 |
| 150 + 15 | 10:1 | 76.3 | 27.0 | 93.6 | 82.7 | 10.9 |
| 75 + 30 | 5:2 | 55.2 | 43.8 | 87.4 | 74.8 | 12.6 |
| 75 + 60 | 5:4 | 55.2 | 67.4 | 98.1 | 85.4 | 12.7 |

TABLE 66
Control effects of A1 or sethoxydim alone and of a combination
thereof on Echinochloa caudate

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 15 | 10:1 | 76.3 | 5.1 | 88.6 | 77.5 | 11.1 |
| 150 + 30 | 5:1 | 76.3 | 21.5 | 93.8 | 81.4 | 12.4 |
| 75 + 60 | 5:4 | 55.2 | 42.6 | 88.2 | 74.3 | 13.9 |
| 75 + 120 | 5:8 | 55.2 | 61.6 | 97.2 | 82.8 | 14.4 |

TABLE 67
Control effects of A1 or quizalofop-P-methyl alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 3.75 | 40:1 | 76.3 | 3.4 | 88.7 | 77.1 | 11.6 |
| 150 + 7.5 | 20:1 | 76.3 | 12.2 | 93.2 | 79.2 | 14.0 |
| 75 + 15 | 5:1 | 55.2 | 40.8 | 89.2 | 73.5 | 15.7 |
| 75 + 30 | 5:2 | 55.2 | 72.1 | 99.6 | 87.5 | 12.1 |

TABLE 68
Control effects of A1 or fluazifop-P-butyl alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 3.75 | 40:1 | 76.3 | 4.2 | 88.9 | 77.3 | 11.6 |
| 150 + 7.5 | 20:1 | 76.3 | 13.9 | 92.3 | 79.6 | 12.7 |
| 75 + 15 | 5:1 | 55.2 | 38.4 | 87.2 | 72.4 | 14.8 |
| 75 + 30 | 5:2 | 55.2 | 74.1 | 98.6 | 88.4 | 10.2 |

TABLE 69
Control effects of A1 or haloxyfop-P-methyl alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 3.75 | 40:1 | 76.3 | 3.0 | 87.2 | 77.0 | 10.2 |
| 150 + 7.5 | 20:1 | 76.3 | 15.6 | 92.1 | 80.0 | 12.1 |
| 75 + 15 | 5:1 | 55.2 | 40.2 | 86.2 | 73.2 | 13.0 |
| 75 + 30 | 5:2 | 55.2 | 73.4 | 98.8 | 88.1 | 10.7 |

TABLE 70
Control effects of A1 or atrazine alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 75 | 2:1 | 76.3 | 3.8 | 89.5 | 77.2 | 12.3 |
| 150 + 150 | 1:1 | 76.3 | 13.5 | 90.4 | 79.5 | 10.9 |
| 75 + 300 | 1:4 | 55.2 | 24.8 | 78.6 | 66.3 | 12.3 |
| 75 + 600 | 1:8 | 55.2 | 66.5 | 95.7 | 85.0 | 10.7 |

TABLE 71
Control effects of A1 or isoproturon alone and of
a combination thereof on Alopecurus japonicus

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 75 | 2:1 | 48.1 | 2.5 | 62.3 | 49.4 | 12.9 |
| 150 + 150 | 1:1 | 48.1 | 11.4 | 67.2 | 54.0 | 13.2 |
| 75 + 300 | 1:4 | 25.6 | 56.5 | 82.2 | 67.6 | 14.6 |
| 75 + 600 | 1:8 | 25.6 | 75.9 | 96.1 | 82.1 | 14.0 |

TABLE 72
Control effects of A1 or chlorotoluron alone and of
a combination thereof on Alopecurus japonicus

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 75 | 2:1 | 48.1 | 2.9 | 60.5 | 49.6 | 10.9 |
| 150 + 150 | 1:1 | 48.1 | 13.1 | 66.7 | 54.9 | 11.8 |
| 75 + 300 | 1:4 | 25.6 | 39.8 | 69.6 | 55.2 | 14.3 |
| 75 + 600 | 1:8 | 25.6 | 71.9 | 91.9 | 79.1 | 12.7 |

TABLE 73
Control effects of A1 or diuron alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 75 | 2:1 | 76.3 | 3.0 | 87.9 | 77.0 | 10.9 |
| 150 + 150 | 1:1 | 76.3 | 16.5 | 93.3 | 80.2 | 13.1 |
| 75 + 300 | 1:4 | 55.2 | 28.6 | 79.2 | 68.0 | 11.2 |
| 75 + 600 | 1:8 | 55.2 | 52.2 | 90.9 | 78.6 | 12.3 |

TABLE 74
Control effects of A1 or bentazone alone and of
a combination thereof on Abutilon theophrasti

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 15 + 18.75 | 4:5 | 79.6 | 5.9 | 91.7 | 80.8 | 10.9 |
| 15 + 37.5 | 2:5 | 79.6 | 11.8 | 94.1 | 82.0 | 12.1 |
| 7.5 + 75 | 1:10 | 44.3 | 49.0 | 85.2 | 71.6 | 13.6 |
| 7.5 + 150 | 1:20 | 44.3 | 69.1 | 94.7 | 82.8 | 11.9 |

TABLE 75
Control effects of A1 or bromoxynil alone and of
a combination thereof on Chenopodium album

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 15 + 18.75 | 8:1 | 55.6 | 3.1 | 67.5 | 57.0 | 10.5 |
| 15 + 37.5 | 4:1 | 55.6 | 10.8 | 72.1 | 60.4 | 11.7 |
| 7.5 + 75 | 1:1 | 23.1 | 57.7 | 81.5 | 67.5 | 14.0 |
| 7.5 + 150 | 1:2 | 23.1 | 83.6 | 99.7 | 87.4 | 12.3 |

TABLE 76
Control effects of A1 or propanil alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 75 | 2:1 | 76.3 | 3.8 | 88.8 | 77.2 | 11.6 |
| 150 + 150 | 1:1 | 76.3 | 21.1 | 94.4 | 81.3 | 13.1 |
| 75 + 300 | 1:4 | 55.2 | 36.4 | 82.3 | 71.5 | 10.8 |
| 75 + 600 | 1:8 | 55.2 | 52.5 | 90.4 | 78.7 | 11.7 |

TABLE 77
Control effects of A1 or cypyrafluone alone and of
a combination thereof on Alopecurus japonicus

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 15 + 18.75 | 8:1 | 48.1 | 4.0 | 62.5 | 50.2 | 12.3 |
| 15 + 37.5 | 4:1 | 48.1 | 24.9 | 75.5 | 61.0 | 14.5 |
| 7.5 + 75 | 1:1 | 25.6 | 54.8 | 79.7 | 66.4 | 13.3 |
| 7.5 + 150 | 1:2 | 25.6 | 81.3 | 98.1 | 86.1 | 12.0 |

TABLE 78
Control effects of A1 or bipyrazone alone and of
a combination thereof on Capsella bursa-pastoris

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 15 + 18.75 | 16:1 | 75.9 | 2.9 | 88.1 | 76.6 | 11.5 |
| 15 + 37.5 | 8:1 | 75.9 | 12.9 | 93.2 | 79.0 | 14.2 |
| 7.5 + 75 | 2:1 | 36.2 | 51.1 | 82.4 | 68.8 | 13.6 |
| 7.5 + 150 | 1:1 | 36.2 | 80.3 | 98.1 | 87.4 | 10.7 |

TABLE 79
Control effects of A1 or fenpyrazone alone and of
a combination thereof on Eleusine indica

| | | Control | Control | | | |
|---|---|---|---|---|---|---|
| | | effect | effcect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 7.5 | 20:1 | 52.2 | 2.9 | 64.6 | 53.6 | 11.0 |
| 150 + 15 | 10:1 | 52.2 | 10.9 | 73.6 | 57.4 | 16.2 |
| 75 + 30 | 5:2 | 24.4 | 38.6 | 67.5 | 53.6 | 13.9 |
| 75 + 60 | 5:4 | 24.4 | 79.1 | 95.6 | 84.2 | 11.4 |

TABLE 80
Control effects of A1 or tripyrasulfone alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 15 + 18.75 | 8:1 | 76.3 | 4.6 | 88.4 | 77.4 | 11.0 |
| 15 + 37.5 | 4:1 | 76.3 | 16.0 | 94.7 | 80.1 | 14.6 |
| 7.5 + 75 | 1:1 | 55.2 | 42.6 | 88.2 | 74.3 | 13.9 |
| 7.5 + 150 | 1:2 | 55.2 | 74.3 | 98.6 | 88.5 | 10.1 |

TABLE 81
Control effects of A1 or tefulyltrione alone and of
a combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 7.5 | 20:1 | 76.3 | 6.8 | 89.7 | 77.9 | 11.8 |
| 150 + 15 | 10:1 | 76.3 | 13.1 | 91.4 | 79.4 | 12.0 |
| 75 + 30 | 5:2 | 55.2 | 41.3 | 86.8 | 73.7 | 13.1 |
| 75 + 60 | 5:4 | 55.2 | 65.4 | 96.6 | 84.5 | 12.1 |

TABLE 82
Control effects of A1 or mesotrione alone and of a combination thereof on Eleusine indica

| | | Control effect | Control effect | | | |
|---|---|---|---|---|---|---|
| | | (%) of A applied | (%) of B applied | | | |
| | | alone in | alone in | Control | | |
| A + B dose | | corresponding | corresponding | effect of A + | | |
| (g a.i./ha) | A:B | dose | dose | B (%), E | E0 (%) | E-E0 (%) |
| 150 + 15 | 10:1 | 52.2 | 4.0 | 64.8 | 54.1 | 10.7 |
| 150 + 30 | 5:1 | 52.2 | 10.9 | 71.1 | 57.4 | 13.7 |
| 75 + 60 | 5:4 | 24.4 | 36.9 | 65.0 | 52.3 | 12.7 |
| 75 + 120 | 5:8 | 24.4 | 75.0 | 93.5 | 81.1 | 12.4 |

TABLE 83
Control effects of A1 or tembotrione alone and of a combination thereof on Eleusine indica

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 3.75 | 40:1 | 52.2 | 5.4 | 65.8 | 54.8 | 11.0 |
| 150 + 7.5 | 20:1 | 52.2 | 12.3 | 73.1 | 58.1 | 15.0 |
| 75 + 15 | 5:1 | 24.4 | 39.7 | 68.8 | 54.4 | 14.4 |
| 75 + 30 | 5:2 | 24.4 | 73.1 | 91.5 | 79.7 | 11.8 |

TABLE 84
Control effects of A1 or topramezone alone and of a combination thereof on Setaria glauca

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 60 + 1.875 | 32:1 | 57.6 | 7.3 | 72.5 | 60.7 | 11.8 |
| 60 + 3.75 | 16:1 | 57.6 | 10.6 | 76.3 | 62.1 | 14.2 |
| 30 + 7.5 | 4:1 | 34.7 | 35.8 | 71.1 | 58.1 | 13.0 |
| 30 + 15 | 2:1 | 34.7 | 72.3 | 94.3 | 81.9 | 12.4 |

TABLE 85
Control effects of A1 or isoxaflutole alone and of a combination thereof on Echinochloa caudate

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 76.3 | 2.1 | 89.8 | 76.8 | 13.0 |
| 150 + 15 | 10:1 | 76.3 | 14.3 | 94.7 | 79.7 | 15.0 |
| 75 + 30 | 5:2 | 55.2 | 47.9 | 89.4 | 76.7 | 12.7 |
| 75 + 60 | 5:4 | 55.2 | 63.6 | 94.7 | 83.7 | 11.0 |

TABLE 86
Control effects of A1 or benzobicylon alone and of a combination thereof on Echinochloa caudate

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 37.5 | 4:1 | 76.3 | 2.1 | 90.5 | 76.8 | 13.7 |
| 150 + 75 | 2:1 | 76.3 | 11.7 | 92.0 | 79.1 | 12.9 |
| 75 + 150 | 1:2 | 55.2 | 43.3 | 86.6 | 74.6 | 12.0 |
| 75 + 300 | 1:4 | 55.2 | 54.4 | 91.5 | 79.6 | 12.0 |

TABLE 87
Control effects of A1 or diflufenican alone and of a combination thereof on Veronica persica²

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 15 | 10:1 | 42.4 | 2.3 | 55.7 | 43.7 | 12.0 |
| 150 + 30 | 5:1 | 42.4 | 10.2 | 63.3 | 48.3 | 15.0 |
| 75 + 60 | 5:4 | 19.6 | 40.3 | 66.3 | 52.0 | 14.3 |
| 75 + 120 | 5:8 | 19.6 | 76.2 | 93.8 | 80.9 | 12.9 |

TABLE 88
Control effects of A1 or flurochloridone alone and of a combination thereof on Veronica persica²

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 75 | 2:1 | 42.4 | 2.1 | 56.4 | 43.6 | 12.8 |
| 150 + 150 | 1:1 | 42.4 | 12.3 | 63.4 | 49.5 | 13.9 |
| 75 + 300 | 1:4 | 19.6 | 44.5 | 71.7 | 55.4 | 16.3 |
| 75 + 600 | 1:8 | 19.6 | 79.6 | 97.7 | 83.6 | 14.1 |

TABLE 89
Control effects of A1 or clomazone alone and of a combination thereof on Echinochloa caudate

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 45 | 10:3 | 76.3 | 8.6 | 89.6 | 78.3 | 11.3 |
| 150 + 90 | 5:3 | 76.3 | 19.0 | 93.5 | 80.8 | 12.7 |
| 75 + 180 | 5:12 | 55.2 | 47.7 | 89.1 | 76.6 | 12.5 |
| 75 + 360 | 5:24 | 55.2 | 70.1 | 99.8 | 86.6 | 13.2 |

TABLE 90
Control effects of A1 or carfentrazone-ethyl alone and of a combination thereof on Veronica persica²

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 1.875 | 80:1 | 42.4 | 2.6 | 56.3 | 43.9 | 12.4 |
| 150 + 3.75 | 40:1 | 42.4 | 11.6 | 62.4 | 49.1 | 13.3 |
| 75 + 7.5 | 10:1 | 19.6 | 36.2 | 62.9 | 48.7 | 14.2 |
| 75 + 15 | 5:1 | 19.6 | 68.2 | 87.6 | 74.4 | 13.2 |

TABLE 91
Control effects of A1 or fomesafen alone and of a combination thereof on Chenopodium album

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 22.5 | 20:3 | 55.6 | 2.7 | 67.0 | 56.8 | 10.2 |
| 150 + 45 | 10:3 | 55.6 | 18.6 | 77.5 | 63.9 | 13.6 |
| 75 + 90 | 5:6 | 23.1 | 45.4 | 73.0 | 58.0 | 15.0 |
| 75 + 180 | 5:12 | 23.1 | 81.9 | 98.8 | 86.1 | 12.7 |

TABLE 92
Control effects of A1 or fluoroglycofen alone and of a combination thereof on Chenopodium album

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 0.9375 | 160:1 | 55.6 | 2.3 | 68.7 | 56.6 | 12.1 |
| 150 + 1.875 | 80:1 | 55.6 | 12.8 | 73.4 | 61.3 | 12.1 |
| 75 + 3.75 | 20:1 | 23.1 | 40.0 | 67.9 | 53.9 | 14.0 |
| 75 + 7.5 | 10:1 | 23.1 | 70.6 | 90.3 | 77.4 | 12.9 |

TABLE 93
Control effects of A1 or oxyfluorfen alone and of a combination thereof on Chenopodium album

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 55.6 | 3.6 | 67.8 | 57.2 | 10.6 |
| 150 + 15 | 10:1 | 55.6 | 11.9 | 71.9 | 60.9 | 11.0 |
| 75 + 30 | 5:2 | 23.1 | 30.7 | 59.9 | 46.7 | 13.2 |
| 75 + 60 | 5:4 | 23.1 | 68.1 | 87.6 | 75.5 | 12.1 |

TABLE 94
Control effects of A1 or lactofen alone and of a combination thereof on Chenopodium album

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 55.6 | 3.3 | 67.8 | 57.1 | 10.7 |
| 150 + 15 | 10:1 | 55.6 | 10.4 | 73.6 | 60.2 | 13.4 |
| 75 + 30 | 5:2 | 23.1 | 39.7 | 66.1 | 53.6 | 12.5 |
| 75 + 60 | 5:4 | 23.1 | 65.4 | 84.3 | 73.4 | 10.9 |

TABLE 95
Control effects of A1 or acifluorfen-sodium alone and of a combination thereof on Chenopodium
album

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 37.5 | 4:1 | 55.6 | 2.0 | 67.8 | 56.5 | 11.3 |
| 150 + 75 | 2:1 | 55.6 | 13.7 | 72.2 | 61.7 | 10.5 |
| 75 + 150 | 1:2 | 23.1 | 45.0 | 71.2 | 57.7 | 13.5 |
| 75 + 300 | 1:4 | 23.1 | 81.0 | 96.0 | 85.4 | 10.6 |

TABLE 96
Control effects of A1 or flumioxazin alone and of a combination thereof on Chenopodium album

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 55.6 | 3.4 | 69.9 | 57.1 | 12.8 |
| 150 + 15 | 10:1 | 55.6 | 12.8 | 74.4 | 61.3 | 13.1 |
| 75 + 30 | 5:2 | 23.1 | 37.3 | 64.2 | 51.8 | 12.4 |
| 75 + 60 | 5:4 | 23.1 | 78.8 | 94.9 | 83.7 | 11.2 |

TABLE 97
Control effects of A1 or sulfentrazone alone and of a
combination thereof on Echinochloa caudate

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 1.875 | 80:1 | 76.3 | 6.6 | 89.2 | 77.9 | 11.4 |
| 150 + 3.75 | 40:1 | 76.3 | 10.8 | 92.6 | 78.9 | 13.8 |
| 75 + 7.5 | 10:1 | 55.2 | 24.5 | 79.1 | 66.2 | 12.9 |
| 75 + 15 | 5:1 | 55.2 | 52.6 | 90.4 | 78.8 | 11.6 |

TABLE 98
Control effects of A1 or saflufenacil alone and of
a combination thereof on Ipomoea purpurea

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 3.75 | 40:1 | 59.5 | 7.9 | 74.0 | 62.7 | 11.3 |
| 75 + 7.5 | 20:1 | 59.5 | 16.0 | 78.1 | 66.0 | 12.1 |
| 75 + 15 | 5:1 | 37.7 | 41.3 | 76.9 | 63.4 | 13.5 |
| 75 + 30 | 5:2 | 37.7 | 75.9 | 97.8 | 85.0 | 12.8 |

TABLE 99
Control effects of A1 or oxadiazon alone and of a combination
thereof on Echinochloa caudate (soil sealing treatment)

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 37.5 | 4:1 | 47.2 | 6.0 | 62.2 | 50.4 | 11.9 |
| 150 + 75 | 2:1 | 47.2 | 22.1 | 71.4 | 58.9 | 12.6 |
| 75 + 150 | 1:2 | 23.4 | 39.5 | 66.6 | 53.7 | 12.9 |
| 75 + 300 | 1:4 | 23.4 | 63.0 | 85.4 | 71.7 | 13.7 |

TABLE 100
Control effects of A1 or oxadiargyl alone and of a combination
thereof on Echinochloa caudate (soil sealing treatment)

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 7.5 | 20:1 | 47.2 | 1.7 | 58.7 | 48.1 | 10.6 |
| 150 + 15 | 10:1 | 47.2 | 10.8 | 63.3 | 52.9 | 10.4 |
| 75 + 30 | 5:2 | 23.4 | 37.2 | 64.4 | 51.9 | 12.5 |
| 75 + 60 | 5:4 | 23.4 | 62.5 | 83.0 | 71.3 | 11.7 |

TABLE 101
Control effects of A4 or penoxsulam alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 1.875 | 80:1 | 74.7 | 4.7 | 86.6 | 75.9 | 10.7 |
| 150 + 3.75 | 40:1 | 74.7 | 13.8 | 90.2 | 78.2 | 12.0 |
| 75 + 7.5 | 10:1 | 52.6 | 47.9 | 87.8 | 75.3 | 12.5 |
| 75 + 15 | 5:1 | 52.6 | 68.4 | 98.7 | 85.0 | 13.7 |

TABLE 102
Control effects of A4 or bispyribac-sodium alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 1.875 | 80:1 | 74.7 | 4.7 | 87.4 | 75.9 | 11.5 |
| 150 + 3.75 | 40:1 | 74.7 | 18.2 | 91.3 | 79.3 | 12.0 |
| 75 + 7.5 | 10:1 | 52.6 | 44.1 | 85.2 | 73.5 | 11.7 |
| 75 + 15 | 5:1 | 52.6 | 62.0 | 94.3 | 82.0 | 12.3 |

TABLE 103
Control effects of A3 orpyrazosulfuron-ethyl alone and
of a combination thereof on Ammannia arenaria

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 1.875 | 80:1 | 66.2 | 16.3 | 82.7 | 71.7 | 11.0 |
| 150 + 3.75 | 40:1 | 66.2 | 26.1 | 86.4 | 75.0 | 11.4 |
| 75 + 7.5 | 10:1 | 30.4 | 52.8 | 79.6 | 67.1 | 12.5 |
| 75 + 15 | 5:1 | 30.4 | 77.2 | 95.4 | 84.1 | 11.3 |

TABLE 104
Control effects of A4 or nicosulfuron alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 3.75 | 40:1 | 74.7 | 9.9 | 88.4 | 77.2 | 11.2 |
| 150 + 7.5 | 20:1 | 74.7 | 18.2 | 91.8 | 79.3 | 12.5 |
| 75 + 15 | 5:1 | 52.6 | 40.5 | 86.2 | 71.8 | 14.4 |
| 75 + 30 | 5:2 | 52.6 | 62.4 | 94.3 | 82.2 | 12.1 |

TABLE 105
Control effects of A3 or florasulam alone and of
a combination thereof on Stellaria media

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 15 + 0.375 | 40:1 | 67.9 | 6.8 | 82.3 | 70.1 | 12.3 |
| 15 + 0.75 | 20:1 | 67.9 | 22.3 | 87.9 | 75.1 | 12.9 |
| 7.5 + 1.5 | 5:1 | 34.1 | 56.9 | 86.1 | 71.6 | 14.6 |
| 7.5 + 3.0 | 5:2 | 34.1 | 76.6 | 97.9 | 84.6 | 13.4 |

TABLE 106
Control effects of A4 or rimsulfuron alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 1.875 | 80:1 | 74.7 | 10.3 | 88.3 | 77.3 | 11.0 |
| 150 + 3.75 | 40:1 | 74.7 | 26.9 | 93.7 | 81.5 | 12.2 |
| 75 + 7.5 | 10:1 | 52.6 | 43.7 | 88.0 | 73.3 | 14.7 |
| 75 + 15 | 5:1 | 52.6 | 69.6 | 98.1 | 85.6 | 12.5 |

TABLE 107
Control effects of A4 or imazethapyr alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 7.5 | 20:1 | 74.7 | 6.7 | 86.8 | 76.4 | 10.4 |
| 150 + 15 | 10:1 | 74.7 | 17.8 | 92.7 | 79.2 | 13.5 |
| 75 + 30 | 5:2 | 52.6 | 34.6 | 83.1 | 69.0 | 14.1 |
| 75 + 60 | 5:4 | 52.6 | 58.2 | 93.0 | 80.2 | 12.8 |

TABLE 108
Control effects of A4 or imazapic alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 9.375 | 16:1 | 74.7 | 4.0 | 87.0 | 75.7 | 11.3 |
| 150 + 18.75 | 8:1 | 74.7 | 21.3 | 92.1 | 80.1 | 12.0 |
| 75 + 37.5 | 2:1 | 52.6 | 30.4 | 82.4 | 67.0 | 15.4 |
| 75 + 75 | 1:1 | 52.6 | 59.7 | 93.4 | 80.9 | 12.5 |

TABLE 109
Control effects of A4 or imazamox alone and of
a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 3.75 | 40:1 | 74.7 | 4.0 | 88.4 | 75.7 | 12.7 |
| 150 + 7.5 | 20:1 | 74.7 | 12.6 | 90.4 | 77.9 | 12.5 |
| 75 + 15 | 5:1 | 52.6 | 27.6 | 80.1 | 65.7 | 14.4 |
| 75 + 30 | 5:2 | 52.6 | 54.4 | 91.2 | 78.4 | 12.8 |

TABLE 110
Control effects of A4 or sulfometuron-methyl alone and
of a combination thereof on Echinochloa oryzoides

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 150 + 9.375 | 16:1 | 74.7 | 3.2 | 85.9 | 75.5 | 10.4 |
| 150 + 18.75 | 8:1 | 74.7 | 12.6 | 92.7 | 77.9 | 14.8 |
| 75 + 37.5 | 2:1 | 52.6 | 38.0 | 84.1 | 70.6 | 13.5 |
| 75 + 75 | 1:1 | 52.6 | 53.8 | 90.8 | 78.1 | 12.7 |

TABLE 111
Control effects of A3 or cloransulam-methyl alone and
of a combination thereof on Cirsium setosum

| | | Control | Control | | | |
|---|---|---|---|---|---|---|
| | | effect | effect | | | |
| | | (%) of A | (%) of B | Control | | |
| | | applied | applied | effect | | |
| A + B | | alone in | alone in | of | | |
| dose | | correspon- | correspon- | A + B | E0 | E-E0 |
| (g a.i./ha) | A:B | ding dose | ding dose | (%), E | (%) | (%) |
| 60 + 1.875 | 32:1 | 64.3 | 13.6 | 80.8 | 69.1 | 11.6 |
| 60 + 3.75 | 16:1 | 64.3 | 23.1 | 86.5 | 72.5 | 13.9 |
| 30 + 7.5 | 4:1 | 31.5 | 53.8 | 81.9 | 68.3 | 13.5 |
| 30 + 15 | 2:1 | 31.5 | 71.9 | 93.0 | 80.7 | 12.2 |

TABLE 112
Control effects of A4 or cyhalofop-butyl alone and of a
combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 9.375 | 16:1 | 74.7 | 5.5 | 87.5 | 76.1 | 11.4 |
| 150 + 18.75 | 8:1 | 74.7 | 15.0 | 89.7 | 78.5 | 11.2 |
| 75 + 37.5 | 2:1 | 52.6 | 32.1 | 81.5 | 67.8 | 13.7 |
| 75 + 75 | 1:1 | 52.6 | 63.5 | 97.9 | 82.7 | 15.2 |

TABLE 113
Control effects of A3 or clodinafop-propargyl alone and of a
combination thereof on Beckmannia syzigachne

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 3.75 | 40:1 | 42.8 | 10.3 | 60.7 | 48.7 | 12.0 |
| 150 + 7.5 | 20:1 | 42.8 | 20.1 | 67.8 | 54.3 | 13.5 |
| 75 + 15 | 5:1 | 23.0 | 59.6 | 83.0 | 68.9 | 14.1 |
| 75 + 30 | 5:2 | 23.0 | 81.2 | 97.9 | 85.5 | 12.4 |

TABLE 114
Control effects of A3 or pinoxaden alone and of a
combination thereof on Beckmannia syzigachne

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 3.75 | 40:1 | 42.8 | 7.9 | 58.4 | 47.3 | 11.1 |
| 150 + 7.5 | 20:1 | 42.8 | 18.0 | 66.9 | 53.1 | 13.8 |
| 75 + 15 | 5:1 | 23.0 | 43.5 | 71.5 | 56.5 | 15.0 |
| 75 + 30 | 5:2 | 23.0 | 72.6 | 91.7 | 78.9 | 12.8 |

TABLE 115
Control effects of A4 or clethodim alone and of a combination
thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 7.5 | 20:1 | 74.7 | 6.7 | 88.0 | 76.4 | 11.6 |
| 150 + 15 | 10:1 | 74.7 | 19.0 | 92.4 | 79.5 | 12.9 |
| 75 + 30 | 5:2 | 52.6 | 37.8 | 85.6 | 70.5 | 15.1 |
| 75 + 60 | 5:4 | 52.6 | 62.7 | 96.0 | 82.3 | 13.7 |

TABLE 116
Control effects of A4 or sethoxydim alone and of a combination
thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 15 | 10:1 | 74.7 | 5.5 | 87.8 | 76.1 | 11.7 |
| 150 + 30 | 5:1 | 74.7 | 13.8 | 93.0 | 78.2 | 14.8 |
| 75 + 60 | 5:4 | 52.6 | 35.4 | 87.7 | 69.4 | 18.3 |
| 75 + 120 | 5:8 | 52.6 | 68.4 | 97.4 | 85.0 | 12.4 |

TABLE 117
Control effects of A4 or quizalofop-P-methyl alone and of a
combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 3.75 | 40:1 | 74.7 | 5.9 | 86.3 | 76.2 | 10.1 |
| 150 + 7.5 | 20:1 | 74.7 | 14.6 | 88.7 | 78.4 | 10.3 |
| 75 + 15 | 5:1 | 52.6 | 38.6 | 86.2 | 70.9 | 15.3 |
| 75 + 30 | 5:2 | 52.6 | 63.3 | 95.4 | 82.6 | 12.8 |

TABLE 118
Control eftects of A4 or fluazifop-P-butyl alone and of a combination
thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 3.75 | 40:1 | 74.7 | 5.5 | 87.6 | 76.1 | 11.5 |
| 150 + 7.5 | 20:1 | 74.7 | 14.2 | 90.3 | 78.3 | 12.0 |
| 75 + 15 | 5:1 | 52.6 | 32.9 | 85.0 | 68.2 | 16.8 |
| 75 + 30 | 5:2 | 52.6 | 71.5 | 97.1 | 86.5 | 10.6 |

TABLE 119
Control effects of A4 or haloxyfop-P-methyl alone and of a combination
thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 3.75 | 40:1 | 74.7 | 7.9 | 88.0 | 76.7 | 11.3 |
| 150 + 7.5 | 20:1 | 74.7 | 19.0 | 92.0 | 79.5 | 12.5 |
| 75 + 15 | 5:1 | 52.6 | 30.4 | 86.1 | 67.0 | 19.1 |
| 75 + 30 | 5:2 | 52.6 | 66.9 | 97.8 | 84.3 | 13.5 |

TABLE 120
Control effects of A4 or atrazine alone and of a combination
thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 74.7 | 6.7 | 87.4 | 76.4 | 11.0 |
| 150 + 150 | 1:1 | 74.7 | 21.7 | 91.3 | 80.2 | 11.1 |
| 75 + 300 | 1:4 | 52.6 | 26.4 | 75.4 | 65.1 | 10.3 |
| 75 + 600 | 1:8 | 52.6 | 61.8 | 92.7 | 81.9 | 10.8 |

TABLE 121
Control effects of A3 or isoproturon alone and of a combination
thereof on Beckmannia syzigachne

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 42.8 | 7.0 | 59.0 | 46.8 | 12.2 |
| 150 + 150 | 1:1 | 42.8 | 15.9 | 64.3 | 51.9 | 12.4 |
| 75 + 300 | 1:4 | 23.0 | 57.6 | 81.5 | 67.3 | 14.2 |
| 75 + 600 | 1:8 | 23.0 | 76.6 | 94.9 | 82.0 | 12.9 |

TABLE 122
Control effects of A3 or chlorotoluron alone and of a
combination thereof on Beckmannia syzigachne

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 42.8 | 5.5 | 56.1 | 45.9 | 10.2 |
| 150 + 150 | 1:1 | 42.8 | 16.8 | 63.5 | 52.4 | 11.1 |
| 75 + 300 | 1:4 | 23.0 | 41.1 | 68.1 | 54.6 | 13.5 |
| 75 + 600 | 1:8 | 23.0 | 72.1 | 90.8 | 78.5 | 12.3 |

TABLE 123
Control effects of A4 or diuron alone and of a
combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 74.7 | 4.1 | 86.3 | 75.7 | 10.6 |
| 150 + 150 | 1:1 | 74.7 | 14.0 | 90.8 | 78.2 | 12.6 |
| 75 + 300 | 1:4 | 52.6 | 31.3 | 78.7 | 67.4 | 11.3 |
| 75 + 600 | 1:8 | 52.6 | 56.2 | 91.1 | 79.2 | 11.9 |

TABLE 124
Control effects of A3 or bentazone alone and of a combination
thereof on Xanthium strumarium

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 15 + 18.75 | 4:5 | 77.2 | 10.9 | 91.4 | 79.7 | 11.7 |
| 15 + 37.5 | 2:5 | 77.2 | 16.1 | 93.4 | 80.9 | 12.5 |
| 7.5 + 75 | 1:10 | 40.8 | 46.6 | 82.5 | 68.4 | 14.1 |
| 7.5 + 150 | 1:20 | 40.8 | 76.5 | 98.9 | 86.1 | 12.8 |

TABLE 125
Control effects of A3 or bromoxynil alone and of a combination
thereof on Acalypha australis

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 18.75 | 8:1 | 51.6 | 4.6 | 64.5 | 53.8 | 10.6 |
| 150 + 37.5 | 4:1 | 51.6 | 10.6 | 68.4 | 56.7 | 11.6 |
| 75 + 75 | 1:1 | 20.7 | 58.9 | 81.5 | 67.4 | 14.0 |
| 75 + 150 | 1:2 | 20.7 | 84.0 | 99.9 | 87.3 | 12.5 |

TABLE 126
Control effects of A4 or propanil alone and of a combination
thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E − E0 (%) |
| 150 + 75 | 2:1 | 74.7 | 7.6 | 88.5 | 76.6 | 11.9 |
| 150 + 150 | 1:1 | 74.7 | 19.9 | 93.0 | 79.7 | 13.3 |
| 75 + 300 | 1:4 | 52.6 | 37.0 | 81.7 | 70.1 | 11.6 |
| 75 + 600 | 1:8 | 52.6 | 53.9 | 89.8 | 78.1 | 11.7 |

TABLE 127
Control effects of A3 or cypyrafluone alone and of a
combination thereof on Beckmannia syzigachne

| | | | Control effect | | | |
|---|---|---|---|---|---|---|
| | | Control effect | (%) of B | | | |
| | | (%) of A applied | applied alone | | | |
| | | alone in | in | Control effect | | |
| A + B dose | | corresponding | corresponding | of A + B | | |
| (g a.i./ha) | A:B | dose | dose | (%), E | E0 (%) | E-E0 (%) |
| 150 + 18.75 | 8:1 | 42.8 | 9.0 | 59.8 | 47.9 | 11.9 |
| 150 + 37.5 | 4:1 | 42.8 | 14.2 | 64.3 | 50.9 | 13.4 |
| 75 + 75 | 1:1 | 23.0 | 56.3 | 78.9 | 66.3 | 12.6 |
| 75 + 150 | 1:2 | 23.0 | 81.8 | 97.2 | 86.0 | 11.2 |

TABLE 128
Control effects of A3 or bipyrazone alone and of a combination
thereof on Sinapis arvensis

| | | Control effect | | | | |
|---|---|---|---|---|---|---|
| | | (%) of A | | | | |
| | | applied alone | Control effect (%) | | | |
| | | in | of B applied alone | | | |
| A + B dose | | corresponding | in corresponding | Control effect | | |
| (g a.i./ha) | A:B | dose | dose | of A + B (%), E | E0 (%) | E-E0 (%) |
| 30 + 1.875 | 16:1 | 72.7 | 9.9 | 87.0 | 75.4 | 11.6 |
| 30 + 3.75 | 8:1 | 72.7 | 23.8 | 93.2 | 79.2 | 14.0 |
| 15 + 7.5 | 2:1 | 33.2 | 50.8 | 80.7 | 67.1 | 13.6 |
| 15 + 15 | 1:1 | 33.2 | 83.7 | 99.8 | 89.1 | 10.7 |

TABLE 129
Control effects of A3 or fenpyrazone alone and of a combination
thereof on Chloris virgata

| | | Control effect | Control effect | | | |
|---|---|---|---|---|---|---|
| | | (%) of A applied | (%) of B applied | | | |
| | | alone in | alone in | | | |
| A + B dose | | corresponding | corresponding | Control effect of | | |
| (g a.i./ha) | A:B | dose | dose | A + B (%), E | E0 (%) | E-E0 (%) |
| 150 + 7.5 | 20:1 | 48.3 | 5.5 | 62.2 | 51.2 | 11.0 |
| 150 + 15 | 10:1 | 48.3 | 14.8 | 72.1 | 56.0 | 16.1 |
| 75 + 30 | 5:2 | 22.0 | 39.9 | 67.0 | 53.2 | 13.8 |
| 75 + 60 | 5:4 | 22.0 | 79.2 | 95.2 | 83.8 | 11.4 |

TABLE 130
Control effects of A4 or tripyrasulfone alone and
of a combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 18.75 | 8:1 | 74.7 | 8.9 | 87.9 | 77.0 | 11.0 |
| 150 + 37.5 | 4:1 | 74.7 | 18.0 | 94.2 | 79.3 | 15.0 |
| 75 + 75 | 1:1 | 52.6 | 44.6 | 87.6 | 73.8 | 13.9 |
| 75 + 150 | 1:2 | 52.6 | 75.2 | 98.6 | 88.3 | 10.4 |

TABLE 131
Control effects of A4 or tefulyltrione alone and of a
combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 74.7 | 8.9 | 88.9 | 77.0 | 12.0 |
| 150 + 15 | 10:1 | 74.7 | 18.8 | 91.3 | 79.5 | 11.9 |
| 75 + 30 | 5:2 | 52.6 | 46.1 | 86.5 | 74.5 | 12.1 |
| 75 + 60 | 5:4 | 52.6 | 69.3 | 97.3 | 85.5 | 11.9 |

TABLE 132
Control effects of A3 or mesotrione alone and of a
combination thereof on Chloris virgata

| | | Control effect | | | | |
|---|---|---|---|---|---|---|
| | | (%) of A | Control effect | | | |
| | | applied alone | (%) of B applied | | | |
| | | in | alone in | | | |
| A + B dose | | corresponding | corresponding | Control effect of | | |
| (g a.i./ha) | A:B | dose | dose | A + B (%), E | E0 (%) | E-E0 (%) |
| 150 + 15 | 10:1 | 48.3 | 6.5 | 62.4 | 51.7 | 10.7 |
| 150 + 30 | 5:1 | 48.3 | 13.4 | 69.0 | 55.3 | 13.7 |
| 75 + 60 | 5:4 | 22.0 | 38.3 | 64.5 | 51.9 | 12.6 |
| 75 + 120 | 5:8 | 22.0 | 75.2 | 93.0 | 80.7 | 12.3 |

TABLE 133
Control effects of A3 or tembotrione alone and
of a combination thereof on Chloris virgata

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 3.75 | 40:1 | 48.3 | 4.0 | 61.3 | 50.4 | 10.9 |
| 150 + 7.5 | 20:1 | 48.3 | 12.3 | 69.7 | 54.7 | 15.0 |
| 75 + 15 | 5:1 | 22.0 | 41.0 | 68.4 | 54.0 | 14.4 |
| 75 + 30 | 5:2 | 22.0 | 73.4 | 91.0 | 79.3 | 11.7 |

TABLE 134
Control effects of A3 or topramezone alone and
of a combination thereof on Setaria faberi

| | | Control effect | | | | |
|---|---|---|---|---|---|---|
| | | (%) of A | Control effect | | | |
| | | applied alone | (%) of B applied | | | |
| | | in | alone in | Control | | |
| A + B dose | | corresponding | corresponding | effect of A + | | |
| (g a.i./ha) | A:B | dose | dose | B (%), E | E0 ( %) | E-E0 (%) |
| 60 + 1.875 | 32:1 | 55.4 | 3.2 | 69.2 | 56.8 | 12.4 |
| 60 + 3.75 | 16:1 | 55.4 | 11.7 | 74.4 | 60.6 | 13.8 |
| 30 + 7.5 | 4:1 | 32.5 | 36.5 | 71.8 | 57.1 | 14.7 |
| 30 + 15 | 2:1 | 32.5 | 75.4 | 95.0 | 83.4 | 11.6 |

TABLE 135
Control effects of A4 or isoxaflutole alone and
of a combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 7.5 | 20:1 | 74.7 | 8.1 | 89.3 | 76.8 | 12.6 |
| 150 + 15 | 10:1 | 74.7 | 19.6 | 94.2 | 79.7 | 14.6 |
| 75 + 30 | 5:2 | 52.6 | 50.6 | 88.9 | 76.6 | 12.3 |
| 75 + 60 | 5:4 | 52.6 | 65.5 | 94.2 | 83.7 | 10.6 |

TABLE 136
Control effects of A4 or benzobicylon alone and
of a combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 37.5 | 4:1 | 74.7 | 9.3 | 89.9 | 77.1 | 12.9 |
| 150 + 75 | 2:1 | 74.7 | 18.0 | 91.5 | 79.3 | 12.3 |
| 75 + 150 | 1:2 | 52.6 | 46.6 | 86.2 | 74.7 | 11.5 |
| 75 + 300 | 1:4 | 52.6 | 57.3 | 91.0 | 79.8 | 11.3 |

TABLE 137
Control effects of A3 or diflufenican alone and
of a combination thereof on Solanum nigrum

| | | Control effect | Control effect | | | |
|---|---|---|---|---|---|---|
| | | (%) of A | (%) of B | | | |
| | | applied alone | applied alone | | | |
| | | in | in | | | |
| A + B dose | | corresponding | corresponding | Control effect | | |
| (g a.i./ha) | A:B | dose | dose | of A + B (%), E | E0 ( %) | E-E0 (%) |
| 150 + 15 | 10:1 | 37.5 | 6.0 | 52.9 | 41.3 | 11.6 |
| 150 + 30 | 5:1 | 37.5 | 15.0 | 61.5 | 46.9 | 14.6 |
| 75 + 60 | 5:4 | 16.9 | 41.7 | 65.5 | 51.6 | 13.9 |
| 75 + 120 | 5:8 | 16.9 | 76.5 | 93.0 | 80.5 | 12.5 |

TABLE 138
Control effects of A3 or flurochloridone alone and
of a combination thereof on Solanum nigrum

| | | Control effect | Control effect | | | |
|---|---|---|---|---|---|---|
| | | (%) of A | (%) of B | | | |
| | | applied alone | applied alone | | | |
| | | in | in | | | |
| A + B dose | | corresponding | corresponding | Control effect | | |
| (g a.i./ha) | A:B | dose | dose | of A + B (%), E | E0 ( %) | E-E0 (%) |
| 150 + 75 | 2:1 | 37.5 | 5.5 | 53.4 | 41.0 | 12.4 |
| 150 + 150 | 1:1 | 37.5 | 13.7 | 59.6 | 46.1 | 13.5 |
| 75 + 300 | 1:4 | 16.9 | 45.8 | 70.9 | 55.0 | 15.9 |
| 75 + 600 | 1:8 | 16.9 | 79.7 | 96.9 | 83.2 | 13.7 |

TABLE 139
Control effects of A4 or clomazone alone and of a
combination thereof on Echinochloa oryzoides

| | | Control effect | Control effect | | | |
|---|---|---|---|---|---|---|
| | | (%) of A | (%) of B | | | |
| | | applied alone | applied alone | | | |
| | | in | in | Control effect | | |
| A + B dose | | corresponding | corresponding | of A + B | | |
| (g a.i./ha) | A:B | dose | dose | (%), E | E0 (%) | E-E0 (%) |
| 150 + 45 | 10:3 | 74.7 | 8.6 | 89.1 | 76.9 | 12.3 |
| 150 + 90 | 5:3 | 74.7 | 12.9 | 89.9 | 78.0 | 12.0 |
| 75 + 180 | 5:12 | 52.6 | 50.9 | 88.6 | 76.7 | 11.9 |
| 75 + 360 | 5:24 | 52.6 | 72.1 | 99.4 | 86.8 | 12.7 |

TABLE 140
Control effects of A3 or carfentrazone-ethyl alone
and of a combination thereof on Solanum nigrum

| | | Control effect | | | | |
|---|---|---|---|---|---|---|
| | | (%) of A | Control effect | | | |
| | | applied alone | (%) of B applied | | | |
| | | in | alone in | Control effect | | |
| A + B dose | | corresponding | corresponding | of A + B | | |
| (g a.i./ha) | A:B | dose | dose | (%), E | E0 (%) | E-E0 (%) |
| 150 + 1.875 | 80:1 | 37.5 | 6.3 | 53.5 | 41.5 | 12.0 |
| 150 + 3.75 | 40:1 | 37.5 | 12.1 | 58.0 | 45.1 | 12.9 |
| 75 + 7.5 | 10:1 | 16.9 | 38.0 | 62.1 | 48.5 | 13.6 |
| 75 + 15 | 5:1 | 16.9 | 68.7 | 86.8 | 74.0 | 12.8 |

TABLE 141
Control effects of A3 or fomesafen alone and
of a combination thereof on Acalypha austrahs

| | | Control effect | Control effect | | | |
|---|---|---|---|---|---|---|
| | | (%) of A applied | (%) of B applied | | | |
| | | alone in | alone in | Control effect | | |
| A + B dose | | corresponding | corresponding | of A + B | | |
| (g a.i./ha) | A:B | dose | dose | (%), E | E0 (%) | E-E0 (%) |
| 150 + 22.5 | 20:3 | 51.6 | 6.4 | 65.2 | 54.7 | 10.4 |
| 150 + 45 | 10:3 | 51.6 | 12.6 | 71.5 | 57.7 | 13.7 |
| 75 + 90 | 5:6 | 20.7 | 46.9 | 72.9 | 57.9 | 14.9 |
| 75 + 180 | 5:12 | 20.7 | 82.4 | 98.8 | 86.0 | 12.7 |

TABLE 142
Control effects of A3 or fluoroglycofen alone and of a combination thereof on Acalypha australis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 0.9375 | 160:1 | 51.6 | 4.0 | 65.7 | 53.5 | 12.1 |
| 150 + 1.875 | 80:1 | 51.6 | 15.7 | 71.6 | 59.2 | 12.3 |
| 75 + 3.75 | 20:1 | 20.7 | 41.6 | 67.9 | 53.7 | 14.1 |
| 75 + 7.5 | 10:1 | 20.7 | 71.4 | 90.2 | 77.3 | 12.8 |

TABLE 143
Control effects of A3 or oxyfluorfen alone and of a combination thereof on Acalypha australis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 7.5 | 20:1 | 51.6 | 4.6 | 64.4 | 53.8 | 10.5 |
| 150 + 15 | 10:1 | 51.6 | 12.4 | 68.7 | 57.6 | 11.0 |
| 75 + 30 | 5:2 | 20.7 | 32.7 | 60.1 | 46.6 | 13.4 |
| 75 + 60 | 5:4 | 20.7 | 68.9 | 87.6 | 75.3 | 12.2 |

TABLE 144
Control effects of A3 or lactofen alone and of a combination thereof on Acalypha australis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 7.5 | 20:1 | 51.6 | 2.7 | 63.8 | 52.9 | 10.8 |
| 150 + 15 | 10:1 | 51.6 | 13.5 | 71.5 | 58.1 | 13.3 |
| 75 + 30 | 5:2 | 20.7 | 41.4 | 66.1 | 53.5 | 12.5 |
| 75 + 60 | 5:4 | 20.7 | 66.4 | 84.5 | 73.3 | 11.1 |

TABLE 145
Control effects of A3 or acifluorfen-sodium alone and of a combination thereof on Acalypha australis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 37.5 | 4:1 | 51.6 | 5.8 | 66.0 | 54.4 | 11.5 |
| 150 + 75 | 2:1 | 51.6 | 11.6 | 67.9 | 57.2 | 10.6 |
| 75 + 150 | 1:2 | 20.7 | 46.6 | 71.1 | 57.6 | 13.4 |
| 75 + 300 | 1:4 | 20.7 | 85.3 | 99.0 | 88.3 | 10.6 |

TABLE 146
Control effects of A3 or flumioxazin alone and of a combination thereof on Acalypha australis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 7.5 | 20:1 | 51.6 | 6.9 | 67.8 | 54.9 | 12.8 |
| 150 + 15 | 10:1 | 51.6 | 13.7 | 71.6 | 58.2 | 13.3 |
| 75 + 30 | 5:2 | 20.7 | 39.0 | 64.2 | 51.6 | 12.5 |
| 75 + 60 | 5:4 | 20.7 | 79.3 | 94.8 | 83.6 | 11.1 |

TABLE 147
Control effects of A4 or sulfentrazone alone and of a combination thereof on Echinochloa oryzoides

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 1.875 | 80:1 | 74.7 | 5.8 | 86.8 | 76.2 | 10.7 |
| 150 + 3.75 | 40:1 | 74.7 | 18.1 | 92.1 | 79.3 | 12.9 |
| 75 + 7.5 | 10:1 | 52.6 | 29.7 | 78.5 | 66.7 | 11.9 |
| 75 + 15 | 5:1 | 52.6 | 56.1 | 89.9 | 79.2 | 10.8 |

TABLE 148
Control effects of A3 or saflufenacil alone and of a combination thereof on Sonchus oleraceus L.

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 3.75 | 40:1 | 55.5 | 5.4 | 70.6 | 57.9 | 12.7 |
| 150 + 7.5 | 20:1 | 55.5 | 13.9 | 75.3 | 61.7 | 13.6 |
| 75 + 15 | 5:1 | 33.8 | 40.9 | 75.5 | 60.9 | 14.6 |
| 75 + 30 | 5:2 | 33.8 | 76.6 | 98.1 | 84.5 | 13.6 |

TABLE 149
Control effects of A4 or oxadiazon alone and of a combination thereof on Echinochloa oryzoides
(soil sealing treatment)

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 37.5 | 4:1 | 42.5 | 5.1 | 56.8 | 45.4 | 11.4 |
| 150 + 75 | 2:1 | 42.5 | 10.3 | 60.3 | 48.4 | 11.9 |
| 75 + 150 | 1:2 | 18.9 | 39.7 | 63.2 | 51.1 | 12.1 |
| 75 + 300 | 1:4 | 18.9 | 50.8 | 73.2 | 60.1 | 13.1 |

TABLE 150
Control effects of A4 or oxacliargyl alone and of a combination thereof on Echinochloa oryzoides
(soil sealing treatment)

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 7.5 | 20:1 | 42.5 | 2.6 | 54.2 | 44.0 | 10.2 |
| 150 + 15 | 10:1 | 42.5 | 12.7 | 59.9 | 49.8 | 10.1 |
| 75 + 30 | 5:2 | 18.9 | 41.6 | 64.7 | 52.6 | 12.1 |
| 75 + 60 | 5:4 | 18.9 | 63.3 | 81.4 | 70.2 | 11.2 |

TABLE 151
Control effects of A172 or glyphosate alone and of a combination thereof on Digitaria sanguinalis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 75 | 2:1 | 38.9 | 12.3 | 62.1 | 46.4 | 15.7 |
| 150 + 150 | 1:1 | 38.9 | 24.6 | 73.9 | 53.9 | 20.0 |
| 75 + 300 | 1:4 | 21.2 | 43.5 | 78.1 | 55.5 | 22.7 |
| 75 + 600 | 1:8 | 21.2 | 76.4 | 93.1 | 81.4 | 11.7 |

TABLE 152
Control effects of A172 or glufosinate ammonium alone and of a combination thereof
on Capsella bursa-pastoris

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 75 | 2:1 | 47.9 | 2.1 | 65.2 | 49.0 | 16.2 |
| 150 + 150 | 1:1 | 47.9 | 8.7 | 72.3 | 52.4 | 19.9 |
| 75 + 300 | 1:4 | 22.4 | 15.3 | 53.7 | 34.3 | 19.4 |
| 75 + 600 | 1:8 | 22.4 | 34.5 | 74.2 | 49.2 | 25.0 |

TABLE 153
Control effects of A67 or glyphosate alone and of a combination thereof on Digitaria sanguinalis

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 75 | 2:1 | 62.2 | 12.3 | 82.4 | 66.8 | 15.6 |
| 150 + 150 | 1:1 | 62.2 | 24.6 | 93.3 | 71.5 | 21.8 |
| 75 + 300 | 1:4 | 23.4 | 43.5 | 78.1 | 56.7 | 21.4 |
| 75 + 600 | 1:8 | 23.4 | 76.4 | 95.9 | 81.9 | 14.0 |

TABLE 154
Control effects of A67 or glyphosate alone and of a combination thereof on Eleusine indica

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 75 | 2:1 | 75.3 | 6.9 | 88.7 | 77.0 | 11.7 |
| 150 + 150 | 1:1 | 75.3 | 13.6 | 92.3 | 78.7 | 13.6 |
| 75 + 300 | 1:4 | 42.5 | 21.3 | 71.4 | 54.7 | 16.7 |
| 75 + 600 | 1:8 | 42.5 | 68.9 | 93.9 | 82.1 | 11.8 |

TABLE 155
Control effects of A67 or glyphosate alone and of a combination thereof on Sinapis arvensis

| | | Control effect | Control effect | | | |
|---|---|---|---|---|---|---|
| | | (%) of A | (%) of B in | | | |
| | | applied alone in | applied alone | Control effect | | |
| A + B dose | | corresponding | corresponding | of A + B (%), | E0 | E-E0 |
| (g a.i./ha) | A:B | dose | dose | E | (%) | (%) |
| 150 + 75 | 2:1 | 72.8 | 2.5 | 86.2 | 73.5 | 12.7 |
| 150 + 150 | 1:1 | 72.8 | 9.4 | 90.9 | 75.4 | 15.5 |
| 75 + 300 | 1:4 | 45.7 | 19.8 | 73.6 | 56.5 | 17.1 |
| 75 + 600 | 1:8 | 45.7 | 37.2 | 85.2 | 65.9 | 19.3 |

TABLE 156
Control effects of A67 or glyphosate alone and of a combination thereof on Alopecurus japonicus

| | | Control effect | Control effect | | | |
|---|---|---|---|---|---|---|
| | | (%) of A | (%) of B | | | |
| | | applied alone in | applied alone in | Control effect | | |
| A + B dose | | corresponding | corresponding | of A + B (%), | E0 | E-E0 |
| (g a.i./ha) | A:B | dose | dose | E | (%) | (%) |
| 150 + 75 | 2:1 | 52.4 | 7.6 | 71.3 | 56.0 | 15.3 |
| 150 + 150 | 1:1 | 52.4 | 19.5 | 75.4 | 61.7 | 13.7 |
| 75 + 300 | 1:4 | 28.7 | 30.8 | 65.5 | 50.7 | 14.8 |
| 75 + 600 | 1:8 | 28.7 | 66.9 | 89.4 | 76.4 | 13.0 |

TABLE 157
Control effects of A67 or glufosinate ammonium alone and of a combination thereof
on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 75.6 | 2.1 | 87.4 | 76.1 | 11.3 |
| 150 + 150 | 1:1 | 75.6 | 8.7 | 91.6 | 77.7 | 13.9 |
| 75 + 300 | 1:4 | 51.4 | 15.3 | 83.2 | 58.8 | 24.4 |
| 75 + 600 | 1:8 | 51.4 | 34.5 | 90.3 | 68.2 | 22.1 |

TABLE 158
Control effects of A67 or glufosinate ammonium alone and of a combination thereof
on Amaranthus retroflexus

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 63.9 | 10.2 | 82.6 | 67.6 | 15.0 |
| 150 + 150 | 1:1 | 63.9 | 19.6 | 89.4 | 71.0 | 18.4 |
| 75 + 300 | 1:4 | 31.7 | 28.6 | 83.7 | 51.2 | 32.5 |
| 75 + 600 | 1:8 | 31.7 | 54.1 | 92.3 | 68.7 | 23.6 |

TABLE 159
Control effects of A67 or paraquat dichloride alone and of a combination thereof
on Conyza Canadensis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 65.6 | 3.2 | 78.4 | 66.7 | 11.7 |
| 150 + 150 | 1:1 | 65.6 | 17.2 | 85.1 | 71.5 | 13.6 |
| 75 + 300 | 1:4 | 45.9 | 47.9 | 84.9 | 71.8 | 13.1 |
| 75 + 600 | 1:8 | 45.9 | 75.2 | 97.6 | 86.6 | 11.0 |

TABLE 160
Control effects of A67 or diquat Dibromide monohydrate alone and of a combination
thereof on Veronica didyma

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 43.1 | 5.5 | 57.7 | 46.2 | 11.5 |
| 150 + 150 | 1:1 | 43.1 | 12.6 | 73.8 | 50.3 | 23.5 |
| 75 + 300 | 1:4 | 23.2 | 41.3 | 78.3 | 54.9 | 23.4 |
| 75 + 600 | 1:8 | 23.2 | 80.4 | 95.8 | 84.9 | 10.9 |

TABLE 161
Control effects of A1 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 69.1 | 12.3 | 85.3 | 72.9 | 12.4 |
| 150 + 150 | 1:1 | 69.1 | 24.6 | 94.6 | 76.7 | 17.9 |
| 75 + 300 | 1:4 | 25.9 | 43.5 | 75.4 | 58.1 | 17.3 |
| 75 + 600 | 1:8 | 25.9 | 76.4 | 96.1 | 82.5 | 13.6 |

TABLE 162
Control effects of A1 or glyphosate alone and of a combination thereof on
Eleusine indica

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 81.2 | 6.9 | 95.7 | 82.5 | 13.2 |
| 150 + 150 | 1:1 | 81.2 | 13.6 | 97.8 | 83.8 | 14.0 |
| 75 + 300 | 1:4 | 46.9 | 21.3 | 76.4 | 58.2 | 18.2 |
| 75 + 600 | 1:8 | 46.9 | 68.9 | 97.9 | 83.5 | 14.4 |

TABLE 163
Control effects of A1 or glyphosate alone and of a combination thereof on
Sinapis arvensis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 79.9 | 2.5 | 93.1 | 80.4 | 12.7 |
| 150 + 150 | 1:1 | 79.9 | 9.4 | 97.3 | 81.8 | 15.5 |
| 75 + 300 | 1:4 | 50.4 | 19.8 | 79.8 | 60.2 | 19.6 |
| 75 + 600 | 1:8 | 50.4 | 37.2 | 87.4 | 68.9 | 18.5 |

TABLE 164
Control effects of A1 or glyphosate alone and of a combination thereof on
Alopecurus japonicus

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 57.6 | 7.6 | 79.7 | 60.8 | 18.9 |
| 150 + 150 | 1:1 | 57.6 | 19.5 | 83.8 | 65.9 | 17.9 |
| 75 + 300 | 1:4 | 31.3 | 30.8 | 75.2 | 52.5 | 22.7 |
| 75 + 600 | 1:8 | 31.3 | 66.9 | 95.1 | 77.3 | 17.8 |

TABLE 165
Control effects of A1 or glufosinate ammonium alone and of a combination thereof
on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 82.4 | 2.1 | 95.8 | 82.8 | 13.0 |
| 150 + 150 | 1:1 | 82.4 | 8.7 | 98.7 | 83.9 | 14.8 |
| 75 + 300 | 1:4 | 56.5 | 15.3 | 82.5 | 63.2 | 19.3 |
| 75 + 600 | 1:8 | 56.5 | 34.5 | 90.5 | 71.5 | 19.0 |

TABLE 166
Control effects of A1 or glufosinate ammonium alone and of a combination thereof
on Amaranthus retroflexus

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 71.7 | 10.2 | 91.4 | 74.6 | 16.8 |
| 150 + 150 | 1:1 | 71.7 | 19.6 | 97.2 | 77.2 | 20.0 |
| 75 + 300 | 1:4 | 35.4 | 28.6 | 76.7 | 53.9 | 22.8 |
| 75 + 600 | 1:8 | 35.4 | 54.1 | 90.2 | 70.3 | 19.9 |

TABLE 167
Control effects of A4 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 56.4 | 12.3 | 72.5 | 61.8 | 10.7 |
| 150 + 150 | 1:1 | 56.4 | 24.6 | 82.1 | 67.1 | 15.0 |
| 75 + 300 | 1:4 | 22.2 | 43.5 | 68.8 | 56.0 | 12.8 |
| 75 + 600 | 1:8 | 22.2 | 76.4 | 94.4 | 81.6 | 12.8 |

TABLE 168
Control effects of A4 or glyphosate alone and of a combination thereof on
Eleusine indica

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 69.2 | 6.9 | 84.1 | 71.3 | 12.8 |
| 150 + 150 | 1:1 | 69.2 | 13.6 | 89.2 | 73.4 | 15.8 |
| 75 + 300 | 1:4 | 38.5 | 21.3 | 69.8 | 51.6 | 18.2 |
| 75 + 600 | 1:8 | 38.5 | 68.9 | 94.9 | 80.9 | 14.0 |

TABLE 169
Control effects of A4 or glyphosate alone and of a combination thereof on
Sinapis arvensis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 65.9 | 2.5 | 82.1 | 66.8 | 15.3 |
| 150 + 150 | 1:1 | 65.9 | 9.4 | 89.3 | 69.1 | 20.2 |
| 75 + 300 | 1:4 | 41.1 | 19.8 | 71.2 | 52.8 | 18.4 |
| 75 + 600 | 1:8 | 41.1 | 37.2 | 81.2 | 63.0 | 18.2 |

TABLE 170
Control effects of A4 or glyphosate alone and of a combination thereof on
Alopecurus japonicus

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 47.2 | 7.6 | 67.1 | 51.2 | 15.9 |
| 150 + 150 | 1:1 | 47.2 | 19.5 | 72.3 | 57.5 | 14.8 |
| 75 + 300 | 1:4 | 24.9 | 30.8 | 63.4 | 48.0 | 15.4 |
| 75 + 600 | 1:8 | 24.9 | 66.9 | 87.2 | 75.1 | 12.1 |

TABLE 171
Control effects of A4 or glufosinate ammonium alone and of a combination thereof
on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 67.2 | 2.1 | 79.1 | 67.9 | 11.2 |
| 150 + 150 | 1:1 | 67.2 | 8.7 | 86.4 | 70.1 | 16.3 |
| 75 + 300 | 1:4 | 44.2 | 15.3 | 70.2 | 52.7 | 17.5 |
| 75 + 600 | 1:8 | 44.2 | 34.5 | 79.2 | 63.5 | 15.7 |

TABLE 172
Control effects of A4 or glufosinate ammonium alone and of a combination thereof on
Amaranthus retroflexus

| | | | Control effect (%) | | | |
|---|---|---|---|---|---|---|
| | | Control effect (%) of | of B applied alone | Control | | |
| A + B dose | | A applied alone in | in corresponding | effect of A + | | |
| (g a.i./ha) | A:B | corresponding dose | dose | B (%), E | E0 (%) | E − E0 (%) |
| 150 + 75 | 2:1 | 57.2 | 10.2 | 72.5 | 61.6 | 10.9 |
| 150 + 150 | 1:1 | 57.2 | 19.6 | 82.6 | 65.6 | 17.0 |
| 75 + 300 | 1:4 | 26.7 | 28.6 | 71.4 | 47.7 | 23.7 |
| 75 + 600 | 1:8 | 26.7 | 54.1 | 84.7 | 66.4 | 18.3 |

TABLE 173
Control effects of A171 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 31.9 | 12.3 | 52.3 | 40.3 | 12.0 |
| 150 + 150 | 1:1 | 31.9 | 24.6 | 64.2 | 48.7 | 15.5 |
| 75 + 300 | 1:4 | 19.2 | 43.5 | 69.2 | 54.3 | 14.9 |
| 75 + 600 | 1:8 | 19.2 | 76.4 | 92.3 | 80.9 | 11.4 |

TABLE 174
Control effects of A171 or glufosinate ammonium alone and of a combination thereof on
Copsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 28.9 | 2.1 | 42.2 | 30.4 | 11.8 |
| 150 + 150 | 1:1 | 28.9 | 8.7 | 53.2 | 35.1 | 18.1 |
| 75 + 300 | 1:4 | 12.2 | 15.3 | 46.2 | 25.6 | 20.6 |
| 75 + 600 | 1:8 | 12.2 | 34.5 | 61.3 | 42.5 | 18.8 |

TABLE 175
Control effects of A211 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 68.3 | 12.3 | 83.2 | 72.2 | 11.0 |
| 150 + 150 | 1:1 | 68.3 | 24.6 | 90.9 | 76.1 | 14.8 |
| 75 + 300 | 1:4 | 31.3 | 43.5 | 85.2 | 61.2 | 24.0 |
| 75 + 600 | 1:8 | 31.3 | 76.4 | 98.7 | 83.8 | 14.9 |

TABLE 176
Control effects of A211 or glufosinate ammoniumalone and of a combination thereof on
Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i/ha) | A:B | dose | dose | B (%), E | E0 (%) | E − E0 (%) |
| 150 + 75 | 2:1 | 14.6 | 2.1 | 34.2 | 16.4 | 17.8 |
| 150 + 150 | 1:1 | 14.6 | 8.7 | 43.8 | 22.0 | 21.8 |
| 75 + 300 | 1:4 | 5.8 | 15.3 | 41.9 | 20.2 | 21.7 |
| 75 + 600 | 1:8 | 5.8 | 34.5 | 61.3 | 38.3 | 23.0 |

TABLE 177
Control effects of A94 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 51.7 | 12.3 | 72.3 | 57.6 | 14.7 |
| 150 + 150 | 1:1 | 51.7 | 24.6 | 82.5 | 63.6 | 18.9 |
| 75 + 300 | 1:4 | 23.4 | 43.5 | 79.5 | 56.7 | 22.8 |
| 75 + 600 | 1:8 | 23.4 | 76.4 | 95.3 | 81.9 | 13.4 |

TABLE 178
Control effects of A94 or glufosinate ammonium alone and of a combination thereof on
Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 12.6 | 2.1 | 31.2 | 14.4 | 16.8 |
| 150 + 150 | 1:1 | 12.6 | 8.7 | 42.7 | 20.2 | 22.5 |
| 75 + 300 | 1:4 | 6.2 | 15.3 | 38.9 | 20.6 | 18.3 |
| 75 + 600 | 1:8 | 6.2 | 34.5 | 52.8 | 38.6 | 14.2 |

TABLE 179
Control effects of A173 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 73.6 | 12.3 | 89.7 | 76.8 | 12.9 |
| 150 + 150 | 1:1 | 73.6 | 24.6 | 93.2 | 80.1 | 13.1 |
| 75 + 300 | 1:4 | 38.2 | 43.5 | 84.3 | 65.1 | 19.2 |
| 75 + 600 | 1:8 | 38.2 | 76.4 | 95.9 | 85.4 | 10.5 |

TABLE 180
Control effects of A173 or glufosinate ammonium alone and of a combination thereof on
Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 52.4 | 2.1 | 66.9 | 53.4 | 13.5 |
| 150 + 150 | 1:1 | 52.4 | 8.7 | 76.8 | 56.5 | 20.3 |
| 75 + 300 | 1:4 | 24.8 | 15.3 | 52.5 | 36.3 | 16.2 |
| 75 + 600 | 1:8 | 24.8 | 34.5 | 67.3 | 50.7 | 16.6 |

TABLE 181
Control effects of A212 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 24.6 | 12.3 | 51.4 | 33.9 | 17.5 |
| 150 + 150 | 1:1 | 24.6 | 24.6 | 62.1 | 43.1 | 19.0 |
| 75 + 300 | 1:4 | 11.5 | 43.5 | 70.4 | 50.0 | 20.4 |
| 75 + 600 | 1:8 | 11.5 | 76.4 | 95.3 | 79.1 | 16.2 |

TABLE 182
Control effects of A212 or glufosinate ammonium alone and of a combination thereof
on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 14.5 | 2.1 | 34.8 | 16.3 | 18.5 |
| 150 + 150 | 1:1 | 14.5 | 8.7 | 46.2 | 21.9 | 24.3 |
| 75 + 300 | 1:4 | 8.6 | 15.3 | 43.7 | 22.6 | 21.1 |
| 75 + 600 | 1:8 | 8.6 | 34.5 | 61.2 | 40.1 | 21.1 |

TABLE 183
Control effects of A141 or glyphosate alone and of a combination thereof on
Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 55.8 | 12.3 | 76.4 | 61.2 | 15.2 |
| 150 + 150 | 1:1 | 55.8 | 24.6 | 83.1 | 66.7 | 16.4 |
| 75 + 300 | 1:4 | 27.7 | 43.5 | 73.2 | 59.2 | 14.0 |
| 75 + 600 | 1:8 | 27.7 | 76.4 | 95.1 | 82.9 | 12.2 |

TABLE 184
Control effects of A141 or glufosinate ammonium alone and of a combination thereof
on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 16.4 | 2.1 | 31.1 | 18.2 | 12.9 |
| 150 + 150 | 1:1 | 16.4 | 8.7 | 42.9 | 23.7 | 19.2 |
| 75 + 300 | 1:4 | 7.8 | 15.3 | 36.2 | 21.9 | 14.3 |
| 75 + 600 | 1:8 | 7.8 | 34.5 | 54.8 | 39.6 | 15.2 |

TABLE 185
Control effects of A163 or glyphosate alone and of a combination thereof on Digitaria
sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 45.4 | 12.3 | 71.2 | 52.2 | 19.0 |
| 150 + 150 | 1:1 | 45.4 | 24.6 | 81.6 | 58.9 | 22.7 |
| 75 + 300 | 1:4 | 16.6 | 43.5 | 74.9 | 52.9 | 22.0 |
| 75 + 600 | 1:8 | 16.6 | 76.4 | 95.8 | 80.3 | 15.5 |

TABLE 186
Control effects of A163 or glyphosate alone and of a combination thereof on Eleusine
indica

| | | Control effect (%) | Control effect (%) | | | |
|---|---|---|---|---|---|---|
| | | of A applied alone | of B applied alone | Control | | |
| A + B dose | | in corresponding | in corresponding | effect of A + | | |
| (g a.i./ha) | A:B | dose | dose | B (%), E | E0 (%) | E − E0 (%) |
| 150 + 75 | 2:1 | 56.0 | 6.9 | 73.7 | 59.0 | 14.7 |
| 150 + 150 | 1:1 | 56.0 | 13.6 | 86.1 | 62.0 | 24.1 |
| 75 + 300 | 1:4 | 31.7 | 21.3 | 65.0 | 46.2 | 18.8 |
| 75 + 600 | 1:8 | 31.7 | 68.9 | 91.7 | 78.8 | 12.9 |

TABLE 187
Control effects of A163 or glyphosate alone and of a
combination thereof on Sinapis arvensis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 47.2 | 2.5 | 69.7 | 48.5 | 21.2 |
| 150 + 150 | 1:1 | 47.2 | 9.4 | 77.3 | 52.1 | 25.2 |
| 75 + 300 | 1:4 | 29.6 | 19.8 | 70.4 | 43.6 | 26.8 |
| 75 + 600 | 1:8 | 29.6 | 37.2 | 81.1 | 55.8 | 25.3 |

TABLE 188
Control effects of A163 or glyphosate alone and of a combination
thereof on Alopecurus japonicus

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 44.0 | 7.6 | 61.8 | 48.3 | 13.5 |
| 150 + 150 | 1:1 | 44.0 | 19.5 | 71.8 | 54.9 | 16.9 |
| 75 + 300 | 1:4 | 24.1 | 30.8 | 62.3 | 47.5 | 14.8 |
| 75 + 600 | 1:8 | 24.1 | 66.9 | 89.3 | 74.9 | 14.4 |

TABLE 189
Control effects of A163 or glufosinate ammonium alone and of a
combination thereof on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 60.5 | 2.1 | 73.9 | 61.3 | 12.6 |
| 150 + 150 | 1:1 | 60.5 | 8.7 | 88.0 | 63.9 | 24.1 |
| 75 + 300 | 1:4 | 41.1 | 15.3 | 74.3 | 50.1 | 24.2 |
| 75 + 600 | 1:8 | 41.1 | 34.5 | 86.2 | 61.4 | 24.8 |

TABLE 190
Control effects of A163 or glufosinate ammonium alone and of a
combination thereof on Amaranthus retroflexus

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 53.7 | 10.2 | 70.1 | 58.4 | 11.7 |
| 150 + 150 | 1:1 | 53.7 | 19.6 | 85.8 | 62.8 | 23.0 |
| 75 + 300 | 1:4 | 26.6 | 28.6 | 70.5 | 47.6 | 22.9 |
| 75 + 600 | 1:8 | 26.6 | 54.1 | 88.5 | 66.3 | 22.2 |

TABLE 191
Control effects of A163 or paraquat dichloride alone and of a
combination thereof on Conyza Canadensis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 55.8 | 3.2 | 75.9 | 57.2 | 18.7 |
| 150 + 150 | 1:1 | 55.8 | 17.2 | 81.5 | 63.4 | 18.1 |
| 75 + 300 | 1:4 | 39.0 | 47.9 | 81.7 | 68.2 | 13.5 |
| 75 + 600 | 1:8 | 39.0 | 75.2 | 97.5 | 84.9 | 12.6 |

TABLE 192
Control effects of A163 or diquat Dibromide monohydrate alone and of a
combination thereof on Veronica didyma

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 34.5 | 5.5 | 55.2 | 38.1 | 17.1 |
| 150 + 150 | 1:1 | 34.5 | 12.6 | 70.2 | 42.7 | 27.5 |
| 75 + 300 | 1:4 | 18.6 | 41.3 | 75.1 | 52.2 | 22.9 |
| 75 + 600 | 1:8 | 18.6 | 80.4 | 97.7 | 84.0 | 13.7 |

TABLE 193
Control effects of A130 or glyphosate alone and of a combination
thereof on Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 36.8 | 12.3 | 66.3 | 44.6 | 21.7 |
| 150 + 150 | 1:1 | 36.8 | 24.6 | 75.5 | 52.3 | 23.2 |
| 75 + 300 | 1:4 | 16.7 | 43.5 | 72.7 | 52.9 | 19.8 |
| 75 + 600 | 1:8 | 16.7 | 76.4 | 93.9 | 80.3 | 13.6 |

TABLE 194
Control effects of A130 or glufosinate ammonium alone and of a
combination thereof on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 13.2 | 2.1 | 32.6 | 15.0 | 17.6 |
| 150 + 150 | 1:1 | 13.2 | 8.7 | 45.8 | 20.8 | 25.0 |
| 75 + 300 | 1:4 | 5.4 | 15.3 | 41.1 | 19.9 | 21.2 |
| 75 + 600 | 1:8 | 5.4 | 34.5 | 56.2 | 38.0 | 18.2 |

TABLE 195
Control effects of A213 or glyphosate alone and of a combination
thereof on Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 31.2 | 12.3 | 53.9 | 39.7 | 14.2 |
| 150 + 150 | 1:1 | 31.2 | 24.6 | 67.9 | 48.1 | 19.8 |
| 75 + 300 | 1:4 | 14.9 | 43.5 | 68.2 | 51.9 | 16.3 |
| 75 + 600 | 1:8 | 14.9 | 76.4 | 91.3 | 79.9 | 11.4 |

TABLE 196
Control effects of A213 orglufosinate ammoniumalone and of a
combination thereof on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 26.8 | 2.1 | 43.9 | 28.3 | 15.6 |
| 150 + 150 | 1:1 | 26.8 | 8.7 | 52.8 | 33.2 | 19.6 |
| 75 + 300 | 1:4 | 14.6 | 15.3 | 48.7 | 27.7 | 21.0 |
| 75 + 600 | 1:8 | 14.6 | 34.5 | 61.2 | 44.1 | 17.1 |

TABLE 197
Control effects of A214 or glyphosate alone and of a combination
thereof on Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 44.6 | 12.3 | 63.9 | 51.4 | 12.5 |
| 150 + 150 | 1:1 | 44.6 | 24.6 | 74.7 | 58.2 | 16.5 |
| 75 + 300 | 1:4 | 21.9 | 43.5 | 74.6 | 55.9 | 18.7 |
| 75 + 600 | 1:8 | 21.9 | 76.4 | 95.6 | 81.6 | 14.0 |

TABLE 198
Control effects of A214 or glufosinate ammonium alone and of a
combination thereof on Capsella bursa-pastoris

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 46.2 | 2.1 | 65.8 | 47.3 | 18.5 |
| 150 + 150 | 1:1 | 46.2 | 8.7 | 73.8 | 50.9 | 22.9 |
| 75 + 300 | 1:4 | 24.8 | 15.3 | 68.8 | 36.3 | 32.5 |
| 75 + 600 | 1:8 | 24.8 | 34.5 | 72.3 | 50.7 | 21.6 |

TABLE 199
Control effects of A2 or glyphosate alone and of a combination
thereof on Digitaria sanguinalis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 51.6 | 12.3 | 73.8 | 57.6 | 16.2 |
| 150 + 150 | 1:1 | 51.6 | 24.6 | 87.2 | 63.5 | 23.7 |
| 75 + 300 | 1:4 | 19.4 | 43.5 | 74.7 | 54.5 | 20.2 |
| 75 + 600 | 1:8 | 19.4 | 76.4 | 94.5 | 81.0 | 13.5 |

TABLE 200
Control effects of A2 or glyphosate alone and of a combination
thereof on Eleusine indica

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 63.3 | 6.9 | 83.2 | 65.8 | 17.4 |
| 150 + 150 | 1:1 | 63.3 | 13.6 | 88.7 | 68.2 | 20.5 |
| 75 + 300 | 1:4 | 35.7 | 21.3 | 68.2 | 49.4 | 18.8 |
| 75 + 600 | 1:8 | 35.7 | 68.9 | 91.8 | 80.0 | 11.8 |

TABLE 201
Control effects of A2 or glyphosate alone and of a combination
thereof on Sinapis arvensis

| | | Control effect (%) | Control effect (%) | | | |
|---|---|---|---|---|---|---|
| | | of A applied alone | of B applied alone | Control | | |
| A + B dose | | in corresponding | in corresponding | effect of | | |
| (g a.i./ha) | A:B | dose | dose | A + B (%), E | E0 (%) | E − E0 (%) |
| 150 + 75 | 2:1 | 60.4 | 2.5 | 81.1 | 61.4 | 19.7 |
| 150 + 150 | 1:1 | 60.4 | 9.4 | 88.2 | 64.1 | 24.1 |
| 75 + 300 | 1:4 | 37.9 | 19.8 | 72.5 | 50.2 | 22.3 |
| 75 + 600 | 1:8 | 37.9 | 37.2 | 83.3 | 61.0 | 22.3 |

TABLE 202
Control effects of A2 or glyphosate alone and of a combination thereof
o Alopecurus japonicusn

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 150 + 75 | 2:1 | 44.5 | 7.6 | 65.4 | 48.8 | 16.6 |
| 150 + 150 | 1:1 | 44.5 | 19.5 | 73.9 | 55.4 | 18.5 |
| 75 + 300 | 1:4 | 24.4 | 30.8 | 63.6 | 47.7 | 15.9 |
| 75 + 600 | 1:8 | 24.4 | 66.9 | 89.8 | 75.0 | 14.8 |

TABLE 203
Control effects of A2 or glufosinate ammonium alone and of a combination thereof
on Copsella bursa-pastoris

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 150 + 75 | 2:1 | 65.0 | 2.1 | 79.3 | 65.8 | 13.5 |
| 150 + 150 | 1:1 | 65.0 | 8.7 | 85.9 | 68.1 | 17.8 |
| 75 + 300 | 1:4 | 44.2 | 15.3 | 76.3 | 52.7 | 23.6 |
| 75 + 600 | 1:8 | 44.2 | 34.5 | 84.1 | 63.5 | 20.6 |

TABLE 204
Control effects of A2 or glufosinate ammonium alone and of a combination thereof
on Amaranthus retroflexus

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 150 + 75 | 2:1 | 51.8 | 10.2 | 69.7 | 56.7 | 13.0 |
| 150 + 150 | 1:1 | 51.8 | 19.6 | 82.5 | 61.2 | 21.3 |
| 75 + 300 | 1:4 | 25.7 | 28.6 | 72.4 | 46.9 | 25.5 |
| 75 + 600 | 1:8 | 25.7 | 54.1 | 83.5 | 65.9 | 17.6 |

TABLE 205
Control effects of A2 or paraquat dichloride alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 150 + 75 | 2:1 | 54.4 | 3.2 | 67.2 | 55.9 | 11.3 |
| 150 + 150 | 1:1 | 54.4 | 17.2 | 78.9 | 62.3 | 16.6 |
| 75 + 300 | 1:4 | 38.1 | 47.9 | 82.2 | 67.7 | 14.5 |
| 75 + 600 | 1:8 | 38.1 | 75.2 | 98.4 | 84.6 | 13.8 |

TABLE 206
Control effects of A2 or diquat Dibromide monohydrate alone and of a combination
thereof on Veronica didyma

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 150 + 75 | 2:1 | 36.6 | 5.5 | 61.7 | 40.1 | 21.6 |
| 150 + 150 | 1:1 | 36.6 | 12.6 | 75.3 | 44.6 | 30.7 |
| 75 + 300 | 1:4 | 19.7 | 41.3 | 79.0 | 52.9 | 26.1 |
| 75 + 600 | 1:8 | 19.7 | 80.4 | 97.3 | 84.3 | 13.0 |

TABLE 207
Control effects of A2 or triclopyr alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 60 + 300 | 1:5 | 22.6 | 78.4 | 95.1 | 83.3 | 11.8 |

TABLE 208
Control effects of A2 or MCPAalone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 75 | 1.6:1 | 47.9 | 18.8 | 71.3 | 57.7 | 13.6 |

TABLE 209
Control effects of A2 or dicamba alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 60 + 150 | 1:2.5 | 22.6 | 58.7 | 81.4 | 68.0 | 13.4 |

TABLE 210
Control effects of A2 or picloram alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 7.5 | 16:1 | 47.9 | 5.0 | 60.8 | 50.5 | 10.3 |
| 60 + 60 | 1:1 | 22.6 | 69.4 | 88.4 | 76.3 | 12.1 |

TABLE 211
Control effects of A2 or aminopyralid alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 15 | 8:1 | 47.9 | 19.0 | 71.2 | 57.8 | 13.4 |
| 60 + 30 | 2:1 | 22.6 | 40.7 | 65.8 | 54.1 | 11.7 |

TABLE 212
Control effects of A2 or fluroxypyr alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 37.5 | 3.2:1 | 47.9 | 5.8 | 63.4 | 50.9 | 12.5 |

TABLE 213
Control effects of A2 or florpyrauxifen benzyl alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 1.875 | 64:1 | 47.9 | 3.5 | 59.8 | 49.7 | 10.1 |
| 60 + 7.5 | 8:1 | 22.6 | 47.4 | 73.2 | 59.3 | 13.9 |

TABLE 214
Control effects of A2 or halauxifen-methyl alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 3.75 | 32:1 | 47.9 | 20.5 | 72.4 | 58.6 | 13.8 |
| 60 + 15 | 4:1 | 22.6 | 81.5 | 99.3 | 85.7 | 13.6 |

TABLE 215
Control effects of A2 or quinclorac alone and of a combinaf on thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 30 | 4:1 | 47.9 | 11.7 | 72.5 | 54.0 | 18.5 |
| 120 + 60 | 2:1 | 47.9 | 28.8 | 82.2 | 62.9 | 19.3 |
| 60 + 120 | 1:2 | 22.6 | 53.7 | 87.4 | 64.2 | 23.2 |
| 60 + 240 | 1:4 | 22.6 | 76.2 | 94.7 | 81.6 | 13.1 |

TABLE 216
Control effects of A2 or clopyralid alone and of a combination thereof
on Conyza Canadensis

| | | Control effect (%) | Control effect (%) | | | |
|---|---|---|---|---|---|---|
| A + B | | of A applied alone | of B applied alone | Control | | |
| dose | | in corresponding | in corresponding | effect of A + | E0 | E-E0 |
| (g a.i./ha) | A:B | dose | dose | B (%), E | (%) | (%) |
| 120 + 15 | 8:1 | 47.9 | 6.1 | 78.3 | 51.1 | 27.2 |
| 120 + 30 | 4:1 | 47.9 | 29.8 | 85.5 | 63.4 | 22.1 |
| 60 + 60 | 1:1 | 22.6 | 53.5 | 86.7 | 64.0 | 22.7 |
| 60 + 120 | 1:2 | 22.6 | 82.8 | 98.6 | 86.7 | 11.9 |

### C) Pilot Sites

Tests wherein the herbicidal compositions prepared in Examples 1 to 150 were used to control weeds in the fields.

In 2018, a demonstration popularization test was conducted at the pilot sites in Qingdao city of Shandong Province. The weeds in the fields mainly included: Digitaria sanguinalis, Eleusine indica, Echinochloa crus-galli, Setaria viridis, Panicum miliaceum L., Amaranthus retroflexus, Acalypha australis, Equisetum arvense, Mollugo pentaphylla L., Juncellus serotinus and so forth.

Experimental Methods:

Foliage treatment: In the stage of 3-5 leaves of the weeds, the agent was evenly sprayed on stems and leaves through a manual sprayer, wherein the amount of added water was 30 kg/667 m².

The specific tested agents and dosage thereof were shown in Table 217. The area of the pilot site was 50 square meters, and each treatment was repeated for 4 times. The weed control efficiency after 45 days of application was shown in Table 217.

Weed control effect expressed by fresh weight (%)=(fresh weight of blank control weed-fresh weight of treated weed)/fresh weight of blank control weed×100

TABLE 217
The control effects of the claimed compositions in pilot sites

| Example | Dosage | |
|---|---|---|
| no. | (g a.i./ha) | Control effect expressed by fresh weight (%) |
| 1 | 150 | 97.8 |
| 2 | 180 | 95.6 |
| 3 | 210 | 93.8 |
| 4 | 150 | 98.3 |
| 5 | 180 | 95.2 |
| 6 | 210 | 94.6 |
| 7 | 150 | 97.5 |
| 8 | 180 | 96.7 |
| 9 | 210 | 94.9 |
| 10 | 180 | 96.6 |
| 11 | 210 | 96.7 |
| 12 | 240 | 94.1 |
| 13 | 124.5 | 97.1 |
| 14 | 154.5 | 96.3 |
| 15 | 184.5 | 94.9 |
| 16 | 150 | 96.3 |
| 17 | 180 | 97.8 |
| 18 | 210 | 95.2 |
| 19 | 210 | 95.4 |
| 20 | 240 | 97.8 |
| 21 | 270 | 94.4 |
| 22 | 270 | 95.9 |
| 23 | 300 | 97.4 |
| 24 | 330 | 95.2 |
| 25 | 180 | 95.1 |
| 26 | 210 | 98.9 |
| 27 | 240 | 95.5 |
| 28 | 270 | 94.2 |
| 29 | 300 | 98.9 |
| 30 | 330 | 94.7 |
| 31 | 150 | 94.7 |
| 32 | 180 | 98.5 |
| 33 | 210 | 95.5 |
| 34 | 270 | 93.9 |
| 35 | 300 | 98.3 |
| 36 | 330 | 95.8 |
| 37 | 165 | 97.5 |
| 38 | 195 | 95.1 |
| 39 | 225 | 93.6 |
| 40 | 195 | 97.6 |
| 41 | 225 | 94.9 |
| 42 | 255 | 94.1 |
| 43 | 210 | 97.3 |
| 44 | 240 | 95.8 |
| 45 | 270 | 94.6 |
| 46 | 345 | 96.1 |
| 47 | 375 | 96.5 |
| 48 | 405 | 93.4 |
| 49 | 180 | 96.8 |
| 50 | 210 | 95.8 |
| 51 | 240 | 94.7 |
| 52 | 180 | 95.6 |
| 53 | 210 | 97.5 |
| 54 | 240 | 94.7 |
| 55 | 180 | 95.1 |
| 56 | 210 | 97.3 |
| 57 | 240 | 94.2 |
| 58 | 870 | 95.2 |
| 59 | 900 | 97.1 |
| 60 | 930 | 94.7 |
| 61 | 870 | 94.9 |
| 62 | 900 | 97.8 |
| 63 | 930 | 95.2 |
| 64 | 870 | 93.7 |
| 65 | 900 | 98.7 |
| 66 | 930 | 93.5 |
| 67 | 1020 | 94.4 |
| 68 | 1050 | 97.7 |
| 69 | 1080 | 95.3 |
| 70 | 720 | 93.2 |
| 71 | 750 | 97.5 |
| 72 | 780 | 95.3 |
| 73 | 300 | 92.7 |
| 74 | 330 | 96.5 |
| 75 | 360 | 95.3 |
| 76 | 1620 | 94.5 |
| 77 | 1650 | 94.9 |
| 78 | 1680 | 97.2 |
| 79 | 255 | 94.1 |
| 80 | 285 | 94.8 |
| 81 | 315 | 96.3 |
| 82 | 150 | 93.5 |
| 83 | 180 | 94.5 |
| 84 | 210 | 96.8 |
| 85 | 255 | 94.2 |
| 86 | 285 | 94.7 |
| 87 | 315 | 96.2 |
| 88 | 300 | 94.9 |
| 89 | 330 | 93.2 |
| 90 | 360 | 98.5 |
| 91 | 210 | 92.3 |
| 92 | 240 | 94.1 |
| 93 | 270 | 96.9 |
| 94 | 270 | 95.1 |
| 95 | 300 | 92.5 |
| 96 | 330 | 96.7 |
| 97 | 210 | 94.8 |
| 98 | 240 | 92.2 |
| 99 | 270 | 96.3 |
| 100 | 165 | 94.2 |
| 101 | 195 | 93.8 |
| 102 | 225 | 94.4 |
| 103 | 210 | 97.9 |
| 104 | 240 | 95.7 |
| 105 | 270 | 94.5 |
| 106 | 420 | 97.1 |
| 107 | 450 | 93.3 |
| 108 | 480 | 93.8 |
| 109 | 270 | 97.2 |
| 110 | 300 | 93.7 |
| 111 | 330 | 94.2 |
| 112 | 870 | 96.5 |
| 113 | 900 | 93.8 |
| 114 | 930 | 92.9 |
| 115 | 570 | 99.8 |
| 116 | 600 | 92.6 |
| 117 | 630 | 92.9 |
| 118 | 150 | 96.6 |
| 119 | 180 | 94.3 |
| 120 | 210 | 92.3 |
| 121 | 495 | 97.9 |
| 122 | 525 | 94.6 |
| 123 | 555 | 96.8 |
| 124 | 135 | 95.4 |
| 125 | 165 | 95.8 |
| 126 | 195 | 97.4 |
| 127 | 300 | 92.1 |
| 128 | 330 | 93.5 |
| 129 | 360 | 96.4 |
| 130 | 240 | 93.5 |
| 131 | 270 | 95.4 |
| 132 | 300 | 96.3 |
| 133 | 570 | 93.1 |
| 134 | 600 | 93.2 |
| 135 | 630 | 99.3 |
| 136 | 210 | 92.1 |
| 137 | 240 | 92.7 |
| 138 | 270 | 95.5 |
| 139 | 480 | 95.1 |
| 140 | 510 | 93.6 |
| 141 | 540 | 98.2 |
| 142 | 480 | 93.4 |
| 143 | 510 | 97.9 |
| 144 | 540 | 94.6 |
| 145 | 720 | 91.5 |
| 146 | 750 | 96.7 |
| 147 | 780 | 94.9 |
| 148 | 210 | 93.7 |
| 149 | 240 | 95.8 |
| 150 | 270 | 96.3 |

### D) In-House Evaluation Tests

The indoor evaluation test was conducted using the herbicide composition produced by A) Example 151-165, and the specific test method was the same as the corresponding part of B) the Efficacy Assays.

Test weed: Echinochloa crus-galli, Digitaria sanguinalis, Eleusine indica, Setaria viridis, Panicum miliaceum L., Amaranthus retrojlexus, Abutilon theophrasti, Acalypha australis.

Test crop (containing glyphosate-, 2,4-D-resistance trait): maize SmartStax™Pro x Enlist™ (Event Name MON87427 x MON89034 x TC1507 x MON87411×59122 x DAS40278), Soybean Conkesta Enlist E3™ (Event Name DAS81419 x) (DAS44406).

Leaf age in the stem and leaf treatments: weed in the stage of 3-5 leaves, maize in the stage of 3-5 leaves with one leaf not fully expanded, and soybean in 2nd to 3rd trilobular stage.

The specific test agents, dosages and the results of the 20-day post-application surveys were shown in Table 218.

Weed control effect expressed by fresh weight (%)=(fresh weight of blank control weed-fresh weight of treated weed)/fresh weight of blank control weed×100

TABLE 218
Application of the compounded compositions on transgenic
herbicide-resistant trait crops

| | | Weed control effect | | |
|---|---|---|---|---|
| | Dosage | expressed by fresh | Safety | Safety of the |
| Agents | (g a.i./ha) | weight ( %) | of the maize | soybean |
| 151 | 1125 | 93.1 | Safety | Safety |
| 152 | 900 | 96.4 | Safety | Safety |
| 153 | 877.5 | 97.2 | Safety | Safety |
| 154 | 945 | 95.2 | Safety | Safety |
| 155 | 1125 | 94.9 | Safety | Safety |
| 156 | 900 | 92.3 | Safety | Safety |
| 157 | 1125 | 91.7 | Safety | Safety |
| 158 | 900 | 93.9 | Safety | Safety |
| 159 | 1125 | 94.6 | Safety | Safety |
| 160 | 900 | 92.0 | Safety | Safety |
| 161 | 900 | 95.5 | Safety | Safety |
| 162 | 900 | 94.2 | Safety | Safety |
| 163 | 900 | 91.6 | Safety | Safety |
| 164 | 900 | 93.2 | Safety | Safety |
| 165 | 900 | 96.0 | Safety | Safety |

After making extensive experimentations and explorations, the present inventors have unexpectedly discovered that after the claimed compsositions are used to control broadleaf weeds such as Ammannia arenaria, Amaranthus retrojlexus, Acalypha australis, Solanum nigrum, Eclipta prostrate, Galium aparine L., Convolvulus arvensis, Conyza Canadensis, Capsella bursa-pastoris, Abutilon theophrasti, Veronica persica, Malachium aquaticum, Stellaria media, Sinapis arvensis, Ludwigia prostrate, Lindernia procumbens, Sonchus arvensis, Sonchus oleraceus L., Cirsium setosum, Xanthium strumarium, Descurainia sophia, Chenopodium album, Commelina communis, Ipomoea purpurea, etc.; grassy weeds such as Alopecurus aequalis, Alopecurus japonicus, Chloris virgata, Echinochloa crus-galli, Echinochloa crusgalli var. zelayensis, Echinochloa oryzoides, Echinochloa caudate, Setaria faberi, Setaria viridis, Setaria glauca, Digitaria sanguinalis, Eleusine indica, Beckmannia syzigachne, Eriochloa villosa, Panicum miliaceum, etc.; and equisetaceous weeds such as Equisetum arvense, etc., and, surprising and unexpected synergistic effects are achieved, and the synergistic effects are particularly significant at low doses, thereby reducing application dose and reducing environmental pollution, and the rational compounding leads to reduced agricultural costs and highly effective control of weeds resistant to ALS and ACCase inhibitors. The claimed compositions have a good application prospect. At the same time, it was shown by experimentations that the claimed compositions exhibit good selectivity and excellent synergistic effects in fields such as wheat fields, maize fields and rice fields, as well as for crops such as peanuts, sugar cane, sorghum, millet, potato, rape, soybean, cotton, vegetables, annual bluegrass, Tall fescue, and Zoysia japonica, and can be developed into herbicidical blends having broad market values.

1. An herbicidal composition comprising R-pyridyloxycarboxylic acid and derivative, which comprises an active ingredient A and an active ingredient B in an herbicidally effective amount, wherein the active ingredient A is one or more compounds selected from an R-pyridyloxycarboxylic acid represented by formula I and salt, ester derivative thereof, 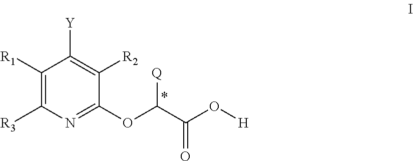
wherein, R₁, R₂ each independently represent halogen, C1-C6 alkyl, halo C1-C6 alkyl or C3-C6 cycloalkyl;
R₃ represents hydrogen, halogen, C1-C6 alkyl or halo C1-C6 alkyl;
Q represents C1-C6 alkyl, halo C1-C6 alkyl, C3-C6 cycloalkyl, C2-C6 alkenyl, C2-C6 alkynyl, halogen, cyano, amino, nitro, formyl, C1-C6 alkoxy, C1-C6 alkylthio, C1-C6 alkoxycarbonyl, hydroxy C1-C6 alkyl, C1-C6 alkoxy C1-C6 alkyl, cyano C1-C6 alkyl, C1-C6 alkylamino C1-C6 alkyl; or phenyl, benzyl, naphthyl, furyl, thienyl, thiazolyl, pyrazolyl, pyridyl or pyrimidinyl that is unsubstituted or substituted by at least one group selected from the group consisting of C1-C6 alkyl, cyano, halo C1-C6 alkyl, C1-C6 alkylamino, halogen, C1-C6 alkoxy;
Y represents amino, C1-C6 alkylamino, C1-C6 alkylcarbonylamino; or phenylcarbonylamino, benzylamino or furylmethyleneamino that is unsubstituted or substituted by at least one group selected from the group consisting of C1-C6 alkyl, halogen, cyano, C1-C6 alkylamino, C1-C6 alkoxy, halo C1-C6 alkyl;
the salt is metal salt, ammonium salt NH₄+, primary amine R″NH₂ salt, secondary amine (R″)₂NH salt, tertiary amine (R″)₃N salt, quaternary amine salt (R″)₄N+, salt of polyamine, morpholine salt, N-methyl morpholine salt, piperidine salt, pyridine salt, aminopropyl morpholine salt, Jeff amine D-230 salt, the salt of 2,4,6-tri(dimethylaminomethyl) phenol and sodium hydroxide, C1-C16 alkylsulfonium salt, C1-C16 alkylsulfoxonium salt, C1-C16 alkylphosphonium salt or C1-C16 alkanolphosphonium salt;
wherein, R″ each independently represents C1-C16 alkyl that is unsubstituted or substituted by one or more of the following groups: halogen, hydroxy, C1-C6 alkoxy, C1-C6 alkylthio, hydroxy C1-C6 alkoxy; C2-C12 alkenyl, C2-C12 alkynyl, C3-C12 cycloalkyl; or phenyl or benzyl that is unsubstituted or substituted by C1-C6 alkyl.
the ester is 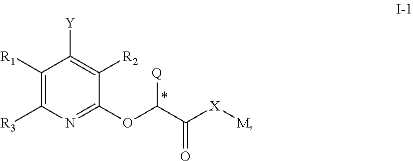
wherein, X represents O or S;
M represents C1-C18 alkyl, halo C1-C8 alkyl, C3-C6 cycloalkyl that is unsubstituted or substituted by C1-C6 alkyl, C2-C6 alkenyl, halo C2-C6 alkenyl, C2-C6 alkynyl, C1-C6 alkoxy, C1-C6 alkoxycarbonyl, C1-C6 alkylsulfonyl, cyano C1-C6 alkyl, nitro C1-C6 alkyl, C1-C6 alkoxy C1-C6 alkyl, —(C1-C6 alkyl)-Z, 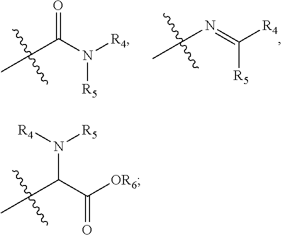
or phenyl, 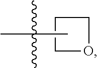
tetrahydrofuryl, pyridyl, naphthyl, furyl, thienyl, pyrrolyl, pyrazolyl or imidazolyl that is unsubstituted or substituted by at least one group selected from the group consisting of C1-C6 alkyl, halo C1-C6 alkyl, cyano, C1-C6 alkylamino, halogen, C1-C6 alkoxy;
Z represents 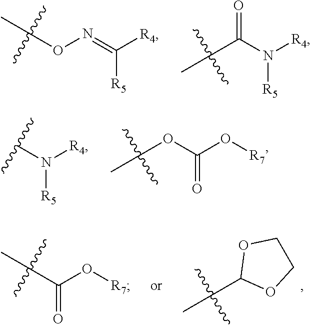
phenyl, tetrahydrofuryl, pyridyl, pyrazolyl, thienyl, furyl or naphthyl that is unsubstituted or substituted by at least one group selected from the group consisting of C1-C6 alkyl, C1-C6 alkoxy, C1-C6 alkylamino, halo C1-C6 alkyl, cyano, halogen;
R₄, R₅, R₆ each independently represent hydrogen, C1-C6 alkyl, C1-C6 alkoxycarbonyl; or phenyl that is unsubstituted or substituted by at least one group selected from the group consisting of C1-C6 alkyl, C1-C6 alkoxy, C1-C6 alkylamino, halo C1-C6 alkyl, cyano, halogen;
R₇ represents C1-C6 alkyl, C2-C6 alkenyl or 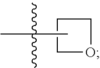
the active ingredient B is selected from the following one or more compounds or acid or salt or ester derivatives thereof,
(1) ALS inhibitor selected from: penoxsulam, bispyribac-sodium, pyrazosulfuron-ethyl, nicosulfuron, florasulam, rimsulfuron, imazethapyr, imazapic, imazamox, sulfometuron-methyl, and cloransulam-methyl;
(2) ACCase inhibitor selected from: cyhalofop-butyl, clodinafop-propargyl, pinoxaden, clethodim, sethoxydim, quizalofop-P-methyl, fluazifop-P-butyl, and haloxyfop-P-methyl;
(3) PSII inhibitor selected from: atrazine, isoproturon, chlorotoluron, diuron, bentazone, bromoxynil, and propanil;
(4) HPPD inhibitor selected from: cypyrafluone, bipyrazone, fenpyrazone, tripyrasulfone, tefuryltrione, mesotrione, tembotrione, topramezone, isoxaflutole, and benzobicylon;
(5) PDS inhibitor selected from: diflufenican, and flurochloridone;
(6) DOXP inhibitor: clomazone;
(7) PPO inhibitor selected from: carfentrazone-ethyl, fomesafen, fluoroglycofen, oxyfluorfen, lactofen, acifluorfen-sodium, flumioxazin, sulfentrazone, saflufenacil, oxadiazon, and oxadiargyl;
(8) Synthetic hormone inhibitor selected from: triclopyr, MCPA, dicamba, picloram, aminopyralid, fluroxypyr, florpyrauxifen benzyl, halauxifen-methyl, quinclorac, and clopyralid;
(9) EPSPS inhibitor: glyphosate;
(10) GS inhibitor selected from, glufosinate ammonium;
(11) PSI inhibitor selected from, diquat Dibromide monohydrate, and paraquat dichloride.

2. The herbicidal composition comprising R-pyridyloxycarboxylic acid and derivative according to claim 1, wherein,
R₁, R₂ each independently represent fluoro, chloro, bromo, iodo, methyl, ethyl, propyl, isopropyl, trifluoromethyl or cyclopropyl;
R₃ represents hydrogen, fluoro, chloro, bromo, iodo, methyl or trifluoromethyl;
Q represents methyl, ethyl, propyl, isopropyl, cyclopropyl, vinyl, ethynyl, fluoro, chloro, bromo, cyano, amino, nitro, formyl, methoxy, methylthio, methoxycarbonyl, monochloromethyl, monofluoromethyl, difluoromethyl, trifluoromethyl, 2-chloroethyl, 2,2,2-trifluoroethyl, hydroxymethyl, 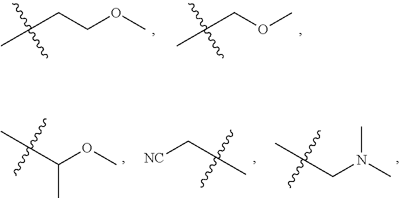
benzyl, naphthyl, furyl, pyridyl, pyrimidinyl; thiazolyl that is unsubstituted or substituted by chloro; thienyl that is unsubstituted or substituted by fluoro; 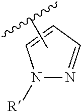
that is unsubstituted or substituted by methyl or fluoro; or phenyl that is unsubstituted or substituted by at least one group selected from the group consisting of methyl, trifluoromethyl, chloro, methoxy;
Y represents NH₂, 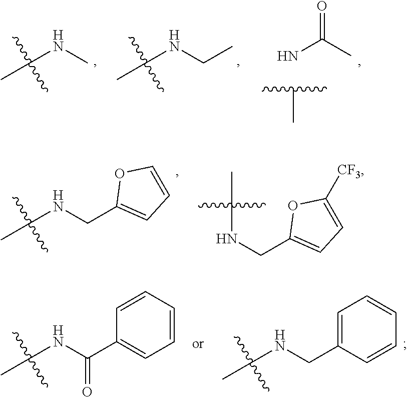
the salt is sodium salt, lithium salt, potassium salt, cesium salt, rubidium salt, calcium salt, magnesium salt, barium salt, strontium salt, antimony salt, bismuth salt, cadmium salt, cerium salt, chromium salt, cobalt salt, scandium salt, titanium salt, manganese salt, copper salt, iron salt, silver salt, gold salt, zinc salt, aluminum salt, ammonium salt, tetramethylammonium salt, tetraethylammonium salt, tetrapropylammonium salt, tetrabutylammonium salt, N-hexadecyltrimethylamine salt, N-benzyltrimethylammonium salt, benzyltriethylammonium salt, choline amine salt, monomethylamine salt, dimethylamine salt, trimethylamine salt, monoethylamine salt, diethylamine salt, triethylamine salt, n-propylamine salt, dipropylamine salt, tripropylamine salt, monoisopropylamine salt, diisopropylamine salt, triisopropylamine salt, n-butylamine salt, dibutylamine salt, tributylamine salt, isobutylamine salt, tert-butylamine salt, pentylamine salt, hexylamine salt, heptylamine salt, octylamine salt, dodecylamine salt, tetradecylamine salt, diallylamine salt, cyclohexylamine salt, cyclododecylamine salt, aniline salt, o-toluidine salt, m-toluidine salt, p-toluidine salt, dianiline salt, benzylamine salt, monoethanolamine salt, N-methyl monoethanolamine salt, N,N-dimethylethanolamine salt, N-ethyl monoethanolamine salt, N,N-diethylethanolamine salt, N-propyl monoethanolamine salt, N,N-di-n-propylethanolamine salt, N-butyl monoethanolamine salt, diethanolamine salt, N-methyldiethanolamine salt, N-ethyldiethanolamine salt, N-propyldiethanolamine salt, N-butyldiethanolamine salt, N, N-dibutylethanolamine salt, triethanolamine salt, tripropanolamine salt, triisopropanolamine salt, tri(2-hydroxypropyl)amine salt, diglycolamine salt, hexamethylenetetramine salt, ethylenediamine salt, diethylenetriamine salt, dimethylaminopropylamine salt, 1,2-propyldiamine salt, triethylenediamine salt, triethylenetetramine salt, benzidine salt, N,N-bis[aminopropyl]methylamine salt, 2-methylthiopropylamine salt, 2-butoxyethylamine salt, AEPD salt, tri(methylol) aminomethane salt, morpholine salt, N-methyl morpholine salt, piperidine salt, pyridine salt, aminopropyl morpholine salt, Jeff amine D-230 salt, the salt of 2,4,6-tri(dimethylaminomethyl) phenol and sodium hydroxide, trimethylsulfonium salt or triethylsulfonium salt;
in formula I-1, X represents O or S;
M represents methyl, ethyl, propyl, isopropyl, n-butyl, sec-butyl, isobutyl, tert-butyl, pentyl, hexyl, heptyl, octyl, nonyl, decyl, undecyl, dodecyl, octadecyl, trifluoromethyl, pentafluoroethyl, 3-chlorobutyl, 2-fluoroethyl, 2-chloroethyl, 2-bromoethyl, 2,2-difluoroethyl, 2,2,2-trifluoroethyl, 4,4,4-trifluorobutyl, 2,2,3,3,3-pentafluoropropyl, cyclopropyl, cyclobutyl, cyclopentyl, cyclohexyl, allyl, 2-propynyl, methoxy, ethoxycarbonyl, methylsulfonyl, 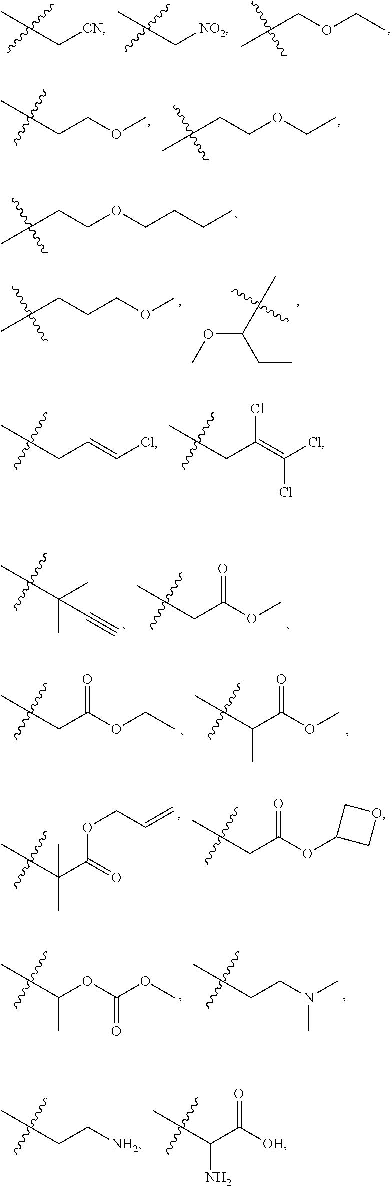 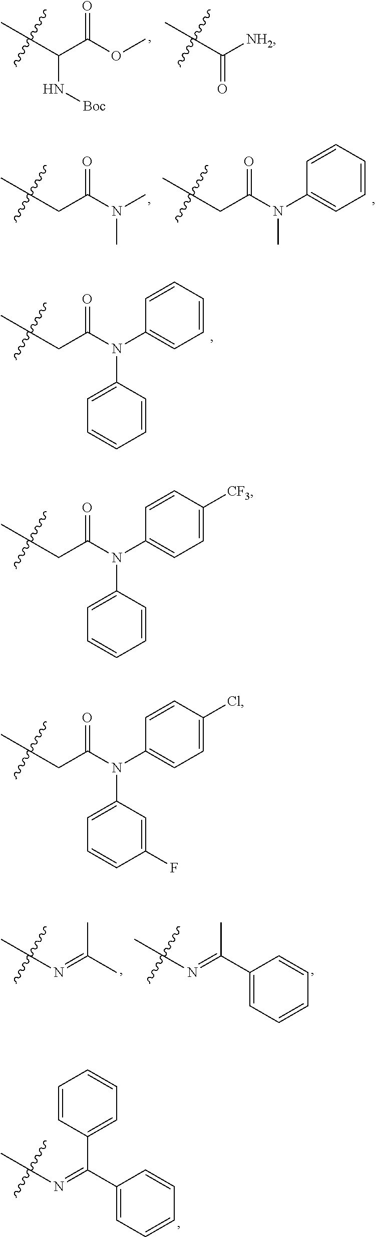 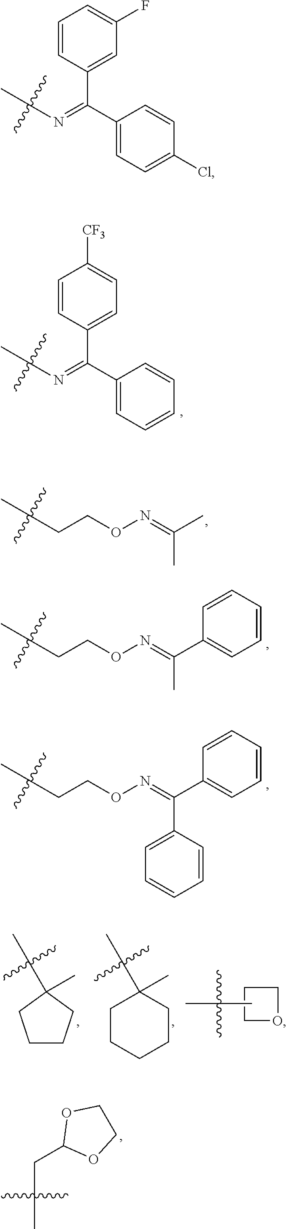
tetrahydrofuryl, tetrahydrofurylmethylene, pyridyl, pyridylmethylene, naphthyl, naphthylmethylene, furyl, furylmethylene, thienyl, thienylmethylene, 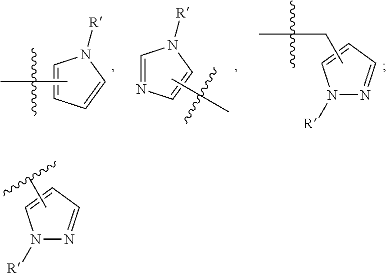
that is unsubstituted or substituted by methyl; phenyl that is unsubstituted or substituted by methyl, dimethylamino, chloro, methoxy, trifluoromethyl or isopropyl; or benzyl that is unsubstituted or substituted by trifluoromethyl, bromo, chloro, fluoro, methoxy, cyano or methyl;
R′ represents hydrogen, methyl, ethyl or difluoromethyl.

3. The herbicidal composition comprising R-pyridyloxycarboxylic acid and derivative according to claim 1 or 2, wherein the active ingredient A is one or more compounds selected from,

| No. of | |
|---|---|
| component A | Structure |
| A1 | 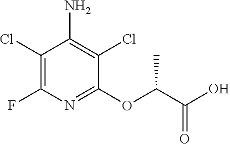 [SMILES: C[C@@H](Oc1nc(F)c(Cl)c(N)c1Cl)C(=O)O] |
| A2 | 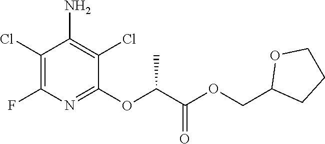 [SMILES: C[C@@H](Oc1nc(F)c(Cl)c(N)c1Cl)C(=O)OCC1CCCO1] |
| A3 | A1 sodium salt |
| A4 | A1 potassium salt |
| A5 | A1 calcium salt |
| A6 | A1 lithium salt |
| A7 | A1 aluminum salt |
| A8 | A1 barium salt |
| A9 | A1 magnesium salt |
| A10 | A1 copper salt |
| A11 | A1 iron salt |
| A12 | A1 ammonium salt |
| A13 | A1 monomethylamine salt |
| A14 | A1 dimethylamine salt |
| A15 | A1 trimethylamine salt |
| A16 | A1 monoethylamine salt |
| A17 | A1 diethylamine salt |
| A18 | A1 triethylamine salt |
| A19 | A1 ethylenediamine salt |
| A20 | A1 triethylene diamine salt |
| A21 | A1 monoethanolamine salt |
| A22 | A1 diethanolamine salt |
| A23 | A1 triethanolamine salt |
| A24 | A1 N-methyl monoethanolamine salt |
| A25 | A1 N-methyldiethanolamine salt |
| A26 | A1 N-ethyl monoethanolamine salt |
| A27 | A1 N-ethyldiethanolamine salt |
| A28 | A1 N,N-diethylethanolamine salt |
| A29 | A1 N-propyl monoethanolamine salt |
| A30 | A1 N-propyl diethanolamine salt |
| A31 | A1 N,N-di-n-propylethanolamine salt |
| A32 | A1 N-butyl monoethanolamine salt |
| A33 | A1 N-butyl diethanolamine salt |
| A34 | A1 N,N-dibutylethanolamine salt |
| A35 | A1 n-propylamine salt |
| A36 | A1 dipropylamine salt |
| A37 | A1 tripropylamine salt |
| A38 | A1 n-butylamine salt |
| A39 | A1 dibutylamine salt |
| A40 | A1 tributylamine salt |
| A41 | A1 isobutylamine salt |
| A42 | A1 tert-butylamine salt |
| A43 | A1 hexylamine salt |
| A44 | A1 octylamine salt |
| A45 | A1 aniline salt |
| A46 | A1 diphenylamine salt |
| A47 | A1 benzidine salt |
| A48 | A1 benzylamine salt |
| A49 | A1 cyclohexylamine salt |
| A50 | A1 monoisopropylamine salt |
| A51 | A1 diisopropylamine salt |
| A52 | A1 diglycolamine salt |
| A53 | A1 hexamethylenetetramine salt |
| A54 | A1 tetramethylammonium salt |
| A55 | A1 tetraethylammonium salt |
| A56 | A1 tetrapropylammonium salt |
| A57 | A1 tetrabutylammonium salt |
| A58 | A1 choline amine salt |
| A59 | A1 N-benzyltrimethylammonium salt |
| A60 | A1 N-hexadecyltrimethylammonium salt |
| A61 | A1 pyridine salt |
| A62 | A1 N-methylmorpholine salt |
| A63 | A1 o-toluidine salt |
| A64 | A1 m-toluidine salt |
| A65 | A1 p-toluidine salt |
| A66 | A1 piperidine salt |
| A67 | 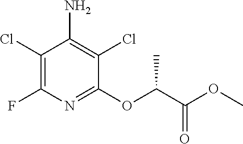 [SMILES: COC(=O)[C@@H](C)Oc1nc(F)c(Cl)c(N)c1Cl] |
| A68 | 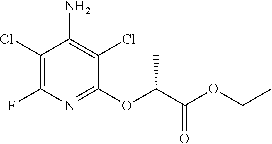 [SMILES: CCOC(=O)[C@@H](C)Oc1nc(F)c(Cl)c(N)c1Cl] |
| A69 | 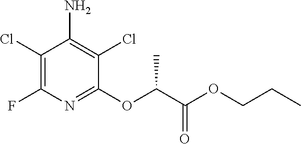 [SMILES: CCCOC(=O)[C@@H](C)Oc1nc(F)c(Cl)c(N)c1Cl] |
| A70 | 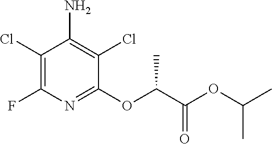 [SMILES: CC(C)OC(=O)[C@@H](C)Oc1nc(F)c(Cl)c(N)c1Cl] |
| A71 | 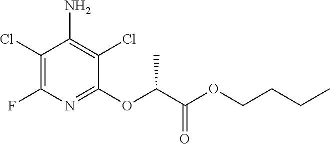 [SMILES: CCCCOC(=O)[C@@H](C)Oc1nc(F)c(Cl)c(N)c1Cl] |
| A72 | 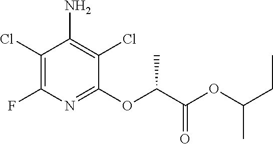 [SMILES: CCC(C)OC(=O)[C@@H](C)Oc1nc(F)c(Cl)c(N)c1Cl] |
| A73 | 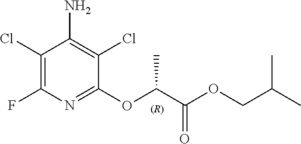 |
| A74 | 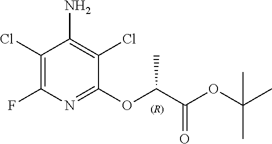 |
| A75 | 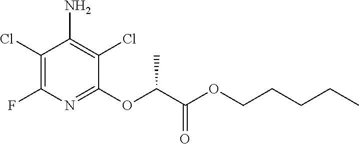 [SMILES: CCCCCOC(=O)[C@@H](C)Oc1nc(F)c(Cl)c(N)c1Cl] |
| A76 | 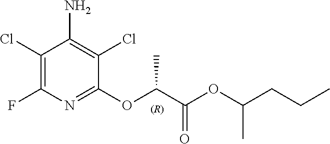 |
| A77 | 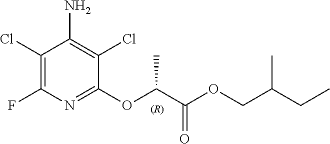 |
| A78 | 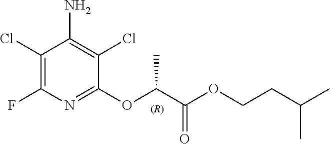 |
| A79 | 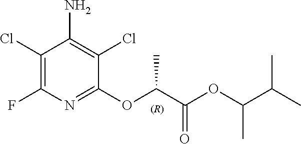 |
| A80 | 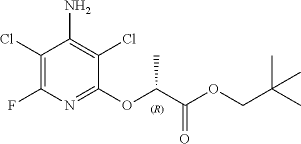 |
| A81 | 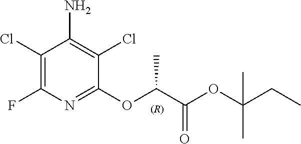 |
| A82 | 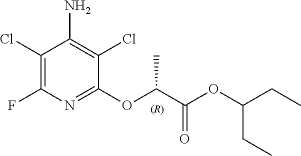 |
| A83 | 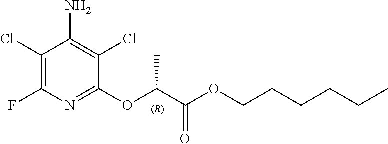 |
| A84 | 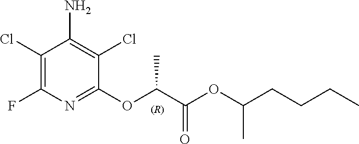 |
| A85 | 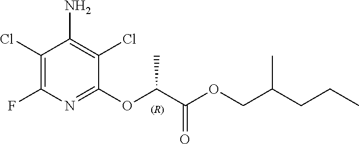 |
| A86 | 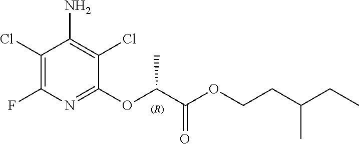 |
| A87 | 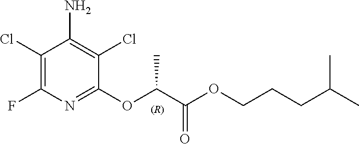 |
| A88 | 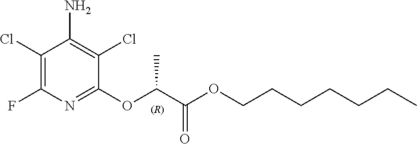 |
| A89 | 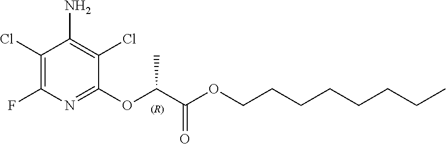 |
| A90 | 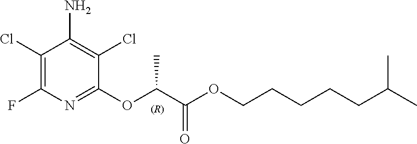 |
| A91 | 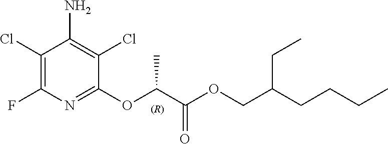 |
| A92 | 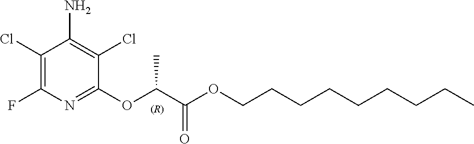 |
| A93 | 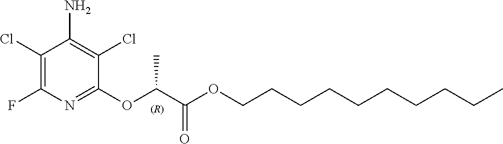 |
| A94 | 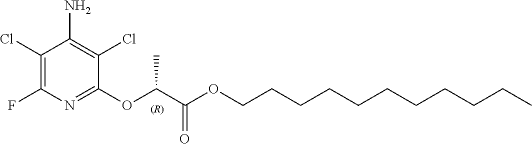 |
| A95 | 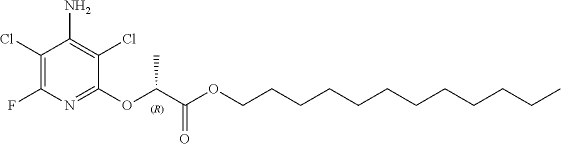 |
| A96 | 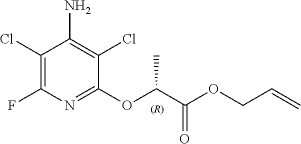 |
| A97 | 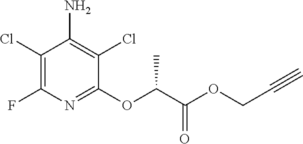 [SMILES: C#CCOC(=O)[C@@H](C)Oc1nc(F)c(Cl)c(N)c1Cl] |
| A98 | 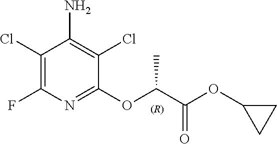 |
| A99 | 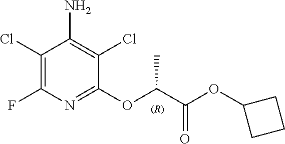 |
| A100 | 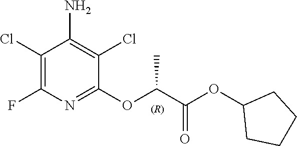 |
| A101 | 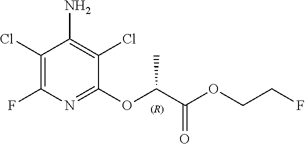 |
| A102 | 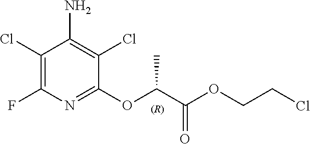 |
| A103 | 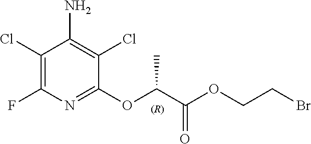 |
| A104 | 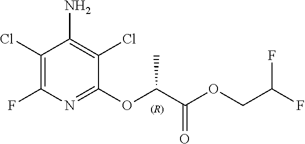 |
| A105 | 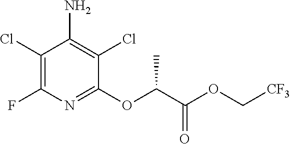 [SMILES: C[C@@H](Oc1nc(F)c(Cl)c(N)c1Cl)C(=O)OCC(F)(F)F] |
| A106 | 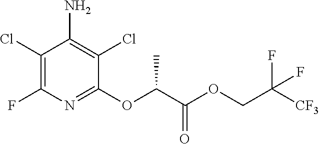 [SMILES: C[C@@H](Oc1nc(F)c(Cl)c(N)c1Cl)C(=O)OCC(F)(F)C(F)(F)F] |
| A107 | 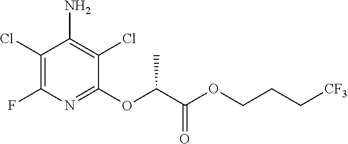 [SMILES: C[C@@H](Oc1nc(F)c(Cl)c(N)c1Cl)C(=O)OCCCC(F)(F)F] |
| A108 | 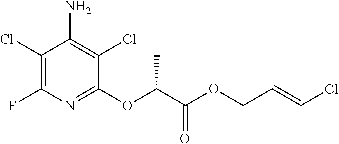 [SMILES: C[C@@H](Oc1nc(F)c(Cl)c(N)c1Cl)C(=O)OC/C=C/Cl] |
| A109 | 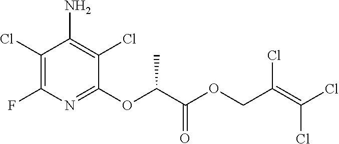 [SMILES: C[C@@H](Oc1nc(F)c(Cl)c(N)c1Cl)C(=O)OCC(Cl)=C(Cl)Cl] |
| A110 | 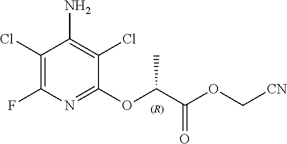 |
| A111 | 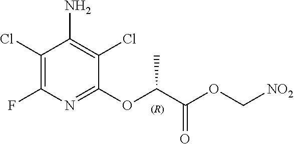 |
| A112 | 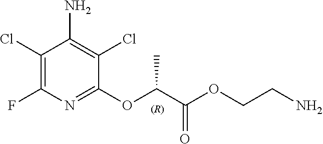 |
| A113 | 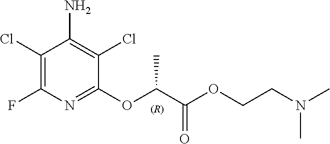 |
| A114 | 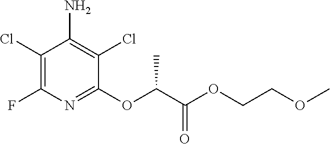 [SMILES: COCCOC(=O)[C@@H](C)Oc1nc(F)c(Cl)c(N)c1Cl] |
| A115 | 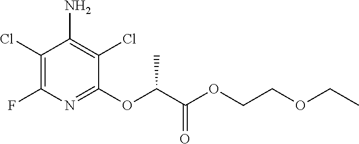 [SMILES: CCOCCOC(=O)[C@@H](C)Oc1nc(F)c(Cl)c(N)c1Cl] |
| A116 | 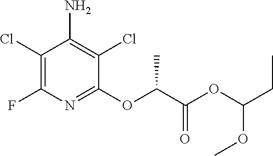 [SMILES: CCC(OC)OC(=O)[C@@H](C)Oc1nc(F)c(Cl)c(N)c1Cl] |
| A117 | 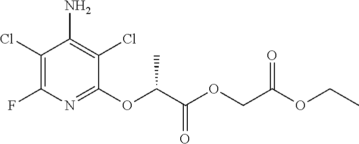 [SMILES: CCOC(=O)COC(=O)[C@@H](C)Oc1nc(F)c(Cl)c(N)c1Cl] |
| A118 | 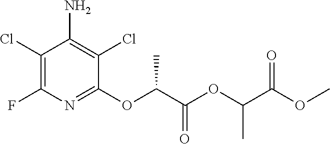 [SMILES: COC(=O)C(C)OC(=O)[C@@H](C)Oc1nc(F)c(Cl)c(N)c1Cl] |
| A119 | 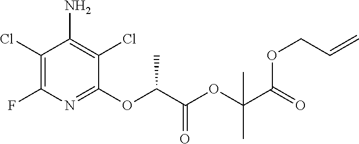 [SMILES: C=CCOC(=O)C(C)(C)OC(=O)[C@@H](C)Oc1nc(F)c(Cl)c(N)c1Cl] |
| A120 | 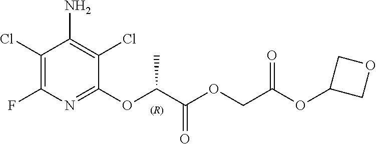 |
| A121 | 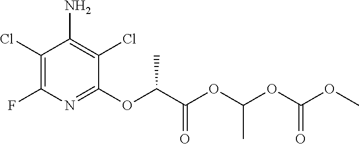 [SMILES: COC(=O)OC(C)OC(=O)[C@@H](C)Oc1nc(F)c(Cl)c(N)c1Cl] |
| A122 | 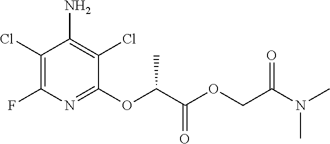 [SMILES: C[C@@H](Oc1nc(F)c(Cl)c(N)c1Cl)C(=O)OCC(=O)N(C)C] |
| A123 | 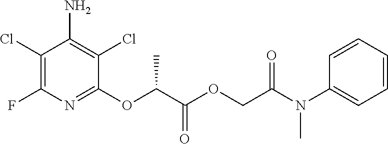 [SMILES: C[C@@H](Oc1nc(F)c(Cl)c(N)c1Cl)C(=O)OCC(=O)N(C)c1ccccc1] |
| A124 | 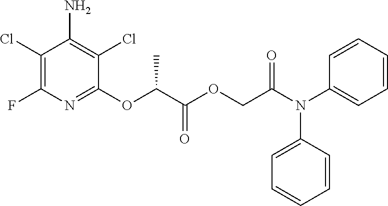 [SMILES: C[C@@H](Oc1nc(F)c(Cl)c(N)c1Cl)C(=O)OCC(=O)N(c1ccccc1)c1ccccc1] |
| A125 | 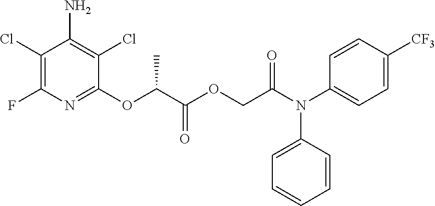 [SMILES: C[C@@H](Oc1nc(F)c(Cl)c(N)c1Cl)C(=O)OCC(=O)N(c1ccccc1)c1ccc(C(F)(F)F)cc1] |
| A126 | 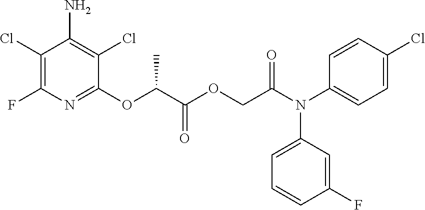 [SMILES: C[C@@H](Oc1nc(F)c(Cl)c(N)c1Cl)C(=O)OCC(=O)N(c1ccc(Cl)cc1)c1cccc(F)c1] |
| A127 | 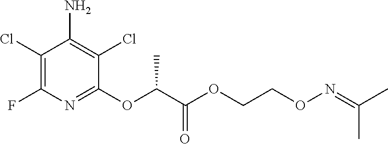 [SMILES: CC(C)=NOCCOC(=O)[C@@H](C)Oc1nc(F)c(Cl)c(N)c1Cl] |
| A128 | 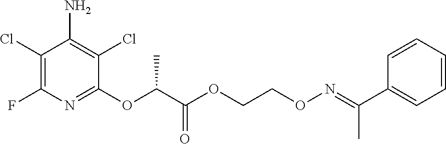 [SMILES: C/C(=N\OCCOC(=O)[C@@H](C)Oc1nc(F)c(Cl)c(N)c1Cl)c1ccccc1] |
| A129 | 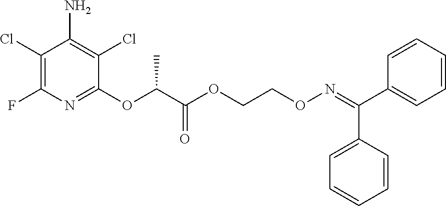 [SMILES: C[C@@H](Oc1nc(F)c(Cl)c(N)c1Cl)C(=O)OCCON=C(c1ccccc1)c1ccccc1] |
| A130 | 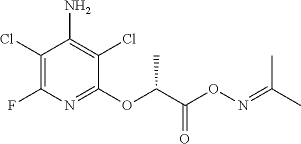 [SMILES: CC(C)=NOC(=O)[C@@H](C)Oc1nc(F)c(Cl)c(N)c1Cl] |
| A131 | 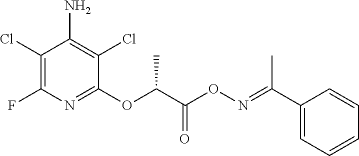 [SMILES: C/C(=N\OC(=O)[C@@H](C)Oc1nc(F)c(Cl)c(N)c1Cl)c1ccccc1] |
| A132 | 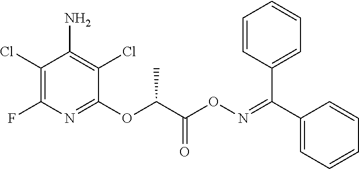 [SMILES: C[C@@H](Oc1nc(F)c(Cl)c(N)c1Cl)C(=O)ON=C(c1ccccc1)c1ccccc1] |
| A133 | 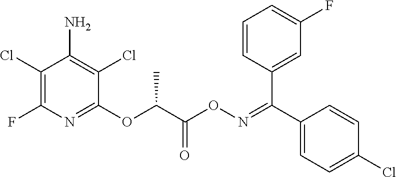 [SMILES: C[C@@H](Oc1nc(F)c(Cl)c(N)c1Cl)C(=O)O/N=C(/c1ccc(Cl)cc1)c1cccc(F)c1] |
| A134 | 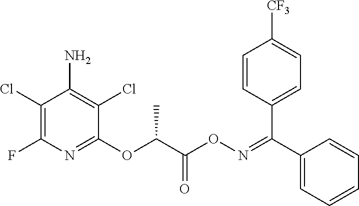 [SMILES: C[C@@H](Oc1nc(F)c(Cl)c(N)c1Cl)C(=O)O/N=C(/c1ccccc1)c1ccc(C(F)(F)F)cc1] |
| A135 | 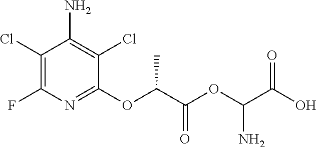 [SMILES: C[C@@H](Oc1nc(F)c(Cl)c(N)c1Cl)C(=O)OC(N)C(=O)O] |
| A136 | 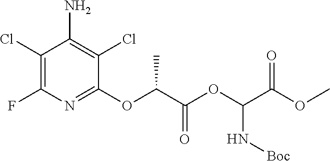 [SMILES: COC(=O)C(NC(=O)OC(C)(C)C)OC(=O)[C@@H](C)Oc1nc(F)c(Cl)c(N)c1Cl] |
| A137 | 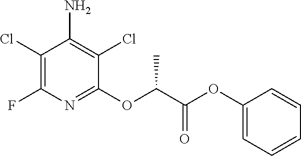 [SMILES: C[C@@H](Oc1nc(F)c(Cl)c(N)c1Cl)C(=O)Oc1ccccc1] |
| A138 | 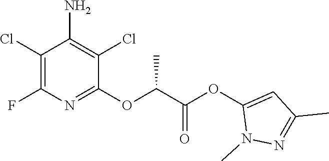 [SMILES: Cc1cc(OC(=O)[C@@H](C)Oc2nc(F)c(Cl)c(N)c2Cl)n(C)n1] |
| A139 | 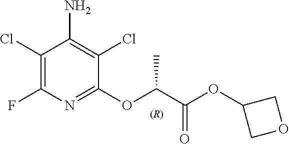 |
| A140 | 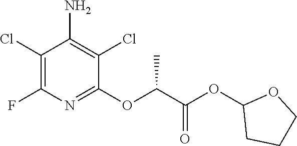 [SMILES: C[C@@H](Oc1nc(F)c(Cl)c(N)c1Cl)C(=O)OC1CCCO1] |
| A141 | 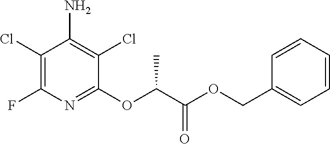 [SMILES: C[C@@H](Oc1nc(F)c(Cl)c(N)c1Cl)C(=O)OCc1ccccc1] |
| A142 | 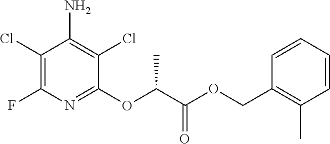 [SMILES: Cc1ccccc1COC(=O)[C@@H](C)Oc1nc(F)c(Cl)c(N)c1Cl] |
| A143 | 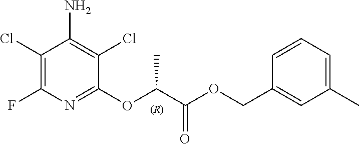 |
| A144 | 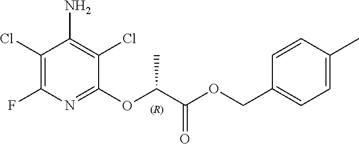 |
| A145 | 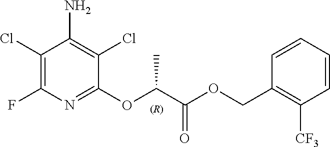 |
| A146 | 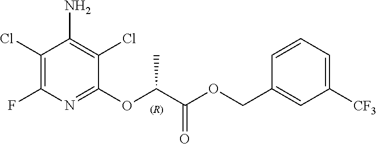 |
| A147 | 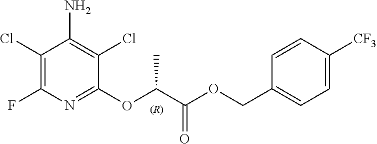 |
| A148 | 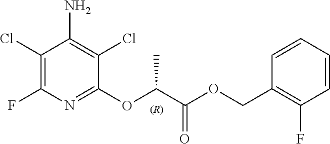 |
| A149 | 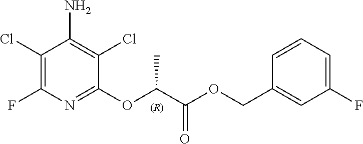 |
| A150 | 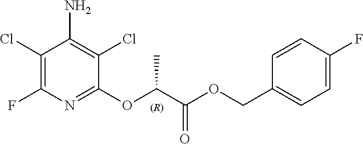 |
| A151 | 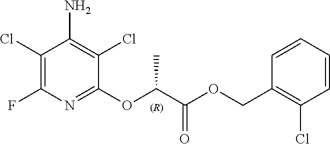 |
| A152 | 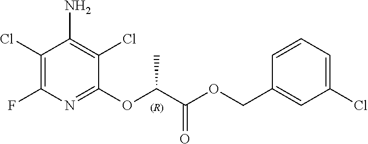 |
| A153 | 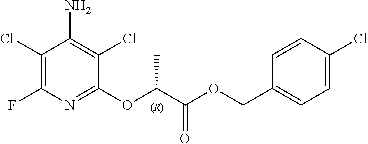 |
| A154 | 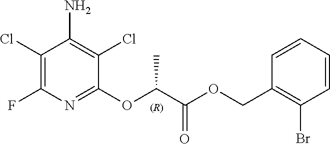 |
| A155 | 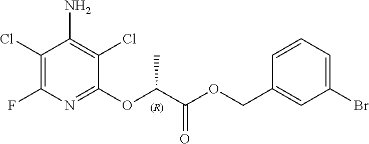 |
| A156 | 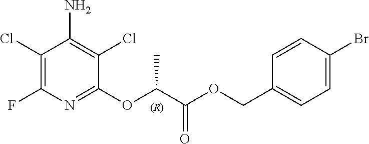 |
| A157 | 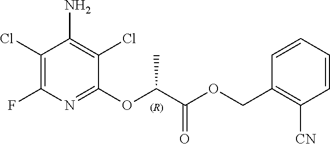 |
| A158 | 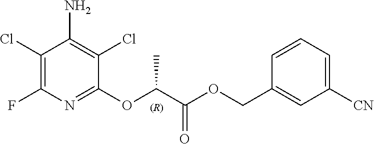 |
| A159 | 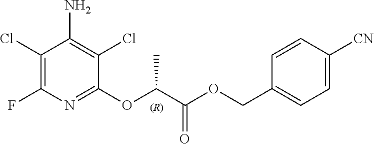 |
| A160 | 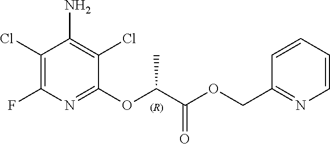 |
| A161 | 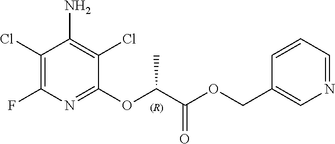 |
| A162 | 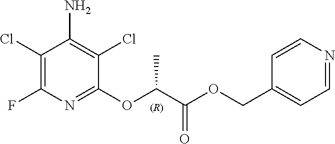 |
| A163 | 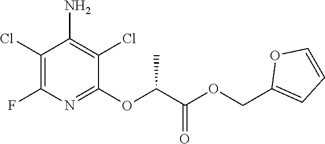 [SMILES: C[C@@H](Oc1nc(F)c(Cl)c(N)c1Cl)C(=O)OCc1ccco1] |
| A164 | 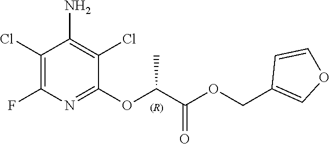 |
| A165 | 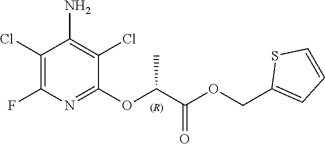 |
| A166 | 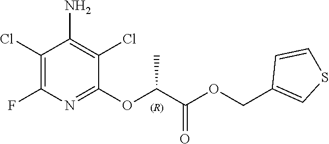 |
| A167 | 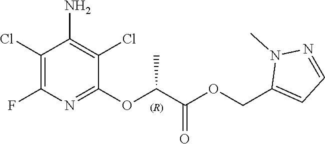 |
| A168 | 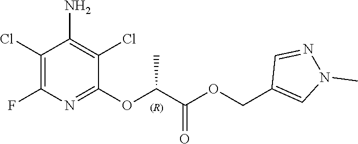 |
| A169 | 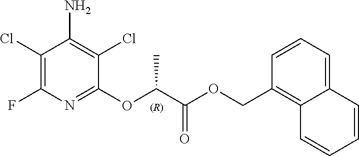 |
| A170 | 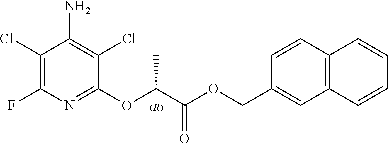 |
| A171 | 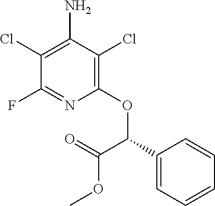 [SMILES: COC(=O)[C@H](Oc1nc(F)c(Cl)c(N)c1Cl)c1ccccc1] |
| A172 | 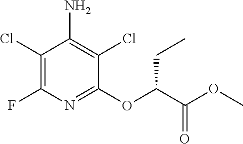 [SMILES: CC[C@@H](Oc1nc(F)c(Cl)c(N)c1Cl)C(=O)OC] |
| A173 | 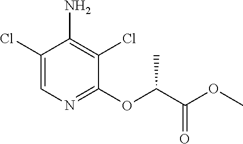 [SMILES: COC(=O)[C@@H](C)Oc1ncc(Cl)c(N)c1Cl] |
| A174 | 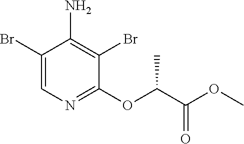 [SMILES: COC(=O)[C@@H](C)Oc1ncc(Br)c(N)c1Br] |
| A175 | 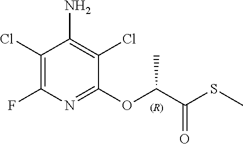 |
| A176 | 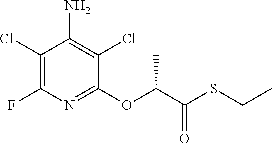 [SMILES: CCSC(=O)[C@@H](C)Oc1nc(F)c(Cl)c(N)c1Cl] |
| A177 | 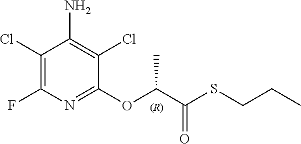 |
| A178 | 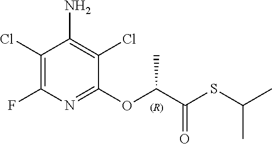 |
| A179 | 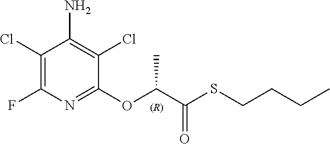 |
| A180 | 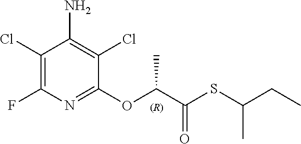 |
| A181 | 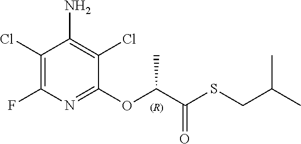 |
| A182 | 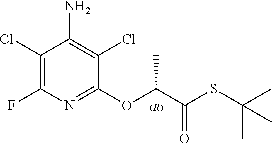 |
| A183 | 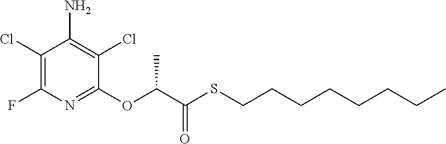 [SMILES: CCCCCCCCSC(=O)[C@@H](C)Oc1nc(F)c(Cl)c(N)c1Cl] |
| A184 | 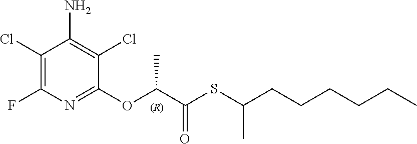 |
| A185 | 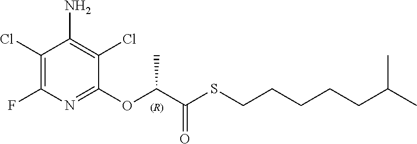 |
| A186 | 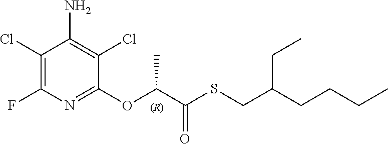 |
| A187 | 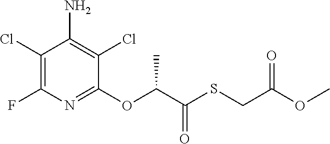 [SMILES: COC(=O)CSC(=O)[C@@H](C)Oc1nc(F)c(Cl)c(N)c1Cl] |
| A188 | 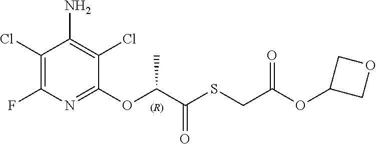 |
| A189 | 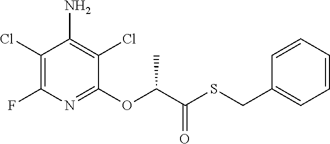 [SMILES: C[C@@H](Oc1nc(F)c(Cl)c(N)c1Cl)C(=O)SCc1ccccc1] |
| A190 | 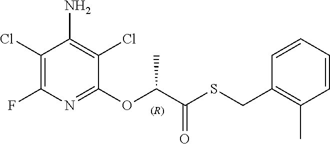 |
| A191 | 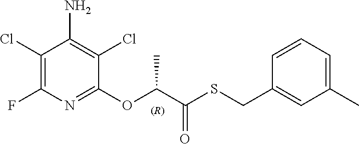 |
| A192 | 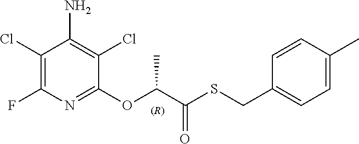 |
| A193 | 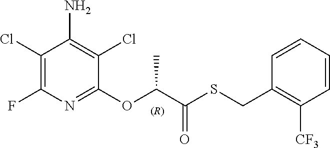 |
| A194 | 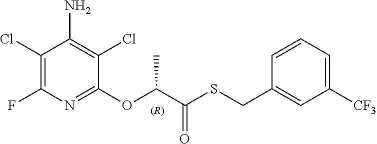 |
| A195 | 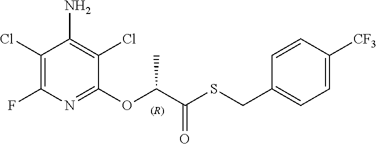 |
| A196 | 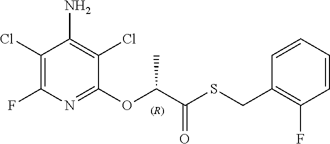 |
| A197 | 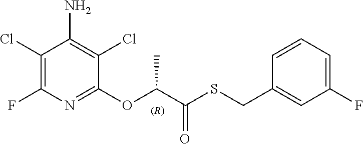 |
| A198 | 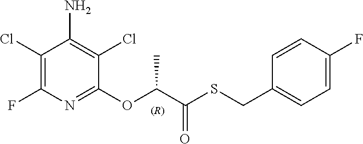 |
| A199 | 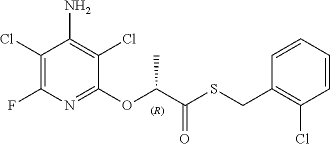 |
| A200 | 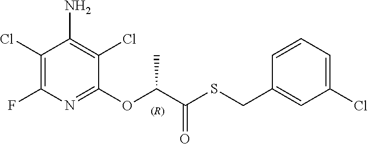 |
| A201 | 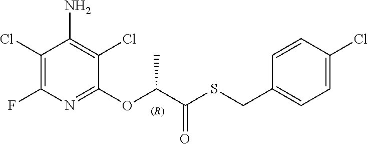 |
| A202 | 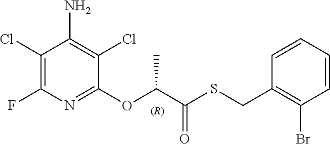 |
| A203 | 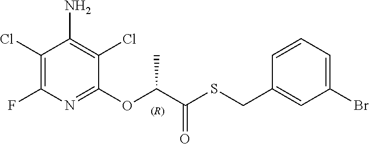 |
| A204 | 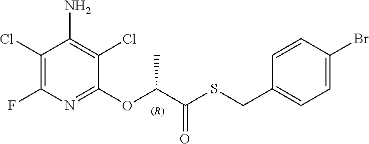 |
| A205 | 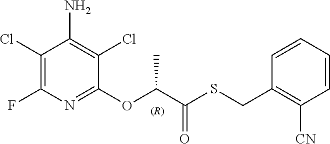 |
| A206 | 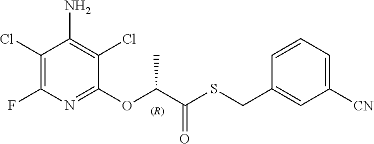 |
| A207 | 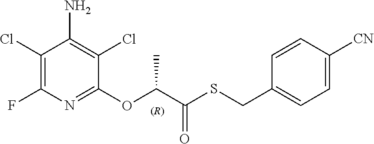 |
| A208 | 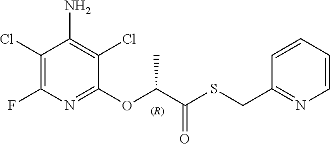 |
| A209 | 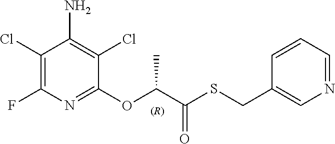 |
| A210 | 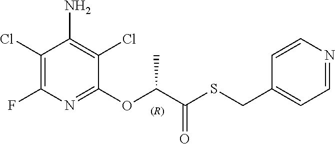 |
| A211 | 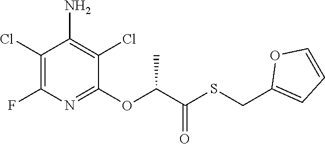 [SMILES: C[C@@H](Oc1nc(F)c(Cl)c(N)c1Cl)C(=O)SCc1ccco1] |
| A212 | 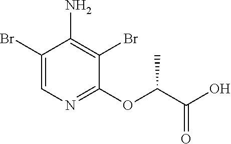 |
| A213 | 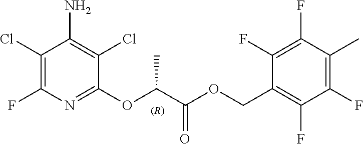 |
| A214 | 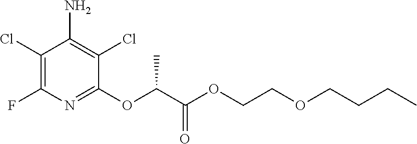 [SMILES: CCCCOCCOC(=O)[C@@H](C)Oc1nc(F)c(Cl)c(N)c1Cl] |
| A215 | 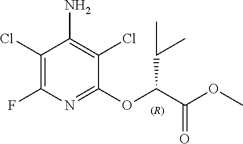 |
| A216 | 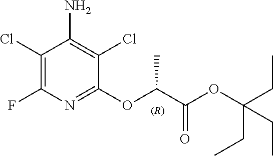 |
| A217 | 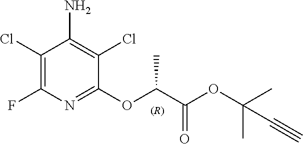 |
| A218 | 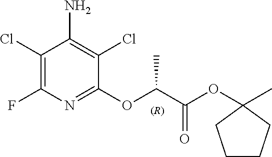 |
| A219 | 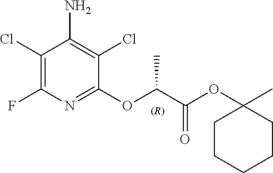 |
| A220 | 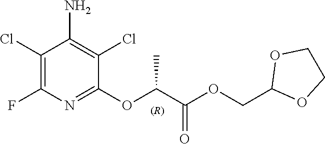 |
| A221 | 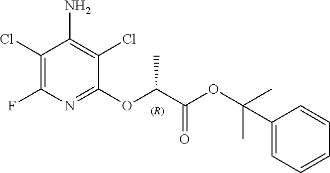 |
| A222 | 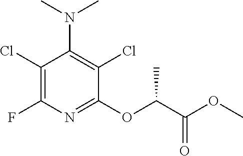 [SMILES: COC(=O)[C@@H](C)Oc1nc(F)c(Cl)c(N(C)C)c1Cl] |
| A223 | 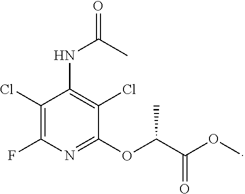 |

4. The herbicidal composition comprising R-pyridyloxycarboxylic acid and derivative according to claim 1, wherein the ingredient A to the ingredient B is in a weight ratio of 1:10˜0100:1 or 1:50˜50:1.

5. The herbicidal composition comprising R-pyridyloxycarboxylic acid and derivative according to claim 1, wherein the ingredients A and B together account for 1-95% of the total weight of the herbicidal composition.

6. The herbicidal composition comprising R-pyridyloxycarboxylic acid and derivative according to claim 1, wherein the herbicidal composition further comprises a conventional auxiliary.

7. The herbicidal composition comprising R-pyridyloxycarboxylic acid and derivative according to claim 1, wherein the herbicidal composition further comprises one or more safeners.

8. The herbicidal composition comprising R-pyridyloxycarboxylic acid and derivative according to claim 1, wherein the herbicidal composition is in a form of a formulation which is selected from: a dispersible oil suspension, a water suspension, a suspoemulsion, a wettable powder, an emulsifiable concentrate, a water-dispersible granule, an aqueous emulsion and a microemulsion.

9. (canceled)

10. A method for controlling unwanted plant growth, comprising applying a herbicidal composition comprising an R-pyridyloxycarboxylic acid and derivative according to claim 1 to plants, plant parts, plant seeds or plant growing area.

11. The herbicidal composition comprising R-pyridyloxycarboxylic acid and derivative according to claim 4, wherein the ingredient A to the ingredient B is in a weight ratio of 1:30˜30:1 or 1:20˜20:1.

12. The herbicidal composition comprising R-pyridyloxycarboxylic acid and derivative according to claim 11, wherein the ingredient A to the ingredient B is in a weight ratio of 1:10˜10:1 or 1:8˜8:1.

13. The herbicidal composition comprising R-pyridyloxycarboxylic acid and derivative according to claim 12, wherein the ingredient A to the ingredient B is in a weight ratio of 1:5˜5:1, 1:1˜2:1 or 1:1˜1:2.

14. The herbicidal composition comprising R-pyridyloxycarboxylic acid and derivative according to claim 5, wherein the ingredients A and B together account for 10-80% of the total weight of the herbicidal composition.

15. The herbicidal composition comprising R-pyridyloxycarboxylic acid and derivative according to claim 6, wherein said conventional auxiliary comprises a carrier, and/or a surfactant.

16. The herbicidal composition comprising R-pyridyloxycarboxylic acid and derivative according to claim 7, wherein said safener is one or more compounds selected from: isoxadifen-ethyl, cyprosulfamide, mefenpyr-diethyl, cloquintocet-mexyl, gibberellic acid, furilazole and metcamifen.

17. The method according to claim 10, wherein the herbicidal composition being used to selectively control a weed in a useful crop.

18. The method according to claim 17, wherein the useful crop is genetically modified crop or a crop treated by gene editing technology.

19. A method for controlling a weed, comprising applying a herbicidal composition comprising an R-pyridyloxycarboxylic acid and derivative according to claim 1.

20. The method according to claim 19, wherein the herbicidal composition being used to selectively control a weed in a useful crop.

21. The method according to claim 20, wherein the useful crop is genetically modified crop or a crop treated by gene editing technology.
